(19) United States
(12) Patent Application Publication
(10) Pub. No.: US 2008/0057448 A1
(43) Pub. Date: Mar. 6, 2008

(54) Photothermographic material and image forming method

(75) Inventor: Hideo Fushimi, Kanagawa (JP)

Correspondence Address: TAIYO CORPORATION, 401 HOLLAND LANE, #407, ALEXANDRIA, VA, 22314, US

(73) Assignee: FUJIFILM CORPORATION, Minato-ku (JP)

(21) Appl. No.: 11/896,145

(22) Filed: Aug. 30, 2007

(30) Foreign Application Priority Data
Sep. 4, 2006 (JP) 2006-239488
Mar. 22, 2007 (JP) 2007-075625

(51) Int. Cl. G03C 1/43; G03C 5/29

(52) U.S. Cl. 430/353; 430/496

(57) ABSTRACT

The present invention provides a photothermographic material having, on at least one side of a support, an image forming layer including at least a photosensitive silver halide, a non-photosensitive organic silver salt, a reducing agent for silver ions, and a binder, and at least one non-photosensitive layer, wherein:
1) a mean grain size of the photosensitive silver halide is from 10 nm to 40 nm in terms of equivalent circular diameter, and a number of coated grains thereof is from 550 grains/μm² to 10000 grains/μm²; and
2) the photothermographic material includes a fluorocarbon compound represented by the following formula (FC-1), (FC-2), or (FC-3). A photothermographic material and an image forming method which exhibit improved coated surface state and high quality are provided.

(Rf)ₚ—Y-(L-Z)_{q}: Formula (FC-1)

Rf-L-Z′-L-Rf: Formula (FC-2)

Z-L-Rf′-L-Z: Formula (FC-3)

### CROSS-REFERENCE TO RELATED APPLICATION

This application claims priority under 35 USC 119 from Japanese Patent Application Nos. 2006-239488 and 2007-75625, the disclosures of which are incorporated by reference herein.

### BACKGROUND OF THE INVENTION

1. Field of the Invention

The present invention relates to a photothermographic material and an image forming method, which exhibit improved surface state.

2. Description of the Related Art

In recent years, in the field of films for medical imaging, there has been a strong desire for decreasing the amount of processing liquid waste from the viewpoints of protecting the environment and economy of space. Technology is therefore required for light-sensitive photothermographic materials which can be exposed effectively by laser image setters or laser imagers and thermally developed to obtain clear black-toned images of high resolution and sharpness, for use in medical diagnostic applications and for use in photographic technical applications. The light-sensitive photothermographic materials do not require liquid processing chemicals and can therefore be supplied to customers as a simpler and environmentally friendly thermal developing processing system.

While similar requirements also exist in the field of general image forming materials, images for medical imaging in particular require high image quality excellent in sharpness and granularity because fine depiction is required, and further require blue-black image tone from the viewpoint of easy diagnosis. Various kinds of hard copy systems utilizing dyes or pigments, such as ink jet printers and electrophotographic systems, have been marketed as general image forming systems, but they are not satisfactory as output systems for medical images.

Thermal image forming systems utilizing organic silver salts are described in many documents. In particular, photothermographic materials generally have an image forming layer in which a catalytically active amount of a photocatalyst (for example, silver halide), a reducing agent, a reducible silver salt (for example, an organic silver salt), and if necessary, a toner for controlling the color tone of developed silver images are dispersed in a binder. Photothermographic materials form black silver images by being heated to a high temperature (for example, 80° C. or higher) after imagewise exposure to cause an oxidation-reduction reaction between a silver halide or a reducible silver salt (functioning as an oxidizing agent) and a reducing agent. The oxidation-reduction reaction is accelerated by the catalytic action of a latent image on the silver halide generated by imagewise exposure. As a result, a black silver image is formed in the exposed region. Further, the Fuji Medical Dry Imager FM-DPL is an example of a medical image forming system using photothermographic materials that has been made commercially available.

Methods of manufacturing such a photothermographic material utilizing an organic silver salt include a method of manufacture by a solvent coating, and a method of coating an aqueous coating solution using an aqueous dispersion of fine polymer particles or an aqueous solution of a water-soluble polymer as a main binder followed by drying.

Attainment of uniform and excellent surface state is an important task, because neither the coating solution for solvent coating nor the coating solution including polymer latex as a binder has a liquid physical property in which the solution loses fluidity upon decrease in temperature, which is called setting ability.

In particular, by conducting fine-granulation through improvement of various materials used for image formation and improvement of methods for production thereof such as dispersion methods, technology for obtaining images with excellent granularity and high image quality having high resolution has been developed. For example, Japanese Patent Application Laid-Open (JP-A) No. 2005-316054 discloses technology for realizing fine particles while maintaining the sensitivity of photosensitive silver halide. Further, JP-A Nos. 2005-157190 and 2005-165006 disclose a method for producing fine particles of organic silver salt which exhibit low fog. U.S. Pat. Nos. 6,630,291 and 6,713,241 disclose a method for producing nanoparticles of organic silver salt. All patents, patent publications, and non-patent literature cited in this specification are hereby expressly incorporated by reference herein. However, because fine-granulation exerts influence on fluid properties of coating solution, particularly on thixotropic property, it has not been easy to obtain uniform surface state under conventional coating conditions.

### SUMMARY OF THE INVENTION

The present invention has been made in view of the above circumstances and provides a photothermographic material comprising, on at least one side of a support, an image forming layer comprising at least a photosensitive silver halide, a non-photosensitive organic silver salt, a reducing agent for silver ions, and a binder, and at least one non-photosensitive layer, wherein:

1) a mean grain size of the photosensitive silver halide is from 10 nm to 40 nm in terms of equivalent circular diameter, and a number of coated grains thereof is from 550 grains/μm² to 10000 grains/μm²; and

2) the photothermographic material comprises a fluorocarbon compound represented by the following formula (FC-1), (FC-2), or (FC-3):

(Rf)ₚ—Y-(L-Z)_{q} Formula (FC-1):

Rf-L-Z′-L-Rf Formula (FC-2):

Z-L-Rf′-L-Z Formula (FC-3):

wherein Rf represents a fluoroalkyl group or fluoroalkenyl group having 3 to 17 fluorine atoms; Rf′ represents a fluoroalkylene group or fluoroalkenylene group having 3 to 17 fluorine atoms; L represents a bond or a divalent linking group; Y represents a bond or a saturated linking group having a valency of (p+q); Z represents an anionic group, a cationic group, a betaine group, or a nonionic polar group; Z′ represents a divalent nonionic polar group; p and q each independently represent an integer of from 1 to 3; and when (p+q) is 2, both of L and Y are not simultaneously a bond.

### DETAILED DESCRIPTION OF THE INVENTION

An object of the present invention is to provide a photothermographic material and an image forming method which exhibit excellent coating ability, excellent surface state, and high image quality.

The problem of the present invention described above has been solved by the following means.

The photothermographic material of the present invention is characterized in that it has, on at least one side of a support, an image forming layer including at least a photosensitive silver halide, a non-photosensitive organic silver salt, a reducing agent for silver ions, and a binder, and at least one non-photosensitive layer, wherein:

1) a mean grain size of the photosensitive silver halide is from 10 nm to 40 nm in terms of equivalent circular diameter, and a number of coated grains thereof is from 550 grains/μm² to 10000 grains/μm²; and

2) the photothermographic material comprises a fluorocarbon compound represented by the following formula (FC-1), (FC-2), or (FC-3):

(Rf)ₚ—Y-(L-Z)_{q} Formula (FC-1):

Rf-L-Z′-L-Rf Formula (FC-2):

Z-L-Rf′-L-Z Formula (FC-3):

wherein Rf represents a fluoroalkyl group or fluoroalkenyl group having 3 to 17 fluorine atoms; Rf′ represents a fluoroalkylene group or fluoroalkenylene group having 3 to 17 fluorine atoms; L represents a bond or a divalent linking group; Y represents a bond or a saturated linking group having a valency of (p+q); Z represents an anionic group, a cationic group, a betaine group, or a nonionic polar group; Z′ represents a divalent nonionic polar group; p and q each independently represent an integer of from 1 to 3; and when (p+q) is 2, both of L and Y are not simultaneously a bond.

Preferably, the mean grain size of the photosensitive silver halide is from 20 nm to 30 nm in terms of equivalent circular diameter, and the number of coated grains of the photosensitive silver halide is from 2000 grains/μm² to 8000 grains/μm².

Preferably, in formula (FC-1) described above, (p+q) is 3.

Preferably, Rf described above is represented by the following

formula (FC-1-C).

-Rc-Re—W Formula (FC-1-C):

In formula (FC-1-C), Rc represents a bond or a straight-chain alkylene group having 4 or fewer carbon atoms; Re represents a perfluoroalkylene group having 2 to 6 carbon atoms; and W represents a hydrogen atom or a fluorine atom.

Preferably, Rf is a C₄F₉ group or a C₉F₁₇ group.

Preferably, the reducing agent for silver ions is a compound represented by the following formula (R1).

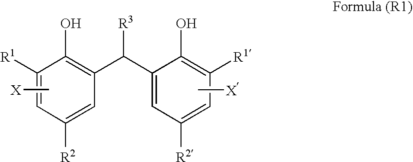

In formula (R1), R¹ and R^{1′} each independently represent an alkyl group having 1 to 20 carbon atoms; R² and R^{2′} each independently represent a hydrogen atom or a substituent which substitutes for a hydrogen atom on a benzene ring; R³ represents a substituent which forms a 3- to 7-membered ring formed from atoms selected from among carbon, oxygen, nitrogen, sulfur, and phosphorus; and X and X′ each independently represent a hydrogen atom or a group substituting for a hydrogen atom on a benzene ring.

In one preferable embodiment, 50% by weight or more of the binder in the image forming layer is poly(vinyl butyral). More preferably, the poly(vinyl butyral) is a mixture of poly(vinyl acetal) of a low polymerization degree and poly(vinyl acetal) of a high polymerization degree.

Preferably, the poly(vinyl acetal) of a low polymerization degree is poly(vinyl butyral) having a weight-average polymerization degree of from 200 to 600. Preferably, the poly(vinyl acetal) of a high polymerization degree is poly(vinyl butyral) having a weight-average polymerization degree of from 900 to 3000. Preferably, a weight ratio of the poly(vinyl acetal) of a low polymerization degree to the poly(vinyl acetal) of a high polymerization degree is from 5/95 to 95/5.

In another preferable embodiment, 50% by weight or more of the binder in the image forming layer is a polymer latex.

Preferably, a mean particle size of the non-photosensitive organic silver salt is 0.4 μm or less in terms of equivalent spherical diameter.

Preferably, the non-photosensitive organic silver salt is a silver salt formed by a reaction between a potassium salt of an organic acid and silver nitrate.

Preferably, the non-photosensitive organic silver salt is nanoparticles. More preferably, the nanoparticles are prepared in the presence of at least one dispersing agent comprising polyacrylamide or a derivative thereof.

Preferably, the photothermographic material of the present invention includes a compound represented by the following formula (1) on the side having the image forming layer.

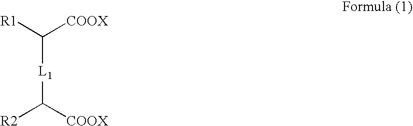

In formula (1), L₁ represents a bond or a divalent linking group; R1 and R2 each independently represent a hydrogen atom, or a hydrocarbon group which may bond to each other to form a ring; X represents a hydrogen atom or a cation; and when X is a cation having a valency of 2 or more, the two carboxy groups may chelate with a single X.

Preferably, the photothermographic material of the present invention includes the compound represented by formula (1) described above on the side having the image forming layer in an amount of from 0.2 g/m² to 1.0 g/m².

Preferably, the photothermographic material of the present invention includes the compound represented by formula (1) described above in an amount of from 10 mol % to 30 mol % per 1 mol of silver on the side having the image forming layer.

Preferably, the compound represented by formula (1) described above is represented by the following formula (2).

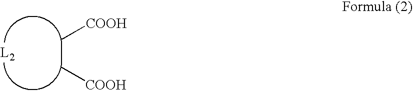

In formula (2), L₂ represents a 6- to 8-membered, substituted or unsubstituted, saturated or unsaturated hydrocarbon ring.

Preferably, the photothermographic material of the present invention includes at least two compounds represented by formula (1).

The image forming method of the present invention is an image forming method for forming an image by imagewise exposing and thermally developing the above-described photothermographic material, wherein the imagewise exposure is executed by scanning exposure using a laser beam forming a beam spot diameter of 25 μm or less on the exposed surface of the photothermographic material, and the thermal development is executed by heating at 100° C. to 200° C. for a period of from 1 sec to 60 sec. Preferably, the image forming method is characterized in that it provides a maximum image density of 4 or higher.

According to the present invention, a photothermographic material and an image forming method which exhibit excellent coating ability, excellent surface state, and high image quality are provided. Further, as an unexpected effect, deterioration of image storage stability in a dark and hot place is improved.

The present invention is explained below in detail.

The photothermographic material of the present invention is characterized in that it has, on at least one side of a support, an image forming layer including at least a photosensitive silver halide, a non-photosensitive organic silver salt, a reducing agent for silver ions, and a binder, and at least one non-photosensitive layer, wherein a mean grain size of the photosensitive silver halide is from 10 nm to 40 nm in terms of equivalent circular diameter, a number of coated grains thereof is from 550 grains/μm² to 10000 grains/μm², and the photothermographic material comprises a fluorocarbon compound represented by formula (FC-1), (FC-2), or (FC-3) described above.

In the present invention, by using photosensitive silver halide particles with a mean grain size of from 10 nm to 40 nm in an amount of coated grains of from 550 grains/μm² to 10000 grains/μm² and using a fluorocarbon compound represented by formula (FC-1), (FC-2), or (FC-3) described above, a photothermographic material, which exhibits excellent coated surface state and provides images with high quality, is accomplished. When the mean grain size exceeds 40 nm, it is not preferred because the total amount of coated silver halide increases to increase film turbidity and halation, resulting in deterioration of image quality. When the mean grain size is too small, it is not preferred because it becomes difficult to obtain sufficient sensitivity. On the other hand, when the number of coated grains is greater than the upper limit of the above range, it is not preferred because film turbidity and halation increase to deteriorate image quality. In contrast, when the number of coated grains is too small, it is not preferred because granularity is deteriorated and maximum image density (Dmax) is lowered.

The photothermographic material of the present invention may have a surface protective layer disposed on the image forming layer, or a back layer, a back protective layer, or the like may be disposed on the opposite side of the support from the image forming layer. The photothermographic material of the present invention may be a double-sided type photothermographic material having image forming layers on both sides of a support, or may be a single-sided type photothermographic material having an image forming layer only on one side of a support.

Preferably, the mean grain size of the photosensitive silver halide is from 20 nm to 30 nm.

Preferably, the number of coated grains of the photosensitive silver halide is from 2000 grains/μm² to 8000 grains/μm².

Preferably, in formula (FC-1) described above, (p+q) is 3.

Preferably, Rf is a group represented by formula (FC-1-C) described above, and more preferably, a C₄F₉ group or a C₉F₁₇ group.

Preferably, the reducing agent for silver ions is a compound represented by formula (R1) described above.

In one preferable embodiment of the binder for the image forming layer, 50% by weight or more thereof is poly(vinyl butyral).

Preferably, the poly(vinyl butyral) is a mixture of poly(vinyl acetal) of a low polymerization degree and poly(vinyl acetal) of a high polymerization degree.

Preferably, the poly(vinyl acetal) of a low polymerization degree is poly(vinyl butyral) having a weight-average polymerization degree of from 200 to 600.

Preferably, the poly(vinyl acetal) of a high polymerization degree is poly(vinyl butyral) having a weight-average polymerization degree of from 900 to 3000.

Preferably, a weight ratio of the poly(vinyl acetal) of a low polymerization degree relative to the poly(vinyl acetal) of a high polymerization degree is from 5/95 to 95/5.

In another preferable embodiment of the binder for the image forming layer, 50% by weight or more thereof is a polymer latex.

Preferably, a mean particle size of the non-photosensitive organic silver salt is 0.4 μm or less in terms of equivalent spherical diameter. More preferably, the non-photosensitive organic silver salt is a silver salt formed by a reaction between a potassium salt of an organic acid and silver nitrate.

In another preferable embodiment, the non-photosensitive organic silver salt is nanoparticles. More preferably, the nanoparticles are prepared in the presence of at least one dispersing agent comprising polyacrylamide or a derivative thereof.

The image forming method using the photothermographic material of the present invention is an image forming method which is characterized in that it includes scanning exposure using a laser beam forming a beam spot diameter of 25 μm or less on the exposed surface of the photothermographic material and thermal development by heating at 100° C. to 200° C. for a period of from 1 sec to 60 sec.

According to the image forming method of the present invention, an image of high image quality having high image density with a maximum image density of 4 or higher, which is particularly suitable for mammography, is obtained.

(Photosensitive Silver Halide)

1) Halogen Composition

For the photosensitive silver halide used in the invention, there is no particular restriction on the halogen composition, and silver chloride, silver bromochloride, silver bromide, silver iodobromide, silver iodochlorobromide, or silver iodide can be used. Among these, silver bromide, silver iodobromide, and silver iodide are preferred. The distribution of the halogen composition in a grain may be uniform, the halogen composition may be changed stepwise, or it may be changed continuously. Further, a silver halide grain having a core/shell structure can be used preferably. Preferred structure is a twofold to fivefold structure, and more preferably, a core/shell grain having a twofold to fourfold structure can be used. Further, a technique of localizing silver bromide or silver iodide at the surface of a silver chloride, silver bromide or silver chlorobromide grain can also be used preferably.

2) Grain Size

The mean grain size of the photosensitive silver halide according to the present invention is from 10 nm to 40 nm, preferably from 15 nm to 40 nm, and more preferably from 20 nm to 30 nm. The grain size as used herein means a diameter of a circle converted such that it has the same area as a projected area of the silver halide grain (projected area of a major plane in the case of a tabular grain).

3) Coating Amount

The number of coated grains of the photosensitive silver halide in the photothermographic material of the present invention is from 550 grains/μm² to 10000 grains/μm².

Preferably, the number of coated grains of the photosensitive silver halide is from 2000 grains/μm² to 8000 grains/μm², and more preferably, the number of coated grains of the photosensitive silver halide is from 5000 grains/μm² to 8000 grains/μm².

The addition amount of the photosensitive silver halide according to the present invention depends on the mean grain size thereof, but is preferably from 0.14 g/m² to 0.28 g/m², and more preferably from 0.16 g/m² to 0.24 g/m², when expressed by the amount of coated silver per 1 m² of the photothermographic material.

4) Method of Grain Formation

Preparation of the Photosensitive Silver Halide Fine Grains Used in the present invention can be performed by well-known methods in the relevant art such as, for example, methods described in Research Disclosure No. 17029, June 1978, and U.S. Pat. No. 3,700,458. All of the methods for grain preparation and apparatus therefor which are conventionally well known in the relevant art can be utilized by replacing a part of the gelatin or hydrophilic polymer used in the well-known methods (including published examples) with a polymer soluble in both water and organic solvent.

Specifically, a photosensitive silver halide is prepared by adding a silver-supplying compound and a halogen-supplying compound into a solution containing a polymer soluble in both water and organic solvent and a hydrophilic polymer such as gelatin or the like. In the above method, a method of adding a silver ion aqueous solution and a halide aqueous solution by a double jet method and performing grain formation is particularly preferred.

It is preferred to use gelatin at the time of silver halide grain formation in view of grain formation. Particularly, at the time of forming a core of the silver halide grain, the use of gelatin is preferred. Accordingly, for example, similar results can be obtained by a method in which a silver halide emulsion prepared by using gelatin, which is a hydrophilic binder and used as a dispersing agent, is enclosed by a polymer that is soluble in both water and organic solvent and transferred to the organic solvent phase. Specifically, a photosensitive silver halide emulsion is prepared by using gelatin as a protective colloid (dispersing agent) in the manner described above, and then the resulting emulsion is mixed with an organic solvent or an organic solvent solution (or an organic silver salt dispersion etc.), in which the polymer that is soluble in both water and organic solvent is added in advance. Thereby, aggregation of the silver halide grains is avoided and excellent performance can be attained. For example, a photosensitive silver halide emulsion is prepared by mixing the silver halide emulsion mentioned above with an organic solvent solution containing the polymer that is soluble in both water and organic solvent, and dispersing them.

(Polymer that is Soluble in Both Water and Organic Solvent)

As the polymer that is soluble in both water and organic solvent used in the present invention, any polymer including natural resin, polymer, and their copolymers, synthetic resin, polymer and their copolymers may be used. For example, any modified compounds prepared by modifying gelatins and rubbers to belong to the scope of the present invention can be applied. Furthermore, the polymer included in the following classification can be used by introducing a functional group to suit for the present invention. Examples of the polymer include poly(vinyl alcohols), hydroxyethyl celluloses, cellulose acetates, cellulose acetate butyrates, poly(vinyl pyrrolidones), casein, starch, poly(acrylic acids), poly(acrylic esters), poly(methyl methacrylate), poly(methacrylic acid esters), poly(vinyl chlorides), poly(methacrylic acids), styrene-maleic anhydride copolymers, styrene-acrylonitrile copolymers, styrene-butadiene copolymers, poly(vinyl acetals) (for example, such as poly(vinyl formal) and poly(vinyl butyral)), polyesters, polyurethanes, phenoxy resin, poly(vinylidene chlorides), polyepoxides, polycarbonates, poly(vinyl acetates), polyolefins, cellulose esters, and polyamides. Several polymers among these may form a copolymer. Especially, copolymers prepared by copolymerizing monomers selected from among acrylic acid, methacrylic acid, and esters thereof are preferred.

The polymer that is soluble in both water and organic solvent used in the present invention may be a polymer which is soluble in water and organic solvent in the same state. However, the polymer which is soluble or insoluble in water or in organic solvent depending on the pH control or the temperature control is also included. For example, in nonionic surfactants, a cloud point phenomena is well known. Therefore, the present invention also includes the polymer which becomes hydrophobic and soluble in organic solvent by elevating the temperature and becomes hydrophilic and soluble in water by lowering the temperature. The polymer needs not to be dissolved completely, and it is enough that the polymer forms a micelle to be emulsified uniformly. Or concerning polymer having an acidic group such as carboxylic acid, some of them are hydrophilic in the dissociated state but becomes hydrophobic and soluble in organic solvent in the undissociated state by lowering the pH. On the contrary, polymer having an amino group becomes hydrophobic by raising the pH but is ionized to increase water solubility by lowering the pH. In the present invention, various types of monomers are used in combination, so it is impossible to mention what monomer is good or how much to be used is good. However, it is easy to understand that the desired polymer can be obtained by combining hydrophilic monomer and hydrophobic monomer in an appropriate ratio.

For the polymer that is soluble in both water and organic solvent, preferably used is a polymer which has a solubility in water of 1% by weight or more (25° C.) and a solubility in methyl ethyl ketone as the organic solvent of 5% by weight or more (25° C.) by adjusting the dissolving condition such as pH or the like as described above or without any adjustment.

As the polymer that is soluble in both water and organic solvent used in the present invention, so-called block polymer and comb-like (graft) polymer are more preferred than straight-chain polymer from the viewpoint of solubility. Especially, the comb-like polymer is preferred. Various means can be used for the preparation of the comb-like polymer, but the use of a monomer capable of introducing a side chain having a molecular weight of 200 or more in the comb-like portion (side chain) is preferred. Among them, the use of an ethylenic unsaturated monomer containing polyoxyalkylene group such as ethylene oxide or propylene oxide is preferred.

As the ethylenic unsaturated monomer containing polyoxyalkylene group, a monomer having a polyoxyalkylene group represented the following formula is particularly preferred.

-(EO)ₗ—(PO)ₘ-(TO)ₙ—R

In the formula, E represents an ethylene group; P represents a propylene group; T represents a butylene group; and R represents a substituent. The butylene group includes a tetramethylene group, an isobutylene group, and the like. l represents an integer of from 1 to 300, m represents an integer of from 0 to 60, and n represents an integer of from 0 to 40. Preferably, l is an integer of from 1 to 200, m is an integer of from 0 to 30, and n is an integer of from 0 to 20. However, I+m+n≧2.

The substituent represented by R represents an alkyl group, an aryl group, a heterocyclic group, or the like. Examples of the alkyl group include a methyl group, an ethyl group, a propyl group, a butyl group, a hexyl group, an octyl group, a dodecyl group, and the like. Examples of the aryl group include a phenyl group, a naphthyl group, and the like. Examples of the heterocyclic group include a thienyl group, a pyridyl group, and the like. The above groups may be further substituted by a halogen atom, an alkoxy group (a methoxy group, an ethoxy group, a butoxy group, or the like), an alkylthio group (a methylthio group, a butylthio group, or the like), an acyl group (an acetyl group, a benzoyl group, or the like), an alkane amido group (an acetamido group, a propionamido group, or the like), an arylamido group (benzoylamido group or the like), or the like. These substituents may be further substituted by these substituents.

The polyoxyalkylene group represented by the formula described above can be introduced to the polymer by using an ethylenic unsaturated monomer having the polyoxyalkylene group. Examples of the ethylenic unsaturated monomer having the polyoxyalkylene group include (polyoxyalkylene) acrylate, (polyoxyalkylene) methacrylate, and the like. The (polyoxyalkylene) acrylate and (polyoxyalkylene) methacrylate can be prepared by reacting commercially available hydroxy poly(oxyalkylene) material such as, for example, Pluronic and Adeka Polyether (trade name, all available from Asahi Denka Kogyo K.K.), Carbowax (trade name, available from The Dow Chemical Company), Toriton (trade name, available from Rohm & Haas Co., Ltd.), or P.E.G (trade name, available from Dai-ichi Kogyo Seiyaku Co., Ltd.) with acrylic acid, methacrylic acid, acrylchloride, methacrylchloride, acrylic anhydride, or the like according to a well-known method. Separately, poly(oxyalkylene) diacrylate or the like prepared by a well-known method can be also used.

Examples of the commercially available monomer include, as hydroxy group end-capped polyalkylene glycol monomethacrylate manufactured by NOF Corporation, BLEMMER PE-90, BLEMMER PE-200, BLEMMER PE-350, BLEMMER AE-90, BLEMMER AE-200, BLEMMER AE-400, BLEMMER PP-1000, BLEMMER PP-500, BLEMMER PP-800, BLEMMER AP-150, BLEMMER AP-400, BLEMMER AP-550, BLEMMER AP-800, BLEMMER 50PEP-300, BLEMMER 70PEP-350B, BLEMMER AEP series, BLEMMER 55PET-400, BLEMMER 30PET-800, BLEMMER 55PET-800, BLEMMER AET series, BLEMMER 30PPT-800, BLEMMER 50PPT-800, BLEMMER 70PPT-800, BLEMMER APT series, BLEMMER 10PPB-500B, BLEMMER 10APB-500B, and the like. Similarly, as alkyl end-capped polyalkylene glycol monomethacrylate, there are described BLEMMER PME-100, BLEMMER PME-200, BLEMMER PME-400, BLEMMER PME-1000, BLEMMER PME-4000, BLEMMER AME-400, BLEMMER 50POEP-800B, BLEMMER 50AOEP-800B, BLEMMER PLE-200, BLEMMER ALE-200, BLEMMER ALE-800, BLEMMER PSE-400, BLEMMER PSE-1300, BLEMMER ASEP series, BLEMMER PKEP series, BLEMMER AKEP series, BLEMMER ANE-300, BLEMMER ANE-1300, BLEMMER PNEP series, BLEMMER PNPE series, BLEMMER 43ANEP-500, BLEMMER 70ANEP-550, and the like (all manufactured by NOF Corporation), and LIGHT-ESTER MC, LIGHT-ESTER 130MA, LIGHT-ESTER 041MA, LIGHT-ACRYLATE BO-A, LIGHT-ACRYLATE EC-A, LIGHT-ACRYLATE MTG-A, LIGHT-ACRYLATE 130A, LIGHT-ACRYLATE DPM-A, LIGHT-ACRYLATE P-200A, LIGHT-ACRYLATE NP-4EA, LIGHT-ACRYLATE NP-8EA, and the like (all manufactured by Kyoeisha Chemical Co., Ltd.).

In the present invention, graft polymers prepared by using a so-called macromer can be also used. They are described, for example, in [Shin Kobunshi Jikkengaku (New Experimental Study on Polymers), No. 2, Kobunshi no Gosei/Hannou (Synthesis and Reaction of Polymers)] edited by Kobunshi Gakkai (the Society of Polymer Science), published by Kyoritsu Shuppan Co., Ltd., 1995, and in more detail in [Makuro Monomer no Kagaku to Kogyo (Chemistry and Industry of Macromonomers)], written by Yuya Yamashita, published by Industrial Publishing & Consulting. Inc., 1989. The molecular weight of the useful macromer is preferably in a range of from 10,000 to 100,000, more preferably from 10,000 to 50,000, and particularly preferably from 10,000 to 20,000. When the molecular weight is less than 10,000, the effect cannot be realized. When the molecular weight is more than 100,000, polymerization with the copolymerization monomer which forms the main chain becomes difficult. Specifically, AA-6, AS-6S, AN-6S, and the like (all manufactured by To a Gosei Co., Ltd.) can be used.

The present invention is not limited to the examples described above. The polyoxyalkylene group-containing ethylenic unsaturated monomer may be used alone or two or more of them may be used simultaneously. Separately, a copolymer prepared by reacting with other copolymerization monomer, or a block polymer prepared by reacting a polymer formed from the polyoxyalkylene group-containing ethylenic unsaturated monomer with other polymer may be also included.

Examples of the other copolymerization monomer which reacts with the monomer mentioned above are described below.

Acrylic esters: methyl acrylate, ethyl acrylate, propyl acrylate, chloroethyl acrylate, 2-hydroxyethyl acrylate, trimethylolpropane monoacrylate, benzyl acrylate, methoxybenzyl acrylate, furfuryl acrylate, tetrahydro furfuryl acrylate, and the like; methacrylic acid esters: methyl methacrylate, ethyl methacrylate, propyl methacrylate, chloroethyl methacrylate, 2-hydroxyethyl methacrylate, trimethylolpropane monomethacrylate, benzyl methacrylate, methoxybenzyl methacrylate, furfuryl methacrylate, tetrahydro furfuryl methacrylate, and the like; acrylic amides: acrylamide, N-alkyl acrylamide (as the alkyl group, an alkyl group having 1 to 3 carbon atoms, for example, a methyl group, an ethyl group, or a propyl group is used), N,N-dialkyl acrylamide, N-hydroxyethyl-N-methyl acrylamide, N-2-acetamidoethyl-N-acetyl acrylamide, and the like; alkyloxy acrylamide: methoxymethyl acrylamide, butoxymethyl acrylamide, and the like; methacrylamides: methacrylamide, N-alkyl methacrylamide, N-hydroxyethyl-N-methyl methacrylamide, N-2-acetamidoethyl-N-acetyl methacrylamide, methoxymethyl methacrylamide, butoxymethyl methacrylamide, and the like; ally compounds: allyl esters (for example, allyl acetate, allyl caproate, allyl caprylate, allyl laurylate, allyl palmitate, allyl stearate, allyl benzoate, allyl acetoacetate, allyl lactate, and the like), allyl oxyethanol, and the like; vinyl ethers: alkyl vinyl ether (for example, hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-dimethylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, tetrahydro furfuryl vinyl ether, and the like); vinyl esters: vinyl butyrate, vinyl isobutyrate, vinyl trimethylacetate, vinyl diethylacetate, vinyl valerate, vinyl caproate, vinyl chloroacetate, vinyl dichloroacetate, vinyl methoxyacetate, vinyl butoxyacetate, vinyl lactate, vinyl-β-phenylbutyrate, vinyl cyclohexylcarboxylate, and the like; dialkyl itaconates: dimethyl itaconate, diethyl itaconate, dibutyl itaconate and the like; dialkyl esters or monoalkyl esters of fumaric acid: dibutyl fumalate and the like. In addition, crotonic acid, itaconic acid, acrylonitrile, methacrylonitrile, maleilonitrile, styrene, and the like are described.

In the case of introducing an amide group, a straight-chain or branched alkyl group having 4 to 22 carbon atoms, an aromatic group, or a 5- or more membered heterocyclic group, the above monomers or the other monomers including the mentioned functional groups may be selected. For example, in the case of introducing 5- or more membered heterocyclic group, 1-vinyl imidazole or a derivative thereof can be used. Various functional groups described above can be introduced to the polymer by adding isocyanate or an epoxy group therein beforehand, and then reacting the resultant with alcohols or amines which contain a straight-chain or branched alkyl group, an aromatic group or a 5- or more membered heterocyclic group. The isocyanate or epoxy group can be easily introduced by using KARENZ MOI (manufactured by Showa Denko K.K.) and BLEMMER G (manufactured by NOF Corporation). The introduction of urethane bonding is also preferred in the present invention.

As the polymerization initiator, an azo type polymerization initiator or an organic peroxide compound can be used.

Examples of the azo type polymerization initiator include ABN-R (2,2′-azobis isobutyronitrile), ABN-V (2,2′-azobis(2,4-dimethyl valeronitrile)), ABN-E (2,2′-azobis(2-methylbutylonitrile)) (all manufactured by Japan Hydrazine Company. Inc.), and the like. Examples of the organic peroxide compound include benzoyl peroxide, dimethyl ethyl ketone peroxide, lauryl peroxide; and PERTERA A, PERHEXA HC, PERHEXA TMH, PERHEXA C, PERHEXA V, PERHEXA 22, PERHEXA MC, PERBUTYL H, PERCUMYL H, PERCUMYL P, PERMENTA H, PEROCTA H, PERBUTYL C, PERBUTYL D, PERHEXYL D, PEROYL IB, PEROYL 355, PEROYL L, PEROYL S, PEROYL SA, NYPER BW, NYPER BMT-K40, NYPER BMT-T40, NYPER BMT-M, PEROYL IPP, PEROYL NPP, PEROYL TCP, PEROYL EEP, PEROYL MBP, PEROYL OPP, PEROYL SBP, PERCUMYL ND, PEROCTA ND, PERCYCLO ND, PERHEXYL ND, PERBUTYL ND, PERHEXYL PV, PERHEXA 250, PEROCTA O, PERHEXYL O, PERBUTYL O, PERBUTYL IB, PERBUTYL L, PERBUTYL 355, PERHEXYL I, PERBUTYL I, PERBUTYL E, PERHEXA 25Z, PERHEXA 25MT, PERBUTYL A, PERHEXYL Z, PERBUTYL ZT, PERBUTYL Z, and the like (trade name, available from NOF Corporation).

As the polymerization inhibitor used in the present invention, quinone type inhibitor such as hydroquinone, p-methoxy phenol, or the like can be used. Examples of the quinone type polymerization inhibitor include phenothiazine, methoquinone, Nonflexalba, MH (methyl hydroquinone), TBH (tert-butyl hydroquinone), PBQ (p-benzoquinone), toluquinone, TBQ (tert-butyl-p-benzoquinone), 2,5-diphenyl-p-benzoquinone, and the like (all available from Seiko Chemical Co., Ltd.).

In the present invention, the polymer preferably has an isoelectric point of pH 6 or less. When the polymer having a high isoelectric point is used, as described later, decomposition of silver halide grains is accelerated at the desalting process of silver halide grains by aggregation precipitation, and as a result, it exert adverse influences on photographic performance. Moreover, it becomes difficult to conduct dispersion, at the time of dispersion of silver halide fine particles in the solvent, without raising the pH, which causes unfavorable fogging. Measurement of an isoelectric point of the polymer can be carried out by an isoelectric point electrophoresis method or a pH measurement after passing a 1% by weight aqueous solution through a mixed-bed column packed with a mixture of cation and anion ion exchange resins.

In order to lower the isoelectric point of the polymer, various acidic groups can be introduced therein, for example, including a carboxylic acid group or a sulfonic acid group. The introduction of carboxylic acid can be achieved by using monomer of acrylic acid or methacrylic acid or by partially hydrolyzing the polymer having a methyl methacrylate group. The introduction of sulfonic acid group can be attained by using styrene sulfonic acid or 2-acrylamide-2-methyl propane sulfonic acid as a monomer or by applying various sulfating techniques after preparation of the polymer. Particularly, the use of carboxylic acid is preferred, because the solvent solubility is relatively high in the non-neutralized state and the polymer formed can be modified to have a water-soluble property in the full or partially neutralized state. The neutralization can be carried out by forming sodium salt, potassium salt, or organic salt such as ammonium salt or salt of monoethanolamine, diethanolamine, or triethanolamine. Imidazoles, triazoles, and amidoamines also can be used.

The polymerization can be performed either in the presence of the solvent or under absence of the solvent, however it is preferably carried out in the presence of the solvent from the standpoint of operational procedure. Examples of the solvent include alcohols such as ethanol, isopropyl alcohol, n-butanol, iso-butanol, tert-butanol, and the like; ketones such as acetone, methyl ethyl ketone, methyl isobutyl ketone, methyl amyl ketone and the like; esters such as methyl acetate, ethyl acetate, butyl acetate, methyl lactate, ethyl lactate, butyl lactate, and the like; monocarboxylic acid esters such as methyl 2-oxypropionate, ethyl 2-oxypropionate, propyl 2-oxypropionate, butyl 2-oxypropionate, methyl 2-methoxypropionate, ethyl 2-methoxypropionate, propyl 2-methoxypropionate, butyl 2-methoxypropionate, and the like; polar solvents such as dimethylformamide, dimethylsulfoxide, N-methylpyrrolidone, and the like; ethers such as methyl cellosolve, cellosolve, butyl cellosolve, butyl carbitol, ethyl cellosolve acetate, and the like; propylene glycols and their ethers such as propylene glycol, propylene glycol monomethyl ether, propylene glycol monomethyl ether acetate, propylene glycol monoethyl ether acetate, propylene glycol monobutyl ether acetate, and the like; halogen solvents such as 1,1,1-trichloroethane, chloroform, and the like; ethers such as tetrahydrofuran, dioxane, and the like; aromatic compounds such as benzene, toluene, xylene, and the like; and fluorocarbon inert liquids such as perfluorooctane, perfluoro tri-n-butylamine, and the like.

A dropping polymerization method, in which polymerization is performed while dropping the monomer and the polymerization initiator in a reaction vessel depending on the polymerization ability of each monomer, is effective for obtaining polymers having an uniform composition. The unreacted monomer can be removed by column filtration, reprecipitation process, solvent extraction, or the like. Or the unreacted monomer having a low boiling point can be removed by stripping.

The polymer dispersions obtained by emulsion polymerization or suspension polymerization also can be used under the absence of the solvent. Methods for preparing the polymer mentioned above are described in, for example, [Gousei Ratekusu no Kagaku (Chemistry of Synthetic Latex)] written by Souichi Muroi, published by Kobunshi Kankokai, 1970.

The molecular weight of the polymers is preferably in a range of from 10,000 to 200,000, more preferably from 20,000 to 150,000, and even more preferably from 30,000 to 100,000, in terms of weight-average molecular weight based on a polystyrene-reduced value measured by gel permeation chromatography (GPC). When the molecular weight is less than 10,000, the protective colloid action for the silver halide grain is so weak that dispersibility is not sufficiently obtained to micronize silver halide grains. When the molecular weight is too large, viscosity of the dispersion may increase or aggregation of silver halide grains may occur.

In the case when the synthetic polymer used in the present invention is an acrylic polymer, various polymerization methods such as ion polymerization, living polymerization method, and the like can be used in addition to the conventional radical polymerization. For example, reference can be made to [Kikan Kagaku Sousetsu (Quarterly Chemical Review) No. 18 Precise Polymerization] planned by Chemical Society of Japan, edited by Takeo Shimizu et al. All materials well known in the art can be applied for the polymerization initiator and the catalysis.

Furthermore, modified gelatins are also preferably used for the polymer that is soluble in both water and organic solvent. Examples of hydrophobic modification of amino group in the gelatin molecule include, but are not particularly limited to, phenylcarbamoylation, phthalation, succination, acetylation, benzoylation, nitrophenylation, and the like. The substitution ratio thereof is preferably 95% or higher, and more preferably 99% or higher. Combination with the hydrophobic modification of carboxy group is also preferred. Examples of the modification include, but are not particularly limited to, methyl esterification and amidation. The substitution ratio of the carboxy group is preferably from 50% to 90%, and more preferably from 70% to 90%.

In addition, the method of forming photosensitive silver halide is well known in the relevant art, and the known technology can be applied depending on needs. For example, methods described in Research Disclosure No. 17,029, June 1978 and U.S. Pat. No. 3,700,458 can be used. Specifically, a method of preparing a photosensitive silver halide by adding a silver-supplying compound and a halogen-supplying compound in a gelatin or other polymer solution and then mixing them with an organic silver salt is used. Further, a method described in JP-A No. 11-119374 (paragraph Nos. 0217 to 0224) and methods described in JP-A Nos. 11-352627 and 2000-347335 are also preferred.

5) Grain Shape

The shape of the silver halide grain includes, for example, cubic, octahedral, tabular, spherical, rod-like, and potato-like shape. In the present invention, a cubic grain is particularly preferred. A silver halide grain rounded at corners can also be used preferably.

The surface indices (Miller indices) of the outer surface of a photosensitive silver halide grain are not particularly restricted, and it is preferable that the ratio occupied by the {100} face is large, because of showing high spectral sensitization efficiency when a spectral sensitizing dye is adsorbed. The ratio is preferably 50% or higher, more preferably 65% or higher, and even more preferably 80% or higher. The ratio of the {100} face, Miller indices, can be determined by a method utilizing adsorption dependency of the {111} face and {100} face upon adsorption of a sensitizing dye, which is described in T. Tani; J. Imaging Sci., vol. 29, page 165, (1985).

6) Heavy Metal

The photosensitive silver halide grain according to the invention can contain metals or complexes of metals belonging to groups 6 to 13 of the periodic table (showing groups 1 to 18). Preferred are metals or complexes of metals belonging to groups 6 to 10. The metal or the center metal of the metal complex from groups 6 to 10 of the periodic table is preferably ferrum, rhodium, ruthenium, or iridium. The metal complex may be used alone, or two or more complexes comprising identical or different species of metals may be used in combination. A preferred content is in a range of from 1×10⁻⁹ mol to 1×10⁻³ mol per 1 mol of silver. The heavy metals, metal complexes, and the addition method thereof are described in JP-A No. 7-225449, in paragraph Nos. 0018 to 0024 of JP-A No. 11-65021, and in paragraph Nos. 0227 to 0240 of JP-A No. 11-119374.

In the present invention, a silver halide grain having a hexacyano metal complex present on the outermost surface of the grain is preferred. The hexacyano metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano metal complex exists in an ionic form in an aqueous solution, counter cation is not important, but an alkaline metal ion such as sodium ion, potassium ion, rubidium ion, cesium ion, or lithium ion, ammonium ion, or an alkyl ammonium ion (for example, tetramethyl ammonium ion, tetraethyl ammonium ion, tetrapropyl ammonium ion, or tetra(n-butyl) ammonium ion), each of which is easily miscible with water and suitable to precipitation operation of silver halide emulsion, is preferably used.

The hexacyano metal complex can be added while being mixed with water, as well as a mixed solvent of water and an appropriate organic solvent miscible with water (for example, alcohols, ethers, glycols, ketones, esters, amides, or the like) or gelatin.

The addition amount of the hexacyano metal complex is preferably from 1×10⁻⁵ mol to 1×10⁻² mol, and more preferably from 1×10⁻⁴ mol to 1×10⁻³ mol, per 1 mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation; before completion of an emulsion formation step prior to a chemical sensitization step of conducting chalcogen sensitization such as sulfur sensitization, selenium sensitization, or tellurium sensitization, or noble metal sensitization such as gold sensitization; during a washing step; during a dispersion step; and before a chemical sensitization step. In order not to grow fine silver halide grains, the hexacyano metal complex is preferably added rapidly after the grain is formed, and it is preferably added before completion of the emulsion formation step.

Addition of the hexacyano metal complex may be started after addition of 96% by weight of an entire amount of silver nitrate to be added for grain formation, more preferably started after addition of 98% by weight, and particularly preferably, started after addition of 99% by weight.

When any of the hexacyano metal complexes is added after addition of an aqueous solution of silver nitrate just prior to completion of grain formation, it can be adsorbed to the outermost surface of the silver halide grain, and most of the complex forms an insoluble salt with silver ions on the surface of the grain. Since silver hexacyanoferrate (II) is a salt less soluble than silver iodide, re-dissolution with fine grains can be prevented, and it becomes possible to prepare fine silver halide grains with smaller grain size.

Metal atoms that can be contained in the silver halide grain used in the invention (for example, [Fe(CN)₆]⁴⁻), and the desalting method and chemical sensitizing method of silver halide emulsion are described in paragraph Nos. 0046 to 0050 of JP-A No. 11-84574, in paragraph Nos. 0025 to 0031 of JP-A No. 11-65021, and in paragraph Nos. 0242 to 0250 of JP-A No. 11-119374.

7) Gelatin

As the gelatin which is contained in the photosensitive silver halide emulsion used in the invention, various types of gelatin can be used. It is necessary to maintain an excellent dispersion state of a photosensitive silver halide emulsion in the coating solution containing an organic silver salt, and gelatin having a molecular weight of 10,000 to 1,000,000 is preferably used. Phthalated gelatin is also preferably used. The gelatin may be used at the time of grain formation or at the time of dispersion after desalting treatment, and it is preferably used at the time of grain formation.

8) Sensitizing Dye

As the sensitizing dye which can be used in the invention, a sensitizing dye which spectrally sensitizes the silver halide grains in a desired wavelength region upon adsorption to the silver halide grains and which has spectral sensitivity suitable to the spectral characteristic of an exposure light source can be advantageously selected. The sensitizing dyes and the addition method are described, for example, as compounds described in paragraph Nos. 0103 to 0109 of JP-A No. 11-65021, compounds represented by formula (II) in JP-A No. 10-186572, dyes represented by formula (I) and described in paragraph No. 0106 of JP-A No. 11-119374, dyes described in U.S. Pat. No. 5,510,236 and in the Example 5 of U.S. Pat. No. 3,871,887, dyes disclosed in JP-A Nos. 2-96131 and 59-48753, as well as in page 19, line 38 to page 20, line 35 of EP No. 0803764A1, and in JP-A Nos. 2001-272747, 2001-290238, and 2002-23306, and the like. The sensitizing dye may be used alone, or two or more of them may be used in combination. In the invention, sensitizing dye is preferably added in the silver halide emulsion at the time after a desalting step and before coating, and more preferably at the time after desalting and before completion of chemical ripening.

In the invention, the sensitizing dye may be added at any amount according to the property of sensitivity or fogging, but it is preferably added in an amount of from 10⁻⁶ mol to 1 mol, and more preferably from 10⁻⁴ mol to 10⁻¹ mol, per 1 mol of silver halide in the image forming layer.

In the invention, a super sensitizer can be used in order to improve the spectral sensitizing effect. The super sensitizer that can be used in the invention includes those compounds described in EP-A No. 587,338, U.S. Pat. Nos. 3,877,943 and 4,873,184, JP-A Nos. 5-341432, 11-109547, and 10-111543, and the like.

9) Chemical Sensitization

The photosensitive silver halide grain according to the invention is preferably chemically sensitized by sulfur sensitizing method, selenium sensitizing method, or tellurium sensitizing method. As the compounds used preferably for sulfur sensitizing method, selenium sensitizing method, and tellurium sensitizing method, known compounds, for example, compounds described in JP-A No. 7-128768 and the like can be used. Particularly, tellurium sensitization is preferred in the invention, and compounds described in the literature cited in paragraph No. 0030 in JP-A No. 11-65021 and compounds represented by formula (II), (III), or (IV) in JP-A No. 5-313284 are more preferred.

The photosensitive silver halide grain in the invention is preferably chemically sensitized by gold sensitizing method alone or in combination with the chalcogen sensitization described above. As the gold sensitizer, those having an oxidation number of gold of either +1 or +3 are preferred, and those gold compounds usually used as the gold sensitizer are preferred. As typical examples, chloroauric acid, bromoauric acid, potassium chloroaurate, potassium bromoaurate, auric trichloride, potassium auric thiocyanate, potassium iodoaurate, tetracyanoauric acid, ammonium aurothiocyanate, and pyridyl trichloro gold are preferred. Further, gold sensitizers described in U.S. Pat. No. 5,858,637 and JP-A No. 2002-278016 are also used preferably.

In the invention, chemical sensitization can be applied at any time so long as it is after grain formation and before coating, and it can be applied, after desalting, (1) before spectral sensitization, (2) simultaneously with spectral sensitization, (3) after spectral sensitization, (4) just prior to coating, or the like.

The amount of sulfur, selenium, or tellurium sensitizer used in the invention may vary depending on the silver halide grain used, the chemical ripening condition, and the like, and it is used in an amount of from 10⁻⁸ mol to 10⁻² mol, and preferably from 10⁻⁷ mol to 10⁻³ mol, per 1 mol of silver halide.

The addition amount of the gold sensitizer may vary depending on various conditions, and it is generally from 10⁻⁷ mol to 10⁻³ mol, and preferably from 10⁻⁶ mol to 5×10⁻⁴ mol, per 1 mol of silver halide.

There is no particular restriction on the condition for the chemical sensitization in the invention, and appropriately, the pH is from 5 to 8, the pAg is from 6 to 11, and the temperature is from 40° C. to 95° C.

In the silver halide emulsion used in the invention, a thiosulfonic acid compound may be added by the method shown in EP-A No. 293,917.

A reduction sensitizer is preferably used for the photosensitive silver halide grain according to the invention. As the specific compound for the reduction sensitizing method, ascorbic acid or aminoimino methane sulfinic acid is preferred, as well as the use of stannous chloride, a hydrazine derivative, a borane compound, a silane compound, or a polyamine compound is preferred. The reduction sensitizer may be added at any stage in the photosensitive emulsion production process from crystal growth to the preparation step just prior to coating. Further, it is preferred to apply reduction sensitization by ripening while keeping the pH to 7 or higher or the pAg to 8.3 or lower for the emulsion, and it is also preferred to apply reduction sensitization by introducing a single addition portion of silver ions during grain formation.

10) Compound that is One-Electron-Oxidized to Provide a One-Electron Oxidation Product which Releases One or More Electrons

The photothermographic material of the present invention preferably contains a compound that is one-electron-oxidized to provide a one-electron oxidation product which releases one or more electrons. The said compound can be used alone or in combination with various chemical sensitizers described above to increase the sensitivity of silver halide.

The compound that is one-electron-oxidized to provide a one-electron oxidation product which releases one or more electrons, which is contained in the photothermographic material of the invention, is a compound selected from the following Groups 1 or 2.

(Group 1) a compound that is one-electron-oxidized to provide a one-electron oxidation product which further releases one or more electrons due to being subjected to a subsequent bond cleavage reaction;

(Group 2) a compound that is one-electron-oxidized to provide a one-electron oxidation product which further releases one or more electrons after being subjected to a subsequent bond formation reaction.

The compound of Group 1 will be explained below.

In the compound of Group 1, as a compound that is one-electron-oxidized to provide a one-electron oxidation product which further releases one electron due to being subjected to a subsequent bond cleavage reaction, specific examples include examples of compound referred to as “one photon two electrons sensitizer” or “deprotonating electron-donating sensitizer” described in JP-A No. 9-211769 (specific examples: Compound PMT-1 to S-37 in Tables E and F, pages 28 to 32); JP-A No. 9-211774; JP-A No. 11-95355 (specific examples: Compound INV 1 to 36); JP-W No. 2001-500996 (specific examples: Compound 1 to 74, 80 to 87, and 92 to 122); U.S. Pat. Nos. 5,747,235 and 5,747,236; EP No. 786,692A1 (specific examples: Compound INV 1 to 35); EP No. 893,732A1; U.S. Pat. Nos. 6,054,260 and 5,994,051; etc. Preferred ranges of these compounds are the same as the preferred ranges described in the quoted specifications.

In the compound of Group 1, as a compound that is one-electron-oxidized to provide a one-electron oxidation product which further releases one or more electrons due to being subjected to a subsequent bond cleavage reaction, specific examples include the compounds represented by formula (1) (same as formula (1) described in JP-A No. 2003-114487), formula (2) (same as formula (2) described in JP-A No. 2003-114487), formula (3) (same as formula (1) described in JP-A No. 2003-114488), formula (4) (same as formula (2) described in JP-A No. 2003-114488), formula (5) (same as formula (3) described in JP-A No. 2003-114488), formula (6) (same as formula (1) described in JP-A No. 2003-75950), formula (7) (same as formula (2) described in JP-A No. 2003-75950), and formula (8) (same as formula (1) described in JP-A No. 2004-239943), and the compound represented by formula (9) (same as formula (3) described in JP-A No. 2004-245929) among the compounds which can undergo the reaction represented by chemical reaction formula (1) (same as chemical reaction formula (1) described in JP-A No. 2004-245929). Preferable ranges of these compounds are the same as the preferable ranges described in the quoted specifications.

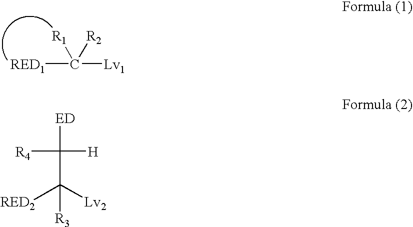

In formulae (1) and (2), RED₁ and RED₂ each independently represent a reducing group. R₁ represents a nonmetallic atomic group forming a cyclic structure equivalent to a tetrahydro derivative or hexahydro derivative of a 5- or 6-membered aromatic ring (including an aromatic heterocycle) with the carbon atom (C) and RED₁. R₂, R₃, and R₄ each independently represent a hydrogen atom or a substituent. Lv₁ and Lv₂ each independently represent a leaving group. ED represents an electron-donating group.

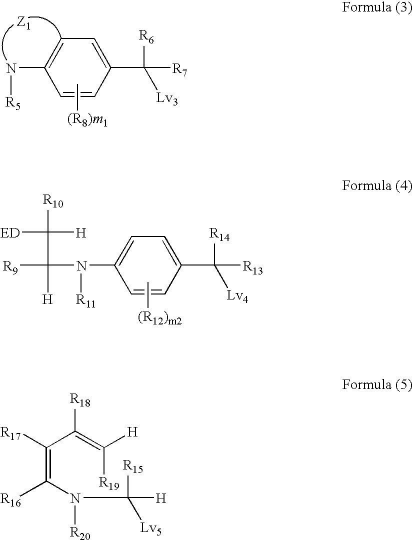

In formulae (3), (4), and (5), Z₁ represents an atomic group forming a 6-membered ring with a nitrogen atom and two carbon atoms of the benzene ring. R₅, R₆, R₇, R₉, R₁₀, R₁₁, R₁₃, R₁₄, R₁₅, R₁₆, R₁₇, R₁₈, and R₁₉ each independently represent a hydrogen atom or a substituent. R₂₀ represents a hydrogen atom or a substituent; however, in the case where R₂₀ represents a group other than an aryl group, R₁₆ and R₁₇ bond to each other to form an aromatic ring or an aromatic heterocycle. R₈ and R₁₂ represent a substituent which substitutes for a hydrogen atom on a benzene ring. m₁ represents an integer of from 0 to 3, and m2 represents an integer of from 0 to 4. Lv₃, Lv₄, and Lv₅ each independently represent a leaving group.

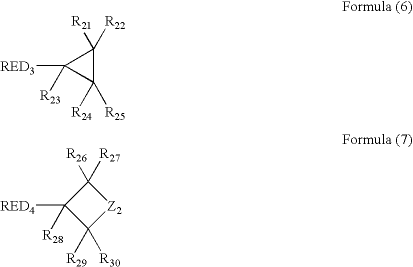

In formulae (6) and (7), RED₃ and RED₄ each independently represent a reducing group. R₂₁ to R₃₀ each independently represent a hydrogen atom or a substituent. Z₂ represents —CR₁₁₁R₁₁₂—, —NR₁₁₃—, or —O—. R₁₁₁ and R₁₁₂ each independently represent a hydrogen atom or a substituent. R₁₁₃ represents a hydrogen atom, an alkyl group, an aryl group, or a heterocyclic group.

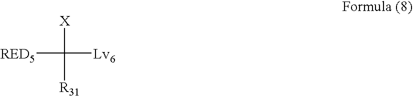

In formula (8), RED₅ is a reducing group and represents an arylamino group or a heterocyclic amino group. R₃₁ represents a hydrogen atom or a substituent. X represents one selected from an alkoxy group, an aryloxy group, a heterocyclic oxy group, an alkylthio group, an arylthio group, a heterocyclic thio group, an alkylamino group, an arylamino group, or a heterocyclic amino group. Lv₆ is a leaving group and represents a carboxy group or a salt thereof, or a hydrogen atom.

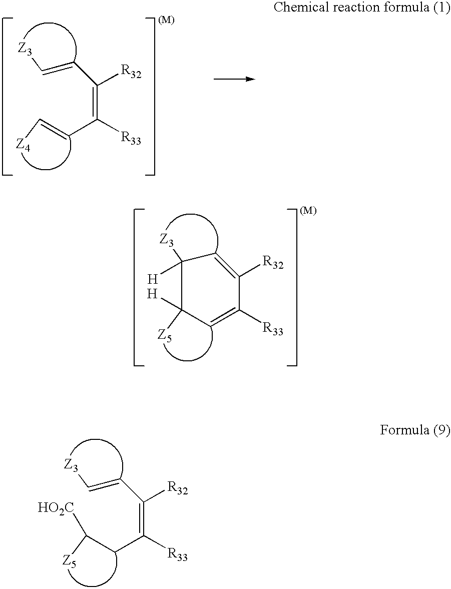

The compound represented by formula (9) is a compound that undergoes a bond formation reaction represented by chemical reaction formula (1) after undergoing two-electrons-oxidation accompanied by decarboxylation and further oxidized. In chemical reaction formula (1), R₃₂ and R₃₃ represent a hydrogen atom or a substituent. Z₃ represents a group which forms a 5- or 6-membered heterocycle with C═C. Z₄ represents a group which forms a 5- or 6-membered aryl group or heterocyclic group with C═C. M represents a radical, a radical cation, or a cation. In formula (9), R₃₂, R₃₃, and Z₃ each have the same meaning as in chemical reaction formula (1). Z₅ represents a group which forms a 5- or 6-membered cyclic aliphatic hydrocarbon group or heterocyclic group with C—C.

Next, the compound of Group 2 is explained.

In the compound of Group 2, as a compound that is one-electron-oxidized to provide a one-electron oxidation product which further releases one or more electrons after being subjected to a subsequent bond formation reaction, specific examples can include the compound represented by formula (10) (same as formula (1) described in JP-A No. 2003-140287), and the compound represented by formula (11) (same as formula (2) described in JP-A No. 2004-245929) which can undergo the reaction represented by chemical reaction formula (1) (same as chemical reaction formula (1) described in JP-A No. 2004-245929). The preferable ranges of these compounds are the same as the preferable ranges described in the quoted specifications.

RED₆-Q-Y Formula (10)

In formula (10), RED₆ represents a reducing group which is to be one-electron-oxidized. Y represents a reactive group containing a carbon-carbon double bond part, a carbon-carbon triple bond part, an aromatic group part, or a benzo-condensed non-aromatic heterocycle part, which reacts with one-electron-oxidized product formed by one-electron-oxidation of RED₆ to form a new bond. Q represents a linking group which links RED₆ and Y.

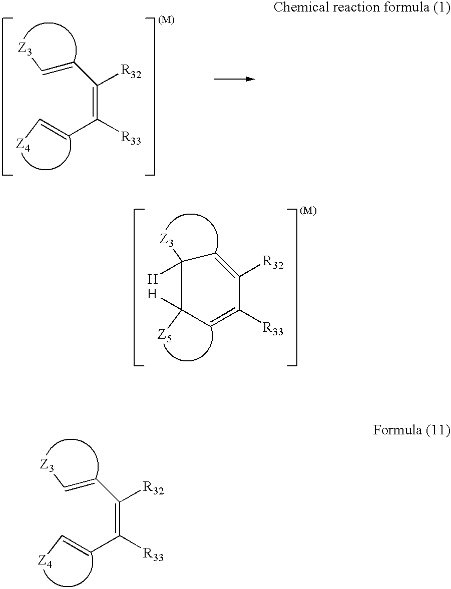

The compound represented by formula (11) is a compound that undergoes a bond formation reaction represented by chemical reaction formula (1) by being oxidized. In chemical reaction formula (1), R₃₂ and R₃₃ each independently represent a hydrogen atom or a substituent. Z₃ represents a group which forms a 5- or 6-membered heterocycle with C═C. Z₄ represents a group which forms a 5- or 6-membered aryl group or heterocyclic group with C═C. Z₅ represents a group which forms a 5- or 6-membered cyclic aliphatic hydrocarbon group or heterocyclic group with C—C. M represents a radical, a radical cation, or a cation. In formula (11), R₃₂, R₃₃, Z₃, and Z₄ each have the same meaning as in chemical reaction formula (1).

The compounds of Groups 1 or 2 are preferably “the compound having an adsorptive group to silver halide in the molecule” or “the compound having a partial structure of a spectral sensitizing dye in the molecule”. The representative adsorptive group to silver halide is the group described in JP-A No. 2003-156823, page 16 right, line 1 to page 17 right, line 12. The partial structure of a spectral sensitizing dye is the structure described in the same specification, page 17 right, line 34 to page 18 right, line 6.

As the compound of Groups 1 or 2, “the compound having at least one adsorptive group to silver halide in the molecule” is more preferred, and “the compound having two or more adsorptive groups to silver halide in the same molecule” is even more preferred. In the case where two or more adsorptive groups exist in a single molecule, those adsorptive groups may be identical or different from one another.

As preferable adsorptive group, a mercapto-substituted nitrogen-containing heterocyclic group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzothiazole group, a 1,5-dimethyl-1,2,4-triazolium-3-thiolate group, or the like) or a nitrogen-containing heterocyclic group having an —NH— group, which forms silver iminate (—N(Ag)—), as a partial structure of the heterocycle (e.g., a benzotriazole group, a benzimidazole group, an indazole group, or the like) are described. A 5-mercaptotetrazole group, a 3-mercapto-1,2,4-triazole group, and a benzotriazole group are particularly preferable, and a 3-mercapto-1,2,4-triazole group and a 5-mercaptotetrazole group are most preferable.

The case where the adsorptive group has two or more mercapto groups as a partial structure in the molecule is also particularly preferable. Herein, the mercapto group (—SH) may become a thione group in the case where it can tautomerize. Preferred examples of the adsorptive group having two or more mercapto groups as a partial structure (dimercapto-substituted nitrogen-containing heterocyclic group and the like) include a 2,4-dimercaptopyrimidine group, a 2,4-dimercaptotriazine group, and a 3,5-dimercapto-1,2,4-triazole group.

Further, a quaternary salt structure of nitrogen or phosphorus is also preferably used as the adsorptive group. Specific examples of the quaternary salt structure of nitrogen include an ammonio group (a trialkylammonio group, a dialkylarylammonio group, a dialkylheteroarylammonio group, an alkyldiarylammonio group, an alkyldiheteroarylammonio group, or the like) and a nitrogen-containing heterocyclic group containing a quaternary nitrogen atom.

Examples of the quaternary salt structure of phosphorus include a phosphonio group (a trialkylphosphonio group, a dialkylarylphosphonio group, a dialkylheteroarylphosphonio group, an alkyldiarylphosphonio group, an alkyldiheteroarylphosphonio group, a triarylphosphonio group, a triheteroarylphosphonio group, or the like). More preferably, a quaternary salt structure of nitrogen is used, and even more preferably, a 5- or 6-membered nitrogen-containing aromatic heterocyclic group containing a quaternary nitrogen atom is used.

Particularly preferably, a pyridinio group, a quinolinio group, or an isoquinolinio group is used. These nitrogen-containing heterocyclic groups containing a quaternary nitrogen atom may have any substituent.

Examples of a counter anion of the quaternary salt include a halogen ion, carboxylate ion, sulfonate ion, sulfate ion, perchlorate ion, carbonate ion, nitrate ion, BF₄⁻, PF₆⁻, Ph₄B⁻, and the like. In the case where the group having negative charge at carboxylate group or the like exists in the molecule, an inner salt may be formed with it. As a counter anion outside of the molecule, a chloro ion, bromo ion, or methanesulfonate ion is particularly preferable.

Preferred structure of the compound represented by Groups 1 or 2 having a quaternary salt structure of nitrogen or phosphorus as the adsorptive group is represented by formula (i).

(P-Q₁-)ᵢ—R(-Q_{2-S})ⱼ Formula (i)

In formula (i), P and R each independently represent a quaternary salt structure of nitrogen or phosphorus, which is not a partial structure of a spectral sensitizing dye. Q₁ and Q₂ each independently represent a linking group and typically represent a single bond, an alkylene group, an arylene group, a heterocyclic group, —O—, —S—, —NR_{N}, —C(═O)—, —SO₂—, —SO—, —P(═O)— or combinations of these groups. Herein, R_{N} represents a hydrogen atom, an alkyl group, an aryl group, or a heterocyclic group. S represents a residue which is obtained by removing one atom from the compound represented by Group 1 or 2. i and j are an integer of one or more and are selected from within a range satisfying i+j=2 to 6. The case where i is 1 to 3 and j is 1 or 2 is preferable, the case where i is 1 or 2 and j is 1 is more preferable, and the case where i is 1 and j is 1 is particularly preferable. The compound represented by formula (i) preferably has 10 to 100 carbon atoms in total, more preferably 10 to 70 carbon atoms, even more preferably 11 to 60 carbon atoms, and particularly preferably 12 to 50 carbon atoms in total.

The compounds of Groups 1 or 2 may be used at any time during preparation of the photosensitive silver halide emulsion and production of the photothermographic material. For example, the compound may be used in a photosensitive silver halide grain formation step, in a desalting step, in a chemical sensitization step, before coating, or the like. The compound may be added several times during these steps. The compound is preferably added after completion of the photosensitive silver halide grain formation step and before the desalting step; in the chemical sensitization step (just before initiation of the chemical sensitization to immediately after completion of the chemical sensitization); or before coating. The compound is more preferably added at the time from the chemical sensitization step to before being mixed with the non-photosensitive organic silver salt.

It is preferred that the compound of Groups 1 or 2 according to the invention is added by being dissolved in water, a water-soluble solvent such as methanol or ethanol, or a mixed solvent thereof. In the case where the compound is dissolved in water and solubility of the compound is increased by increasing or decreasing a pH value of the solvent, the pH value may be increased or decreased to dissolve and add the compound.

The compound of Groups 1 or 2 according to the invention is preferably used in the image forming layer which contains the photosensitive silver halide and the non-photosensitive organic silver salt. The compound may be added to a protective layer or intermediate layer, as well as the image forming layer containing the photosensitive silver halide and the non-photosensitive organic silver salt, to be diffused in the coating step.

The compound may be added before or after addition of a sensitizing dye. The compound is contained in the silver halide emulsion layer (image forming layer) preferably in an amount of from 1×10⁻⁹ mol to 5×10⁻¹ mol, more preferably from 1×10⁻⁸ mol to 5×10⁻² mol, per 1 mol of silver halide.

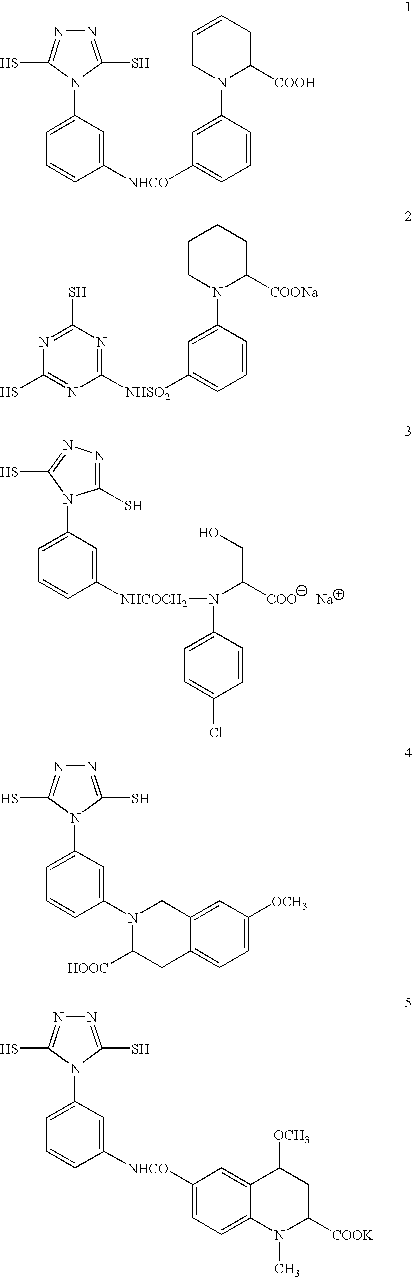

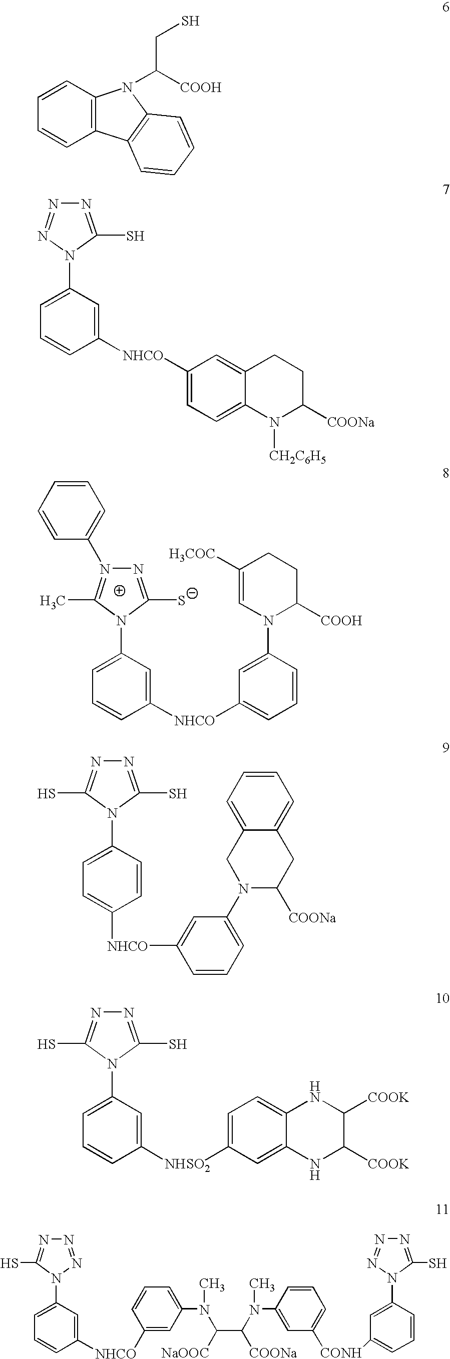

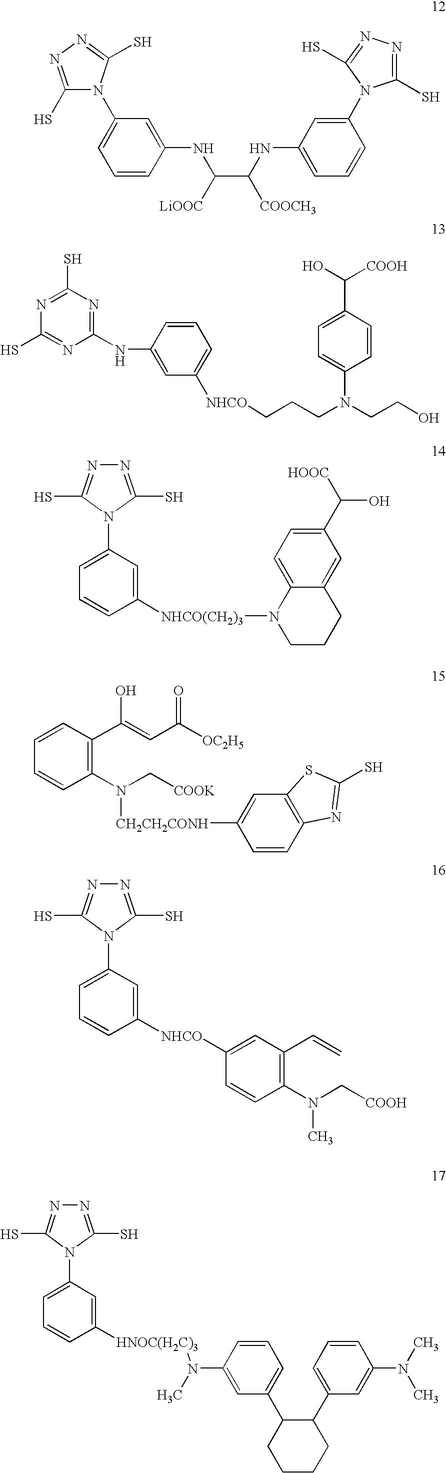

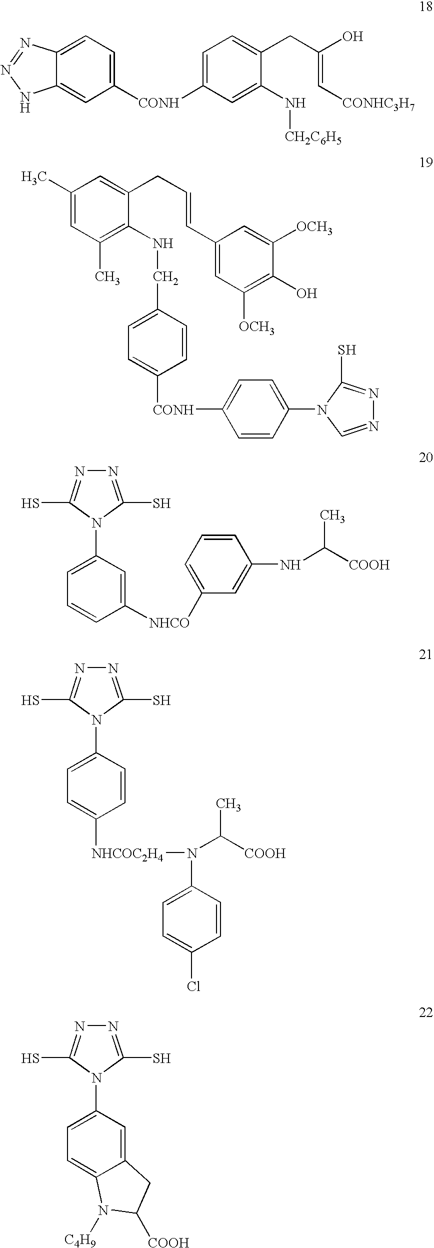

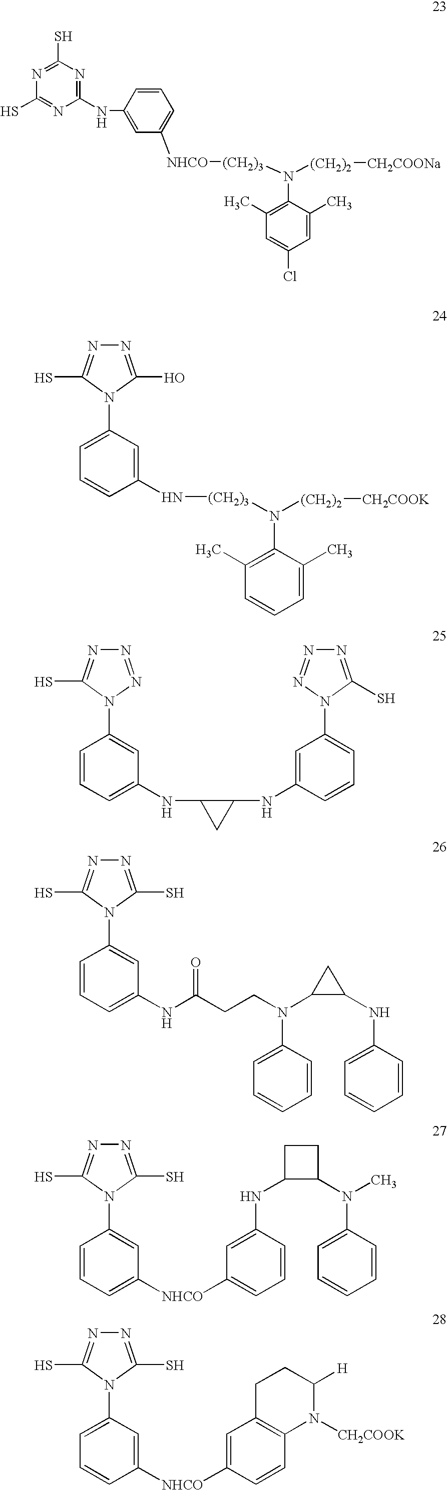

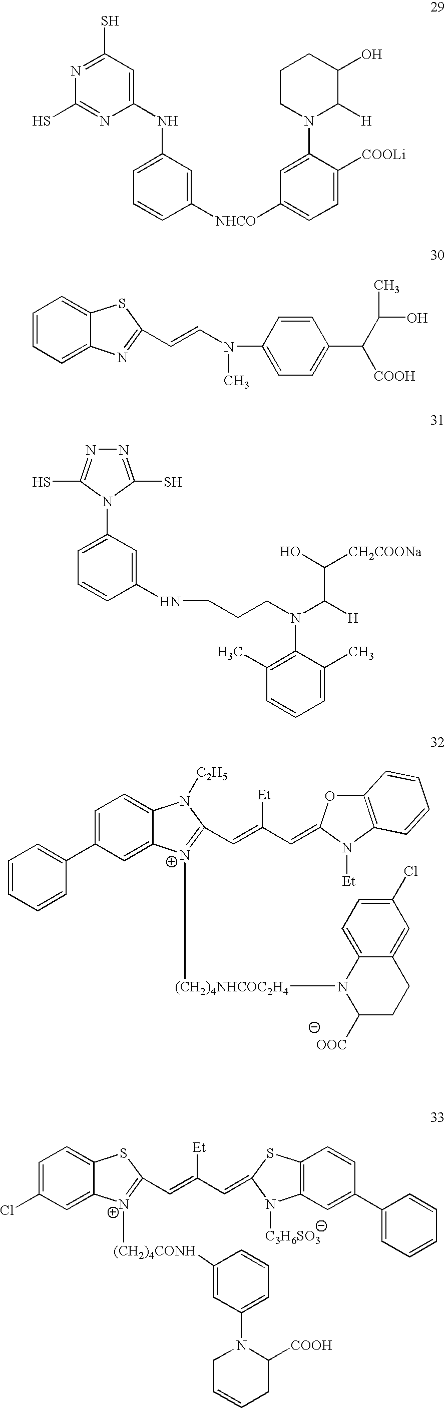

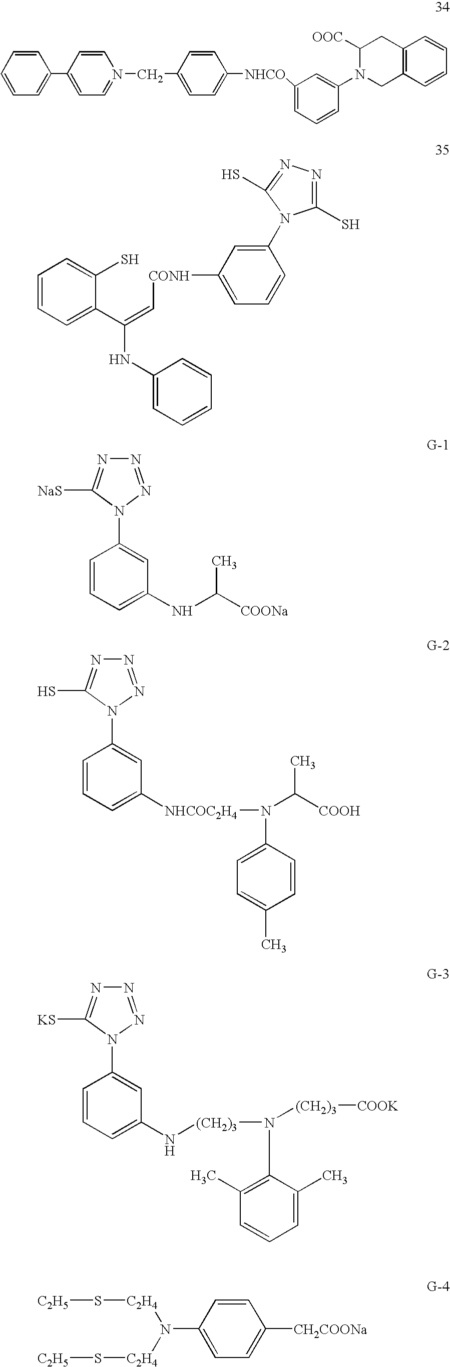

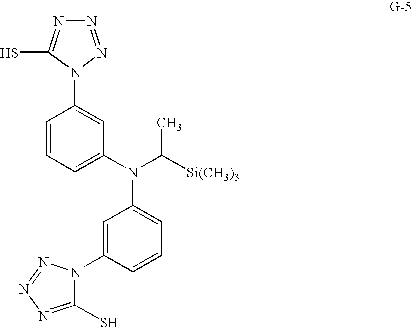

11) Compound Having Adsorptive Group and Reducing Group

The photothermographic material of the present invention preferably contains a compound having an adsorptive group to silver halide and a reducing group in the molecule. It is preferred that the compound is represented by the following formula (I).

A-(W)n-B Formula (I)

In formula (I), A represents a group which adsorbs to a silver halide (hereafter, it is called an adsorptive group.); W represents a divalent linking group; n represents 0 or 1; and B represents a reducing group.

In formula (I), the adsorptive group represented by A is a group to adsorb directly to a silver halide or a group to promote adsorption to a silver halide. As typical examples, a mercapto group (or a salt thereof), a thione group (—C(═S)—), a heterocyclic group comprising at least one atom selected from among nitrogen, sulfur, selenium, and tellurium, a sulfide group, a disulfide group, a cationic group, an ethynyl group, and the like are described.

The mercapto group (or the salt thereof) as the adsorptive group means a mercapto group (or a salt thereof) itself and simultaneously more preferably represents a heterocyclic group, aryl group, or alkyl group substituted by at least one mercapto group (or a salt thereof). Herein, the heterocyclic group is at least a 5- to 7-membered, monocyclic or condensed, aromatic or non-aromatic heterocyclic group; and examples thereof include an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, and the like. Further, a heterocyclic group having a quaternary nitrogen atom may also be adopted, wherein the mercapto group as a substituent may dissociate to form a mesoion. When the mercapto group forms a salt, a counter ion of the salt may be a cation of an alkaline metal, alkaline earth metal, heavy metal, or the like, such as L⁺, Na⁺, K⁺, Mg²⁺, Ag⁺, or Zn²⁺; an ammonium ion; a heterocyclic group containing a quaternary nitrogen atom; a phosphonium ion, or the like.

Furthermore, the mercapto group as the adsorptive group may become a thione group by tautomerization.

The thione group used as the adsorptive group also includes a chain or cyclic thioamido group, thioureido group, thiourethane group, and dithiocarbamic acid ester group.

The heterocyclic group, as the adsorptive group, which comprises at least one atom selected from among nitrogen, sulfur, selenium, and tellurium, represents a nitrogen-containing heterocyclic group having an —NH— group, which forms silver iminate (—N(Ag)—), as a partial structure of the heterocycle, or a heterocyclic group having an —S— group, a —Se— group, a —Te— group, or an ═N— group, each of which coordinates to a silver ion by a coordination bond, as a partial structure of a heterocycle. As the former examples, a benzotriazole group, a triazole group, an indazole group, a pyrazole group, a tetrazole group, a benzimidazole group, an imidazole group, a purine group, and the like are described. As the latter examples, a thiophene group, a thiazole group, an oxazole group, a benzothiophene group, a benzothiazole group, a benzoxazole group, a thiadiazole group, an oxadiazole group, a triazine group, a selenoazole group, a benzoselenoazole group, a tellurazole group, a benzotellurazole group, and the like are described.

The sulfide group or disulfide group as the adsorptive group contains all groups having “—S-” or “—S—S-” as a partial structure.

The cationic group as the adsorptive group means a group containing a quaternary nitrogen atom, such as an ammonio group or a nitrogen-containing heterocyclic group containing a quaternary nitrogen atom. As examples of the nitrogen-containing heterocyclic group containing a quaternary nitrogen atom, a pyridinio group, a quinolinio group, an isoquinolinio group, an imidazolio group, and the like are described.

The ethynyl group as the adsorptive group means —C≡CH group and the said hydrogen atom may be substituted.

The adsorptive group described above may have any substituent.

Further, as typical examples of the adsorptive group, the groups described in pages 4 to 7 in the specification of JP-A No. 11-95355 are described.

As the adsorptive group represented by A in formula (I), a mercapto-substituted heterocyclic group (for example, a 2-mercaptothiadiazole group, a 2-mercapto-5-aminothiadiazole group, a 3-mercapto-1,2,4-triazole group, a 5-mercaptotetrazole group, a 2-mercapto-1,3,4-oxadiazole group, a 2-mercaptobenzimidazole group, a 1,5-dimethyl-1,2,4-triazolium-3-thiolate group, a 2,4-dimercaptopyrimidine group, a 2,4-dimercaptotriazine group, a 3,5-dimercapto-1,2,4-triazole group, a 2,5-dimercapto-1,3-thiazole group, or the like) and a nitrogen-containing heterocyclic group having an —NH— group, which forms silver iminate (—N(Ag)—), as a partial structure of the heterocycle (for example, a benzotriazole group, a benzimidazole group, an indazole group, or the like) are preferable, and more preferable as the adsorptive group are a 2-mercaptobenzimidazole group and a 3,5-dimercapto-1,2,4-triazole group.

In formula (I), W represents a divalent linking group. The said linking group may be any divalent linking group as long as it does not exert adverse influences on photographic performance. For example, a divalent linking group which is formed from carbon, hydrogen, oxygen, nitrogen, or sulfur can be used. As typical examples, an alkylene group having 1 to 20 carbon atoms (for example, a methylene group, an ethylene group, a trimethylene group, a tetramethylene group, a hexamethylene group, or the like), an alkenylene group having 2 to 20 carbon atoms, an alkynylene group having 2 to 20 carbon atoms, an arylene group having 6 to 20 carbon atoms (for example, a phenylene group, a naphthylene group, or the like), —CO—, —SO₂—, —O—, —S—, —NR₁—, and the combinations of these linking groups are described. Herein, R₁ represents a hydrogen atom, an alkyl group, a heterocyclic group, or an aryl group.

The linking group represented by W may have any substituent.

In formula (I), the reducing group represented by B represents a group which reduces a silver ion. Examples thereof include a formyl group; an amino group; a triple bond group such as an acetylene group, a propargyl group, or the like; a mercapto group; and residues which are obtained by removing one hydrogen atom from hydroxyamines, hydroxamic acids, hydroxyureas, hydroxyurethanes, hydroxysemicarbazides, reductones (reductone derivatives are contained.), anilines, phenols (chroman-6-ols, 2,3-dihydrobenzofuran-5-ols, aminophenols, sulfonamidophenols, and polyphenols such as hydroquinones, catechols, resorcinols, benzenetriols, bisphenols are included.), acylhydrazines, carbamoylhydrazines, 3-pyrazolidones, or the like. They may have any substituent.

The oxidation potential of the reducing group represented by B in formula (I) can be measured by using the measuring method described in Akira Fujishima, “DENKIKAGAKU SOKUTEIHO”, pages 150 to 208, GIHODO SHUPPAN and The Chemical Society of Japan, “JIKKEN KAGAKU KOZA”, 4th ed., vol. 9, pages 282 to 344, MARUZEN. For example, the method of rotating disc voltammetry can be used; namely the sample is dissolved in the solution (methanol:pH 6.5 Britton-Robinson buffer=10%:90% (% by volume)) and after bubbling with nitrogen gas for 10 minutes, the voltamograph can be measured under conditions of 1000 rotations/minute, sweep rate of 20 mV/second, at 25° C. by using a rotating disc electrode (RDE) made by glassy carbon as a working electrode, a platinum electrode as a counter electrode, and a saturated calomel electrode as a reference electrode. The half wave potential (E1/2) can be calculated by that obtained voltamograph.

When the reducing group represented by B in the present invention is measured by the method described above, the oxidation potential is preferably in a range of from about −0.3 V to about 1.0 V, more preferably from about −0.1 V to about 0.8 V, and particularly preferably from about 0 V to about 0.7 V.

In formula (I), the reducing group represented by B is preferably a residue which is obtained by removing one hydrogen atom from hydroxyamines, hydroxamic acids, hydroxyureas, hydroxysemicarbazides, reductones, phenols, acylhydrazines, carbamoylhydrazines, or 3-pyrazolidones.

The compound of formula (I) according to the present invention may have a ballast group or polymer chain, which are generally used in the non-moving photographic additives such as a coupler or the like, in it. And as the polymer, for example, the polymer described in JP-A No. 1-100530 is described.

The compound of formula (I) according to the present invention may be bis or tris type of compound. The molecular weight of the compound represented by formula (I) according to the present invention is preferably within a range of from 100 to 10000, more preferably from 120 to 1000, and particularly preferably from 150 to 500.

Specific examples of the compound represented by formula (I) according to the present invention are shown below, but the present invention is not limited to these examples.

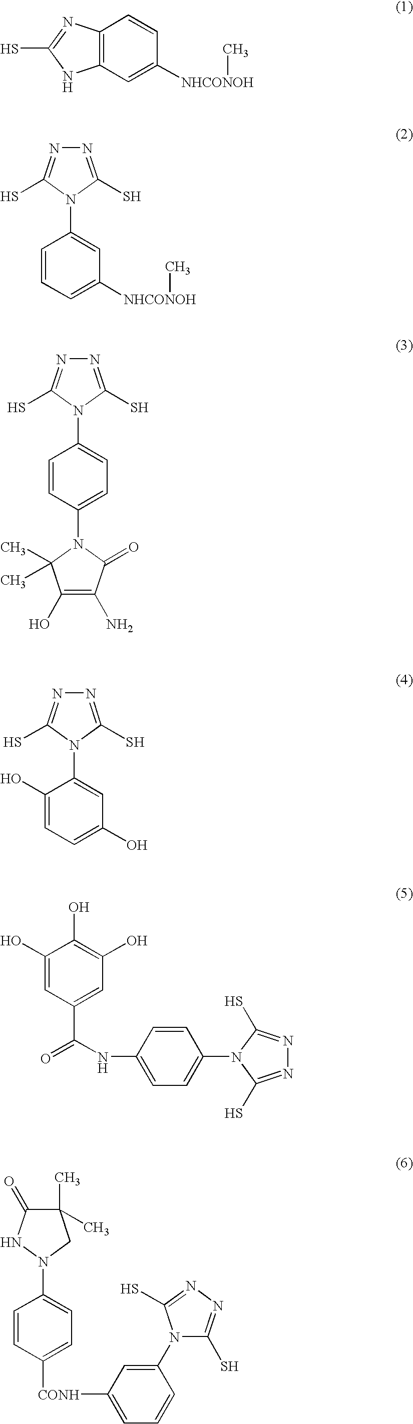

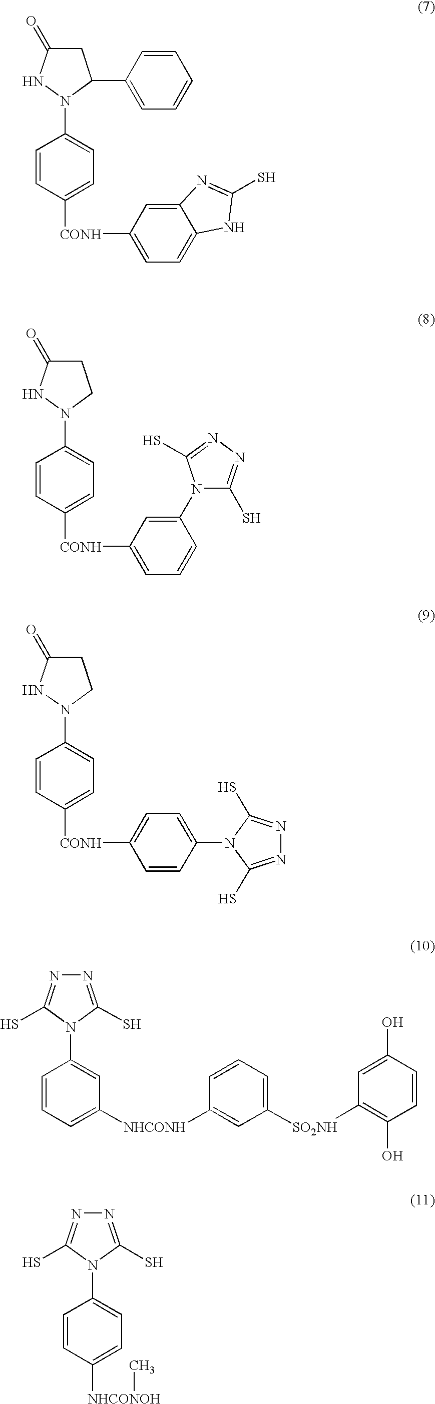

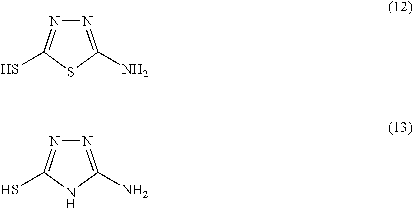

Further, specific compounds 1 to 30 and 1″-1 to 1″-77 shown in EP No. 1,308,776A2, pages 73 to 87 are also described as preferable examples of the compound having an adsorptive group and a reducing group according to the invention.

These compounds can be easily synthesized by a known method in the technical field. The compound of formula (I) according to the present invention may be used alone, but it is preferred to use two or more of the compounds simultaneously. When two or more of the compounds are used, those compounds may be added to the same layer or different layers, whereby addition methods may be different from each other.

The compound represented by formula (I) according to the present invention is preferably added to the silver halide emulsion layer (image forming layer) and more preferably, the compound represented by formula (I) is added in an emulsion preparation process. In the case where the compound is added in an emulsion preparation process, the compound can be added at any stage in the process. For example, the compound can be added during the silver halide grain formation step; before starting of desalting step; during the desalting step; before starting of chemical ripening; during the chemical ripening step; in the step before preparing a final emulsion, or the like. The compound can be added several times during these steps. It is preferred to use the compound in the image forming layer. But the compound may be added to a protective layer or intermediate layer adjacent to the image forming layer, in combination with its addition to the image forming layer, to be diffused in the coating step.

The preferred addition amount is largely dependent on the addition method described above or the type of the compound, but is generally from 1×10⁻⁶ mol to 1 mol, preferably from 1×10⁻⁵ mol to 5×10⁻¹ mol, and more preferably from 1×10⁻⁴ mol to 1×10⁻¹ mol, per 1 mol of photosensitive silver halide in each case.

The compound represented by formula (I) according to the present invention can be added by being dissolved in water, a water-soluble solvent such as methanol, ethanol and the like, or a mixed solution thereof. At this stage, the pH may be arranged suitably by an acid or a base, and a surfactant may coexist. Further, these compounds can be added as an emulsified dispersion by dissolving them in an organic solvent having a high boiling point, and also can be added as a solid dispersion.

12) Combined Use of Silver Halides

The photosensitive silver halide emulsion in the photothermographic material of the invention may be used alone, or two or more of them (for example, those having different mean grain sizes, different halogen compositions, different crystal habits, or different conditions for chemical sensitization) may be used together. Gradation can be controlled by using plural photosensitive silver halides each having different sensitivity. The relevant techniques include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

13) Mixing Photosensitive Silver Halide and Organic Silver Salt

The mixing method and mixing conditions of the separately prepared photosensitive silver halide and organic silver salt include a method of mixing respectively prepared photosensitive silver halide grains and organic silver salt by a high speed stirrer, ball mill, sand mill, colloid mill, vibration mill, homogenizer, or the like, a method of mixing a photosensitive silver halide completed for preparation at any timing during the preparation of the organic silver salt and preparing the organic silver salt, and the like. However, so long as the effects of the invention are sufficiently realized, there is no particular restriction on the method. Further, a method of mixing two or more aqueous dispersions of organic silver salts and two or more aqueous dispersions of photosensitive silver salts upon mixing is used preferably for controlling photographic properties.

14) Mixing Silver Halide into Coating Solution

In the invention, the time of adding silver halide to the coating solution for the image forming layer is preferably in a range of from 180 minutes before coating to just prior to coating, and more preferably 60 minutes before coating to 10 seconds before coating. However, as long as the effects of the invention are sufficiently realized, there is no particular restriction concerning the mixing method and the conditions of mixing. As a specific mixing method, there is a method of mixing in a tank and controlling an average residence time. The average residence time herein is calculated from addition flux and the amount of solution transferred to the coater. And another mixing method is a method using a static mixer, which is described in 8th chapter or the like of “Ekitai Kongo Gijutu” by N. Harnby, M. F. Edwards, and A. W. Nienow, translated by Koji Takahashi (Nikkan Kogyo Shinbunsha, 1989).

(Fluorocarbon Compound)

The fluorocarbon compound represented by formula (FC-1), (FC-2), or (FC-3), which is included in the photothermographic material of the present invention is to be explained. The fluorocarbon compound is characterized in that it has one or more of a fluoroalkyl group or fluoroalkenyl group having 3 to 17 fluorine atoms. The fluorocarbon compound may be any of anionic, cationic, betaine, or nonionic, but among these, an anionic or nonionic compound is preferable, and an anionic compound is most preferable. Furthermore, the fluorocarbon compound may be a low-molecular compound or macromolecular compound, but it is preferably a low-molecular compound.

(Rf)ₚ—Y-(L-Z)_{q} Formula (FC-1):

Rf-L-Z′-L-Rf Formula (FC-2):

Z-L-Rf′-L-Z Formula (FC-3):

In the formulae, Rf represents a fluoroalkyl group or fluoroalkenyl group having 3 to 17 fluorine atoms; Rf′ represents a fluoroalkylene group or fluoroalkenylene group having 3 to 17 fluorine atoms; L represents a bond or a divalent linking group; Y represents a bond or a saturated linking group having a valency of (p+q); Z represents an anionic group, a cationic group, a betaine group, or a nonionic polar group; Z′ represents a divalent nonionic polar group; p and q each independently represent an integer of from 1 to 3; and when (p+q) is 2, both of L and Y are not simultaneously a bond. Plural Rf groups of the number p and plural -(L-Z) groups of the number q may each be the same as or different from each other.

The fluoroalkyl group or fluoroalkenyl group represented by Rf and the fluoroalkylene group or fluoroalkenylene group represented by Rf′ respectively have 3 to 17 fluorine atoms, and preferably 6 to 17 fluorine atoms. Further, they preferably have 1 to 16 carbon atoms, more preferably 2 to 12 carbon atoms, and most preferably 3 to 9 carbon atoms, respectively. The fluoroalkyl group, fluoroalkenyl group, fluoroalkylene group, or fluoroalkenylene group may be a straight chain or branched chain, or may have a cyclic structure, but is preferably a straight chain or branched chain, and more preferably a straight chain.

The fluoroalkyl group is preferably a group represented by the following formula (FC-1-C).

-Rc-Re—W Formula (FC-1-C):

In formula (FC-1-C), Rc represents a bond or a straight-chain alkylene group having 4 or fewer carbon atoms; Re represents a perfluoroalkylene group having 2 to 6 carbon atoms; and W represents a hydrogen atom or a fluorine atom.

The fluoroalkenyl group is particularly preferably a group represented by the following formula (Rf-1).

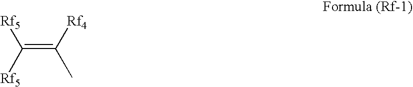

In formula (Rf-1), Rf₄ and Rf₅ each independently represent a fluorine atom or a perfluoroalkyl group having 1 to 3 carbon atoms, and preferably a perfluoroalkyl group. The sum of the numbers of carbon atoms of Rf₄ and Rf₅ is preferably 3 or 4.

Specific examples of the fluoroalkyl group or fluoroalkenyl group include the following groups.

—CF₃

—CF₂CF₃

—(CF₂)₂CF₃

—(CF₂)₃CF₃

—(CF₂)₄H

—(CF₂)₄CF₃

—(CF₂)₅H

—(CF₂)₅CF₃

—C(C₂F₅)C(CF₃)₂

—(CF₂)₆H

—C₉F₁₇

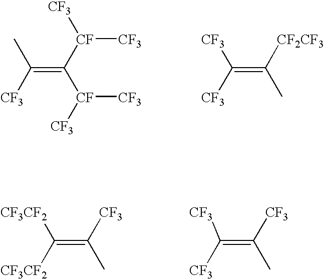

Specific examples of the fluoroalkylene group or fluoroalkenylene group include groups obtained by removing one hydrogen atom from these fluoroalkyl groups or fluoroalkenyl groups.

L described above represents a simple bond or a divalent linking group. Examples of the divalent linking group include an alkyleneoxy group, an oxyalkyleneoxy group, a perfluorooxyalkylene group, a perfluorooxyalkyleneoxy group, a thioalkylene group, a phenyleneoxy group, an oxyphenyleneoxy group, a carbonyl group, —SO₂NR⁵—, —CONR⁶—, —OCO—, —COO—, a heteroatom such as oxygen, sulfur, or the like, combinations of these groups, and the like. L is preferably a bond. R⁵ and R⁶ each independently represent a hydrogen atom or an alkyl group.

Z described above represents an anionic group, a cationic group, a betaine group, or a nonionic polar group. Z is preferably an anionic group or a nonionic polar group.

The anionic group means an acidic group having pKa of 7 or less, or an alkaline metal salt or ammonium salt thereof. Specifically, examples of the anionic group include a sulfo group, a carboxy group, a phosphonic acid group, and salts of these. Among these, a sulfo group and a salt thereof are preferable. Examples of the cation species which form salts include lithium, sodium, potassium, cesium, ammonium, tetramethylammonium, tetrabutylammonium, methylpyridinium, and the like. Preferred are an alkaline metal ion such as lithium, sodium, potassium, or the like and ammonium, and more preferred is lithium.

The cationic group is preferably an organic cationic substituent, and more preferably a cationic group of nitrogen or phosphorus. It is even more preferably a pyridinium cation or an ammonium cation, and further preferably a trialkylammonium cation. As the counter anion of the cationic group, a halide ion, a p-toluenesulfonate ion, or the like is preferable.

Examples of the nonionic polar group include a hydroxy group and a polyoxyalkylene group. The nonionic polar group is preferably a polyoxyalkylene group, and among them, a polyoxyethylene group is preferred. There is no particular restriction on the length of the polyoxyalkylene group, but the number of repetition is preferably from 5 to 50, and more preferably from 10 to 30.

Y described above represents a bond or a saturated linking group having a valency of (p+q). Examples of the linking group include an alkylene group, an oxyalkyleneoxy group, an arylene group, a heteroatom, combinations of these groups, and the like. p and q each independently represent an integer of from 1 to 3. It is most preferable that (p+q) is 3.

Specific examples of the fluorocarbon compound used in the present invention are shown below, but the compounds which can be used in the present invention are not limited to these specific examples.

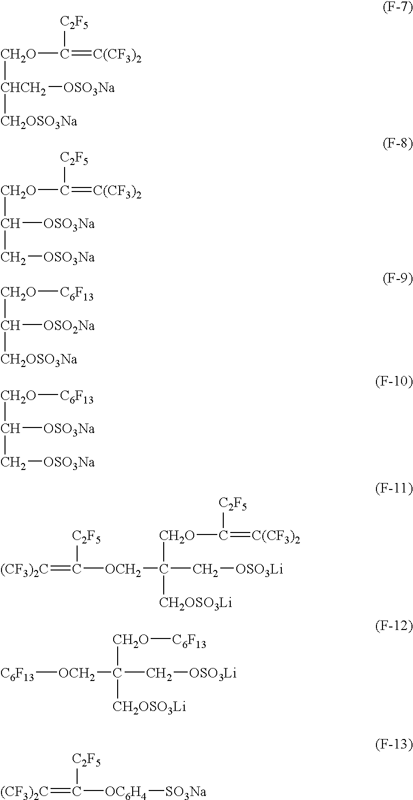

C₆F₁₃—OC₆H₄—SO₃Na (F-14)

C₆F₁₃—CH₂CH₂C₆H₄—SO₃Na (F-17)

C₄F₉—CH₂CH₂OCH₂CH₂—CO₂Na (F-18)

(HC₆F₁₂CH₂CH₂O)₂—PO—OH (F-19)

(C₄F₉CH₂CH₂O)₂—PO—OH (F-20)

(HC₄F₈CH₂CH₂O)₂—PO—OH (F-21)

C₃F₇—OCF₂CF₂OCF₂—CH₂—OPO(ONa)₂ (F-26)

C₄F₉—OCF₂CF₂—OPO(ONa)₂ (F-27)

C₆F₁₃—(OCF₂CF₂)₃OCF₂—CH₂—OPO(ONa)₂ (F-28)

C₃F₇—O(CF₂)₃—CO₂Na (F-29)

C₅F₁₁—O(CF₂)₃—CO₂Na (F-30)

C₅F₁₁—O(CF₂)₅—CO₂Na (F-31)

C₃F₇—(OCF₂CF₂)₅OCF₂—CO₂Na (F-32)

HC₆F₁₂—OCF₂O(CF₂)₅—CO₂K (F-33)

(CF₃)₂—C—(OH)₂ (F-42)

C₃F₆—(OC₃H₆—S₃Na)₂ (F-43)

C₃F₆—(OC₃H₆—SO₃Li)₂ (F-44)

C₃F₆—(OPO(ONa)₂)₂ (F-45)

C₃F₆—(OSO₃Na)₂ (F-46)

C₃F₆—(OSO₃Li)₂ (F-47)

C₃F₆—(SO₃Li)₂ (F-48)

C₃F₆—(CO₂Na)₂ (F-49)

C₃F₆—(CO₂K)₂ (F-50)

C₄F₉—(OCH₂CH₂)₁₂O—C₄F₉ (F-51)

C₆F₁₃—(OCH₂CH₂)₂₂O—C₆F₁₃ (F-52)

C₆F₁₃—COO—(CH₂CH₂O)₂₂—CO—C₆F₁₃ (F-53)

C₈F₁₇—CH₂CH₂SCH₂CHMe-COOLi (F-35)

C₉F₁₇—O—(CH₂CH₂O)₁₈H (F-36)

C₉F₁₇—O—(CH₂CH₂O)₂₂Me (F-37)

C₆F₁₁—O—(CH₂CH₂O)₂₂—C₆F₁₁ (F-38)

C₉F₁₇—O—(CH₂CH₂O)₃₃—C₉F₁₇ (F-39)

C₉F₁₇—O—(CH₂CHMeO)₁₅—C₉F₁₇ (F-40)

C₉F₁₇—O—(CH₂CH₂O)₂₂—C₆F₁₁ (F-41)

### *C₆F₁₁ represents the following partial structure 1, and C₉F₁₇ represents the following partial structure 2.

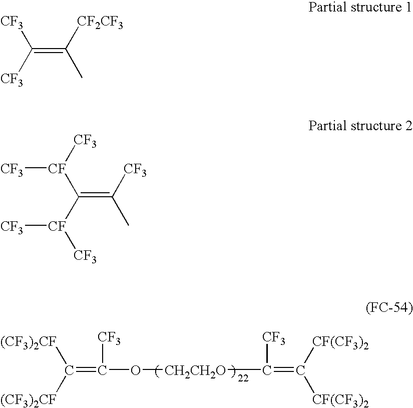

With regard to the synthesis methods of the above fluorocarbon compounds, reference can be made to JP-W Nos. 10-500950, 10-158218, 11-504360, and 2000-505803.

While the fluorocarbon compound according to the invention can be used in a desired amount necessary for improving the coated surface state, the coating amount is preferably in a range of from about 0.5 mg/m² to 90 mg/m², more preferably from 15 mg/m² to 85 mg/m², and even more preferably from 25 mg/m² to 80 mg/m². When the coating amount is less than the lower limit of this range, sufficient improvement effect with respect to coating ability cannot be obtained. When the coating amount exceeds the upper limit of this range, it is not preferred because development unevenness occurs.

(Compound Represented by Formula (1))

In the present invention, it is preferable to add a compound represented by formula (1) at the side having the image forming layer. It was found that coating ability, which is the task of the invention, is further improved by the addition of the compound represented by the following formula (1).

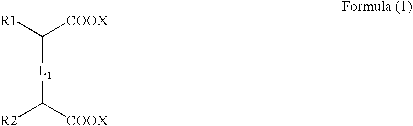

In formula (1), L₁ represents a bond or a divalent linking group; R¹ and R² each independently represent a hydrogen atom, or a hydrocarbon group which may bond to each other to form a ring; X represents a hydrogen atom or a cation; and when X is a cation having a valency of 2 or more, the two carboxy groups may chelate with a single X.

The linking group of L₁ is not particularly restricted, but L₁ is preferably a bond or a substituted or unsubstituted imino group, and more preferably a bond. Further, when L₁ is a linking group, L₁ may have a substituent. In this case, the substituent is not particularly restricted, but the substituent is preferably a substituent having a polar group such as a carboxyalkylene group or a hydroxyalkylene group.

R1 and R2 each independently represent a hydrogen atom, or a hydrocarbon group which may bond to each other to form a ring. Preferably, at least one of R1 and R2 is a hydrocarbon group. The hydrocarbon group has preferably 4 to 18 carbon atoms, and more preferably 4 to 12 carbon atoms. Further, it is preferred that R1 and R2 bond to each other to form a ring. These hydrocarbon groups may be saturated or unsaturated, and they may have a substituent. In this case, examples of the substituent include an alkyl group, a hydroxy group, a carbonyl group, an alkyloxyalkyl group, an amino group, and a halogen atom. The substituent is preferably an alkyl group or a halogen atom.

X represents a hydrogen atom or a cation. Examples of the cation include an alkaline metal ion, an alkaline earth metal ion, and an ammonium ion. X is preferably a hydrogen atom or an alkaline metal ion, and more preferably a hydrogen atom.

Further, a compound represented by the following formula (2) is also preferable.

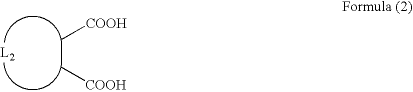

In formula (2), L₂ represents a 6- to 8-membered, substituted or unsubstituted, saturated or unsaturated hydrocarbon ring, and is preferably a 6-membered ring. Further, the ring is preferably an unsaturated hydrocarbon ring, and more preferably an aromatic ring. L₂ may be substituted or unsubstituted, but is preferably unsubstituted or substituted by a hydrophilic group such as a carboxy group or the like, and is more preferably unsubstituted.

Specific examples of the compound represented by formula (1) are shown below, but the invention is not limited to these examples.

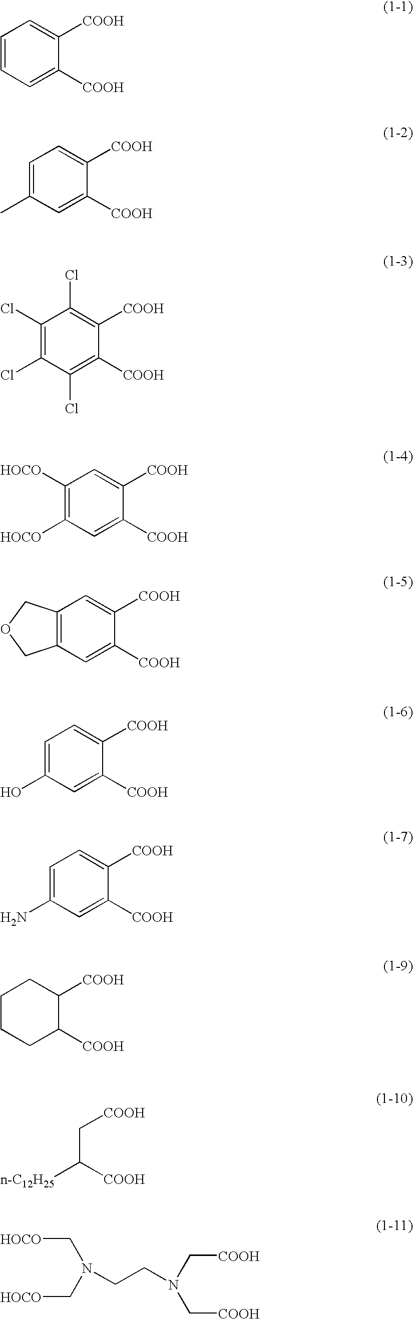

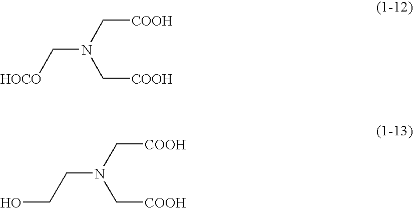

The compound represented by formula (1) may be used alone, or two or more of them may be used in combination. It is preferable to use two or more of them in combination. There is no particular restriction concerning the addition method, and the compound may be added by a known method such as in the form of a solid dispersion or a solution.

Further, there is no particular restriction on the layer in which the compound represented by formula (1) is to be added, but the compound is preferable added in the image forming layer.

While there is no particular restriction on the addition amount of the compound represented by formula (1), the addition amount is preferably in a range of from 200 mg/m² to 1000 mg/m², and more preferably from 200 mg/m² to 400 mg/m². The compound represented by formula (1) is preferably added in an amount of from 10 mol % to 30 mol % with respect to 1 mol of coated silver.

(Organic Silver Salt)

1) Composition

The organic silver salt which can be used in the present invention is relatively stable to light but serves to supply silver ions and forms silver images when heated to 80° C. or higher in the presence of an exposed photosensitive silver halide and a reducing agent. The organic silver salt may be any organic substance which supplies silver ions that are reducible by a reducing agent. Such a non-photosensitive organic silver salt is described, for example, in JP-A No. 10-62899 (paragraph Nos. 0048 and 0049), European Patent (EP) No. 0803764A1 (page 18, line 24 to page 19, line 37), EP No. 0962812A1, JP-A Nos. 11-349591, 2000-7683, and 2000-72711, and the like. A silver salt of an organic acid, particularly, a silver salt of a long-chained aliphatic carboxylic acid (having 10 to 30 carbon atoms, and preferably having 15 to 28 carbon atoms) is preferable. Preferred examples of the silver salt of a fatty acid include silver lignocerate, silver behenate, silver arachidinate, silver stearate, silver oleate, silver laurate, silver capronate, silver myristate, silver palmitate, silver erucate, and mixtures thereof. In the invention, among these silver salts of a fatty acid, it is preferred to use a silver salt of a fatty acid with a silver behenate content of 50 mol % or higher, more preferably 85 mol % or higher, and even more preferably 95 mol % or higher. Further, it is preferred to use a silver salt of a fatty acid with a silver erucate content of 2 mol % or lower, more preferably 1 mol % or lower, and even more preferably 0.1 mol % or lower.

It is preferred that the content of silver stearate is 1 mol % or lower. When the content of silver stearate is 1 mol % or lower, a silver salt of an organic acid having low fog, high sensitivity, and excellent image storability can be obtained. The above-mentioned content of silver stearate is preferably 0.5 mol % or lower, and particularly preferably, silver stearate is not substantially contained.

Further, in the case where silver arachidinate is included as a silver salt of an organic acid, it is preferred that the content of silver arachidinate is 6 mol % or lower from the viewpoint of obtaining a silver salt of an organic acid having low fog and excellent image storability. The content of silver arachidinate is more preferably 3 mol % or lower.

2) Particle Size

The non-photosensitive organic silver salt according to the present invention is fine particles having a mean particle size of 0.4 μm or less.

Preferably, the mean particle size is from 0.01 μm to 0.4 μm, and more preferably, the mean particle size is from 0.02 μm to 0.35 μm.

Another preferable type of the particle size is a type of nanoparticle.

In the present invention, particle size is an equivalent spherical diameter, which is expressed as a diameter of a sphere having a volume equal to the volume of a particle. The equivalent spherical diameter can be measured by a method of photographing a sample directly by using an electron microscope and then image processing the negative images.

As the particle size distribution of the organic silver salt, monodispersion is preferred. The particle size of the organic silver salt can be measured by analyzing a dispersion of an organic silver salt as transmission type electron microscopic images. Another method of measuring the monodispersion is a method of determining the standard deviation of the volume-weighted mean diameter of the organic silver salt particles, in which the percentage for the value defined by the volume-weighted mean diameter (variation coefficient) is preferably 100% or less, more preferably 80% or less, and even more preferably 50% or less. For determination of such a value, a commercially available laser beam scattering particle size analyzer can be used.

Concerning the shape of the organic silver salt according to the present invention, a flake shaped particle with a length-width ratio being from 1 to 9 is preferred. When the length-width ratio is within a range of from 1 to 9, it is preferred since particles do not cause crushing during preparation of dispersion thereof so that image storability is improved.

In the present specification, a flake shaped organic silver salt and the length-width ratio are defined as described below. When an organic silver salt is observed under an electron microscope, calculation is made while approximating the shape of a particle of the organic silver salt to a rectangular body, designating respective sides of the rectangular body as a, b, c from the shortest side (c may be identical with b.), and determining x and y based on the numerical values a, b, and c as follows.

x=b/a, y=c/b

In this manner, x and y are determined for about 200 particles, and those satisfying the relationship of x (average)≧1.5 based on an average value x (average) are defined as flake shaped. The relationship is preferably 30≧x (average)≧1.5, and more preferably, 20≧x (average)≧2.0. Incidentally, needle-like is expressed as 1≦x (average)<1.5. Further, the average value y (average) is defined as the length-width ratio. Concerning the organic silver salt particles according to the present invention, the length-width ratio is preferably from 1 to 9, more preferably from 1 to 6, and particularly preferably from 1 to 3.

In the flake shaped particle, a can be regarded as a thickness of a tabular particle having a major plane with b and c being as the sides. a in average is preferably from 0.01 μm to 0.23 μm and, more preferably from 0.1 μm to 0.20 μm.

In the flake shaped particle, the equivalent spherical diameter of the particle/a is defined as an aspect ratio. The aspect ratio of the flake shaped particle according to the present invention is preferably from 1.1 to 30. When the aspect ratio is within this range, particles cause less agglomeration in the photothermographic material, and image storability is improved. The aspect ratio is more preferably from 1.1 to 15.

3) Preparing Method

The method for producing fine particles of the non-photosensitive organic silver salt used in the invention and the dispersing method thereof are described below.

<<Method for Preparing Organic Silver Salt Fine Particles>>

The organic silver salt particle for use in the present invention is preferably prepared at a reaction temperature of 60° C. or lower from the viewpoint of preparing particles having low minimum density. The temperature of chemicals to be added such as an aqueous solution of an organic acid alkaline metal salt may be higher than 60° C., but the temperature of the reaction bath to which the reaction solution is added is preferably 60° C. or lower, more preferably 50° C. or lower, and particularly preferably 40° C. or lower.

The pH of the silver ion-containing solution (for example, an aqueous solution of silver nitrate) for use in the present invention is preferably from 1 to 6, and more preferably from 1.5 to 4. For adjusting the pH, an acid or alkali may be added to the silver ion-containing solution itself. The types of acid and alkali are not particularly limited.

After completion of addition of a silver ion-containing solution (for example, an aqueous solution of silver nitrate) and/or a solution or suspension of an organic acid alkaline metal salt, the organic silver salt according to the present invention may be ripened by elevating the reaction temperature. In the present invention, the ripening temperature is different from the above-described reaction temperature. During the ripening, a silver ion-containing solution and a solution or suspension of an organic acid alkaline metal salt are not added at all. The ripening is preferably performed at a temperature of 1° C. to 20° C. higher than the reaction temperature, and more preferably 1° C. to 10° C. higher than the reaction temperature. The time period for ripening is preferably determined by trial and error.

In the preparation of the organic silver salt according to the present invention, 0.5 mol % to 30 mol % of the total added molar number of the solution or suspension of the organic acid alkaline metal salt may be added singly after completion of addition of the silver ion-containing solution. Preferably, it may be added singly in an amount of from 3 mol % to 20 mol %. The above addition is preferably carried out as one turn of the divided addition. In the case where a sealed mixing means is utilized, the solution or suspension may be added to either the sealed mixing means or the reaction vessel, but is preferably added to the reaction vessel. By carrying out this addition, hydrophilic property of the surface of the organic silver salt particles can be improved so that the obtained photothermographic material provides improved film-forming property and improved peeling resistance.

The silver ion concentration of the silver ion-containing solution (for example, an aqueous solution of silver nitrate) for use in the present invention may be arbitrary determined. The silver ion concentration is preferably in a range of from 0.03 mol/L to 6.5 mol/L, and more preferably from 0.1 mol/L to 5 mol/L, on the basis of the molar concentration.

In the practice of the present invention, in order to form organic silver salt particles, it is preferred that at least one of the silver ion-containing solution, the solution or suspension of an organic acid alkaline metal salt, or a solution prepared in advance in the reaction site contains an organic solvent in an amount that is sufficient to form a substantially transparent solution without making the organic acid alkaline metal salt into string-like aggregates or micelles.

As the solution, water, an organic solvent, or a mixture of water and an organic solvent is preferably employed, but more preferred is a mixed solution of water and an organic solvent.

The organic solvent for use in the present invention is not particularly limited concerning the type thereof as long as it is water soluble and has the above-described performance, but those which exert adverse influences on photographic performance are not favored. Alcohol or acetone that is miscible with water is preferably employed for the organic solvent.

Specifically, the alkaline metal of the alkaline metal salt of an organic acid used in the invention is preferably potassium. The alkaline metal salt of an organic acid is prepared by adding potassium hydroxide to an organic acid. In this process, it is preferred to allow unreacted organic acid to remain by setting the amount of alkali equivalent to or less than the amount of organic acid. The amount of residual organic acid is preferably from 3 mol % to 50 mol %, and more preferably from 3 mol % to 30 mol %, with respect to the total amount of organic acids. The amount of residual organic acid may also be adjusted by adding an alkali in excess of the desired amount and thereafter adding an acid such as nitric acid or sulfuric acid to neutralize the excess alkali content. Furthermore, in the practice of the present invention, the liquid in the sealed mixing means where the silver ion-containing solution and at least one of the solution or suspension of an organic acid alkaline metal salt are added can contain, for example, a compound such as expressed by formula (1) of JP-A No. 62-65035, a nitrogen-containing heterocyclic compound having a water-soluble group such as described in JP-A No. 62-150240, an inorganic peroxide such as described in JP-A No. 50-101019, a sulfur compound such as described in JP-A No. 51-78319, a disulfide compound and hydrogen peroxide such as described in JP-A No. 57-643, and the like.

In the solution or suspension of the organic acid alkaline metal salt used in the present invention, the amount of organic solvent is preferably, in terms of the organic solvent volume, from 3% to 70%, and more preferably from 5% to 50%, with respect to the volume of water content. Here, the optimum solvent volume varies depending on the reaction temperature, and therefore, the optimum amount can be determined by trial and error. The concentration of the alkaline metal salt of an organic acid for use in the present invention is from 5% by weight to 50% by weight, preferably from 7% by weight to 45% by weight, and more preferably from 10% by weight to 40% by weight, on the basis of the weight ratio.

The temperature of the solution or suspension of the organic acid alkaline metal salt supplied to the reaction vessel is preferably from 50° C. to 90° C., more preferably from 60° C. to 85° C., and most preferably from 65° C. to 85° C., for the purpose of maintaining the temperature necessary for preventing crystallization or solidification of the organic acid alkaline metal salt. Also, for performing the reaction at a constant temperature, the solution or suspension of the organic acid alkaline metal salt is preferably controlled to a constant temperature selected from the above-described range. By this control, the speed at which the solution or suspension of the organic acid alkaline metal salt at a high temperature is rapidly cooled and precipitated in the form of fine crystal in the sealed mixing means and the speed at which an organic silver salt is formed by the reaction with the silver ion-containing solution are preferably controlled, so that crystal form, crystal size, and crystal size distribution of the organic silver salt can be preferably controlled, and at the same time, the performance as thermal developing image recording material can be further improved.

A solvent can be added in advance in the reaction vessel. As the solvent added in advance, water is preferably used, but a mixed solvent with a solution or suspension of organic acid alkaline metal salt is also preferably used.

The solution or suspension of organic acid alkaline metal salt, the ion-containing solution, or the reaction solution may contain a dispersing agent which is soluble in an aqueous medium. Any dispersing agent may be used as long as it can disperse the formed organic silver salt. Specific examples are the same as those described below for the dispersing agent of the organic silver salt.

In the method for preparing the organic silver salt, it is preferred to perform a desalting/dehydration step after the formation of the silver salt. The method thereof is not particularly limited and a known and commonly employed means can be used. For example, a known filtration method such as centrifugal filtration, suction filtration, ultra filtration, or flocculation/water washing by coagulation, or a method of removing the supernatant after centrifugal separation and precipitation is preferably used. Among these, the centrifuge method is more preferred. The desalting/dehydration may be performed once or may be repeated several times. Addition and removal of water may be performed continuously or individually. The desalting/dehydration is performed to such an extent that the final dehydrated water preferably has a conductivity of 300 μS/cm or less, more preferably 100 μS/cm or less, and most preferably 60 μS/cm or less. The lower limit of the conductivity is not particularly limited, but is usually about 5 μS/cm.

In the desalting by ultra filtration according to the present invention, prior to the treatment, the liquid is preferably dispersed beforehand to make the particle size about two times the final particle size based on the volume-weighted mean thereof. The dispersion may be performed using any means such as high-pressure homogenizer, micro-fluidizer, or the like described below.

During the time period from the particle formation until the desalting operation starts, the temperature of the liquid is preferably maintained low. This is because, in the state where the organic solvent used for dissolving the alkaline metal salt of an organic acid is penetrated into the inside of the formed organic silver salt particles, silver nuclei are readily produced due to the liquid feeding operation or desalting operation. Accordingly, in the practice of the present invention, the desalting operation is preferably performed while keeping the organic silver salt particle dispersion at a temperature of from 1° C. to 30° C., and preferably from 5° C. to 25° C.

<<Method for Preparing Organic Silver Salt Nanoparticles>>

Furthermore, as the non-photosensitive organic silver salt fine particles, nanoparticles of the organic silver salt are preferably employed in the present invention. In the practice of the present invention, nanoparticles of the organic silver salt can be prepared in the presence of at least one dispersing agent comprising polyacrylamide or a derivative thereof.

The dispersing agent may be added during the preparation process of the organic silver salt, or during the dispersion process. After preparation of the organic silver salt, salts formed as by-products are preferably desalted in the presence of washing water containing at least one dispersing agent comprising polyacrylamide or a derivative thereof.

A weight ratio of the organic silver salt relative to the dispersing agent is preferably in a range of from 15 to 100, and more preferably from 20 to 70.

As the dispersing agent, a compound represented by any one of the following formulae is preferably employed. Desalting using a water-washing liquid containing the dispersing agent can impart an excellent coated surface state to the organic silver salt.

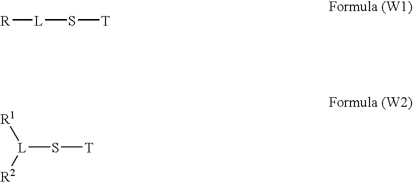

R represents a hydrophobic group. At least one of R¹ or R² is a hydrophobic group. L represents a divalent linking group. T represents an oligomer part.

The number of the hydrophobic group is determined by the linking group L. Examples of the hydrophobic group include a saturated or unsaturated alkyl group, a saturated or unsaturated arylalkyl group, and a saturated or unsaturated alkylaryl group, in which each alkyl part may be straight chain or branched. Preferably, the hydrophobic groups R, R¹, and R² each have 8 to 21 carbon atoms. The linking group L is linked to the hydrophobic group by a simple chemical bond and to the oligomer part T by a thio bond (—S—). Typical examples of the linking group for a substance including one hydrophobic group are indicated in italic type in the following formulae.

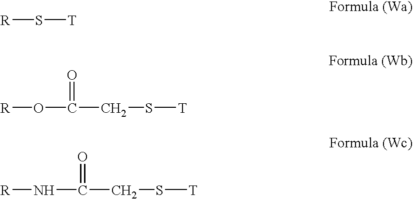

Typical examples of the linking group for a substance including two hydrophobic groups are indicated in italic type in the following formulae.

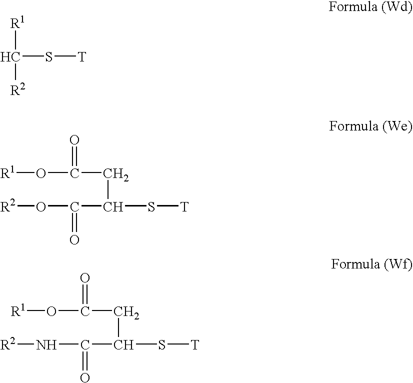

The oligomer part T is based on oligomerization of a vinyl monomer having an amido functional group, wherein the vinyl part provides a route to the oligomerization and the amido part provides a nonionic polar group comprising a hydrophilic functional group after oligomerization. The oligomer part T can be formed from a monomer source or a mixture of monomers if the obtained oligomer chain has sufficient hydrophilic property for dissolving or dispersing the obtained surface active substance in water. A typical monomer used for forming the oligomer part T is based on acrylamide, methacrylamide, an acrylamide derivative, a methacrylamide derivative, or 2-vinylpyrrolidone, but the last of these is not preferable because of a harmful effect on photographic properties that is sometimes observed when using polyvinylpyrrolidone (PVP).

These monomers can be expressed by the following two formulae.

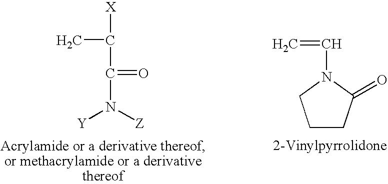

In the formulae, X is typically H or CH₃, and these bring about an acrylamido monomer or a methacrylamido monomer, respectively. Y and Z are typically H, CH₃, C₂H₅, or C(CH₂OH)₃. Here, X and Y can be the same or different.

The above-described oligomer surfactant, which has a vinyl polymer including an amido functional group as a main component, can be produced by a method that is well known in the technical field or by simply modifying a well-known method. One example of the preparing method is described hereinafter. An aqueous nanoparticle dispersion of silver carboxylate can be prepared by a media grinding method comprising the following steps:

(A) preparing a silver carboxylate dispersion containing silver carboxylate, water as a carrier for the carboxylate, and the above-described surface modifying agent,

(B) mixing the obtained silver carboxylate dispersion and hard media for grinding having a mean particle diameter of less than 500 μm,

(C) adding the mixture of step (B) into a high speed mill,

(D) grinding the mixture of step (C) until a particle size distribution of silver carboxylate in which 90% by weight of the silver carboxylate particles has a particle diameter of less than 1 μm is obtained, and

(E) separating the media for grinding from the mixture obtained by the grinding in step (D).

The weight ratio of the non-photosensitive organic silver salt relative to the dispersing agent comprising polyacrylamide or a derivative thereof is preferably from 15 to 100.

4) Addition Amount

While the non-photosensitive organic silver salt according to the invention can be used in a desired amount, a total amount of coated silver including also the silver halide is preferably in a range of from 2.4 g/m² to 5.0 g/m², more preferably from 2.6 g/m² to 4.0 g/m², and even more preferably from 2.7 g/m² to 3.2 g/m².

Concerning the method for producing the non-photosensitive organic silver salt used in the invention and to the dispersing method thereof, in addition to the above, reference can be made to JP-A No. 10-62899, EP Nos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868, and the like.

When a photosensitive silver salt is present together during dispersion of the organic silver salt, fog increases and sensitivity becomes remarkably lower, so that it is more preferred that the photosensitive silver salt is not substantially contained during dispersion. In the invention, the amount of the photosensitive silver salt to be dispersed in the aqueous dispersion is preferably 1 mol % or less, more preferably 0.1 mol % or less, with respect to 1 mol of the organic silver salt in the solution, and even more preferably, positive addition of the photosensitive silver salt is not conducted.

(Compound Represented by Formula (R1))

The reducing agent for silver ions according to the present invention is a compound which reduces silver ions into developed silver at the time of thermal development.

In the photothermographic material of the present invention, a compound represented by formula (R1) is preferably used as a reducing agent for silver ions.

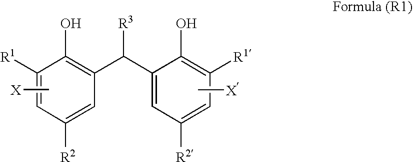

In formula (R1), R¹ and R^{1′} each independently represent an alkyl group having 1 to 20 carbon atoms. R² and R^{2′} each independently represent a hydrogen atom or a substituent which substitutes for a hydrogen atom on a benzene ring. R³ represents a substituent which forms a 3- to 7-membered ring formed from atoms selected from among carbon, oxygen, nitrogen, sulfur, and phosphorus. X and X′ each independently represent a hydrogen atom or a group substituting for a hydrogen atom on a benzene ring.

Formula (R1) is described in detail.

1) R¹ and R^{1′}

R¹ and R^{1′} each independently represent a substituted or unsubstituted alkyl group having 1 to 20 carbon atoms. The substituent of the alkyl group is not particularly restricted and include, preferably, an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group, a ureido group, a urethane group, a halogen atom, and the like.

R¹ and R^{1′} are preferably a secondary, or tertiary alkyl group having 3 to 15 carbon atoms; and examples thereof include, specifically, an isopropyl group, an isobutyl group, a t-butyl group, a t-amyl group, a t-octyl group, a cyclohexyl group, a cyclopentyl group, a 1-methylcyclohexyl group, a 1-methylcyclopropyl group, and the like. R¹ and R^{1′} each represent, more preferably, a tertiary alkyl group having 4 to 12 carbon atoms and, among them, a t-butyl group, a t-amyl group, and a 1-methylcyclohexyl group are even more preferred, a t-butyl group being most preferred.

2) R² and R^{2′}, X and X′

R² and R^{2′} each independently represent a hydrogen atom or a substituent which substitutes for a hydrogen atom on a benzene ring. X and X′ each independently represent a hydrogen atom or a group substituting for a hydrogen atom on a benzene ring.

As each of the groups substituting for a hydrogen atom on the benzene ring, an alkyl group, an aryl group, a halogen atom, an alkoxy group, and an acylamino group are described preferably.

R² and R^{2′} are preferably an alkyl group having 1 to 20 carbon atoms; and examples thereof include, specifically, a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group, and the like. More preferred are a methyl group, an ethyl group, a propyl group, an isopropyl group, and a t-butyl group.

X¹ and X^{1′} are preferably a hydrogen atom, a halogen atom, or an alkyl group, and more preferably a hydrogen atom.

3) R³

R³ represents a substituent which forms a 3- to 10-membered ring formed from atoms selected from among carbon, oxygen, nitrogen, sulfur, and phosphorus. The ring may be composed of carbon atoms only, or the ring may be a heterocycle which comprises carbon and the heteroatom described above.

R³ is preferably a group which has 3 to 20 carbon atoms and forms a 5- or 6-membered carbon ring or heterocycle, and more preferably a group which forms a ring formed from atoms selected from carbon and oxygen.

These rings may include an unsaturated linkage.

These rings may have a substituent. It is preferred that the ring including the substituent has 2 to 30 carbon atoms.

Examples of the substituent of the group represented by R³ include a halogen atom, an alkyl group, an alkenyl group, an alkynyl group, a cycloalkyl group, an aryl group, an alkoxy group, an alkylthio group, an aryloxy group, an arylthio group, an allyloxy group, an allylthio group, an acylamino group, a sulfonamido group, a sulfonyl group, a phosphoryl group, a carbonyl group, an oxycarbonyl group, a carbamoyl group, a sulfamoyl group, a heterocyclic group, an amino group, a hydroxy group, and the like.

Specific examples of the ring group represented by R³ include a cyclopropyl group, a cyclobutyl group, a cyclopentyl group, a cyclohexyl group, a cycloheptyl group, a 2-norbornyl group, a 2-[2,2,2]-bicyclooctyl group, a 2-adamantyl group, a 2-cyclopentenyl group, a 2-cyclohexenyl group, a 3-cyclohexenyl group, a 2-tetrahydrofuranyl group, a 2-dihydrofuranyl group, a 2-tetrahydropyranyl group, a 3-dihydropyranyl group, a 2-pyrollidine group, a 2-piperidine group, a 3-tetrahydrothiopyranyl group, a 3-tetrahydrophosphorane group, and the like.

More preferable specific examples of the ring group represented by R³ include a cycloalkyl group, a cycloalkenyl group, and a heterocyclic group, each of which has 1 to 15 carbon atoms. As the cycloalkyl group, preferred are a cyclohexyl group and a cyclopentyl group; as the cycloalkenyl group, preferred are a 2-cyclohexenyl group, a 3-cyclohexenyl group, and a 3-cyclopentenyl group; and as the heterocyclic group, preferred are a 2-tetrahydrofuranyl group, a 2-tetrahydropyranyl group, and a 3-tetrahydropyranyl group. R³ is particularly preferably a cyclohexyl group, a 3-cyclohexenyl group, and a 3-cyclopentenyl group.

The reducing agent described above can be used alone, but it is preferred to use two or more reducing agents in combination for the purpose of adjusting developing performance or color tone. Further, the reducing agent described above can be used in combination with a reducing agent other than the reducing agent according to the present invention. The reducing agent which can be used in combination with the reducing agent according to the present invention is preferably a reducing agent represented by formula (R) described below.

Specific examples of the compound represented by formula (R1) according to the invention are shown below, but the invention is not restricted to these examples.

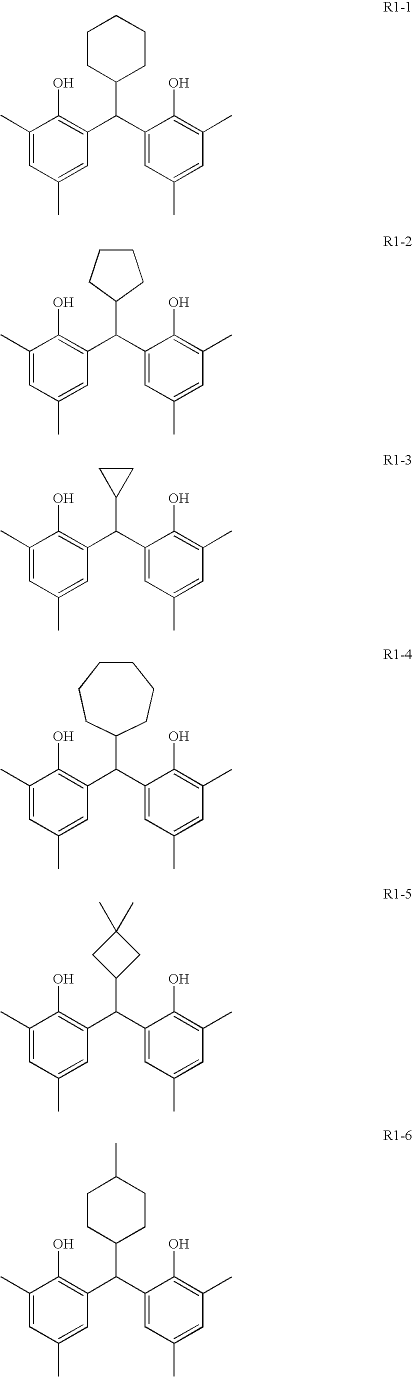

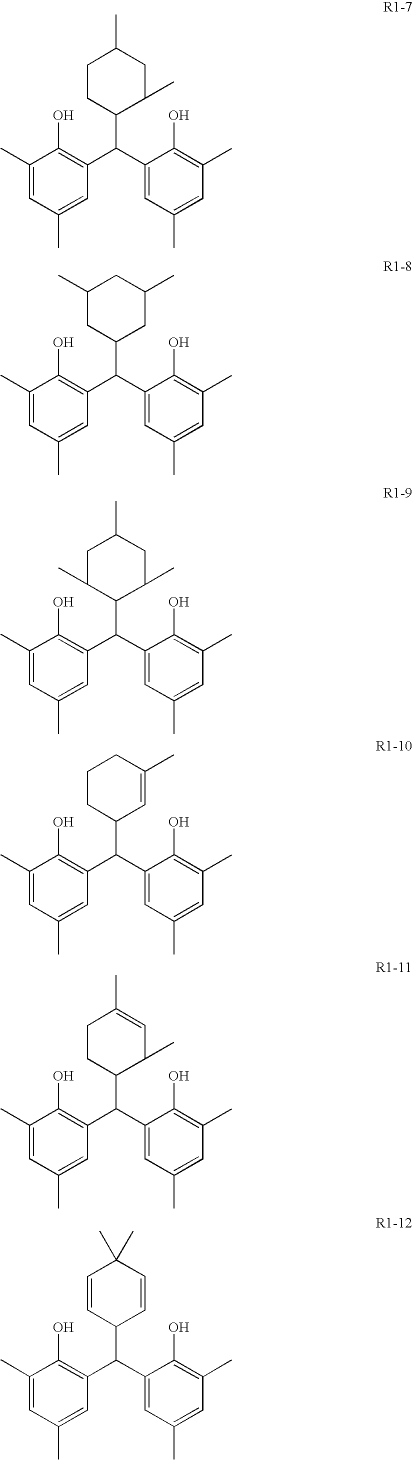

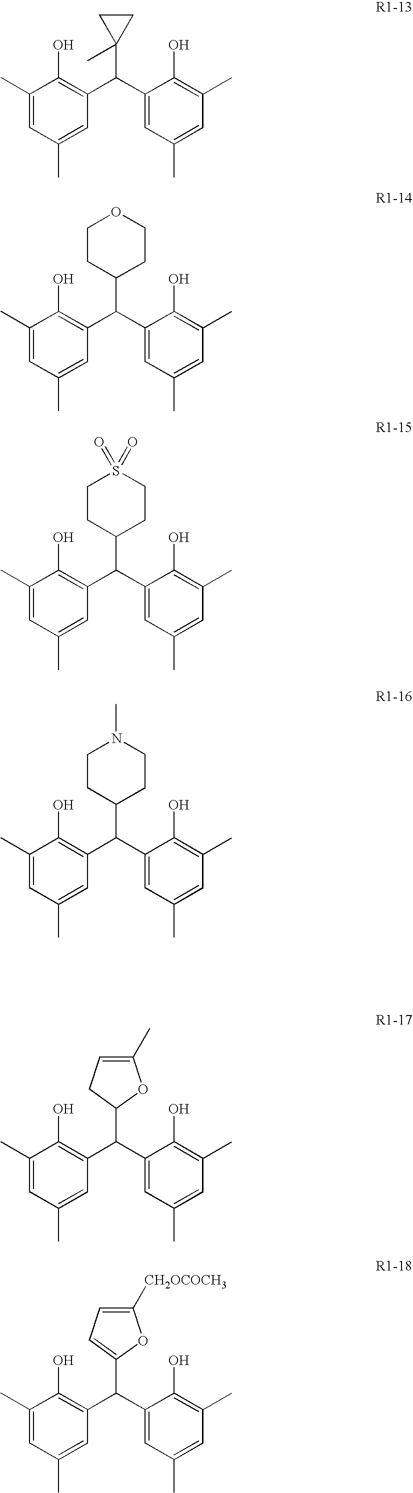

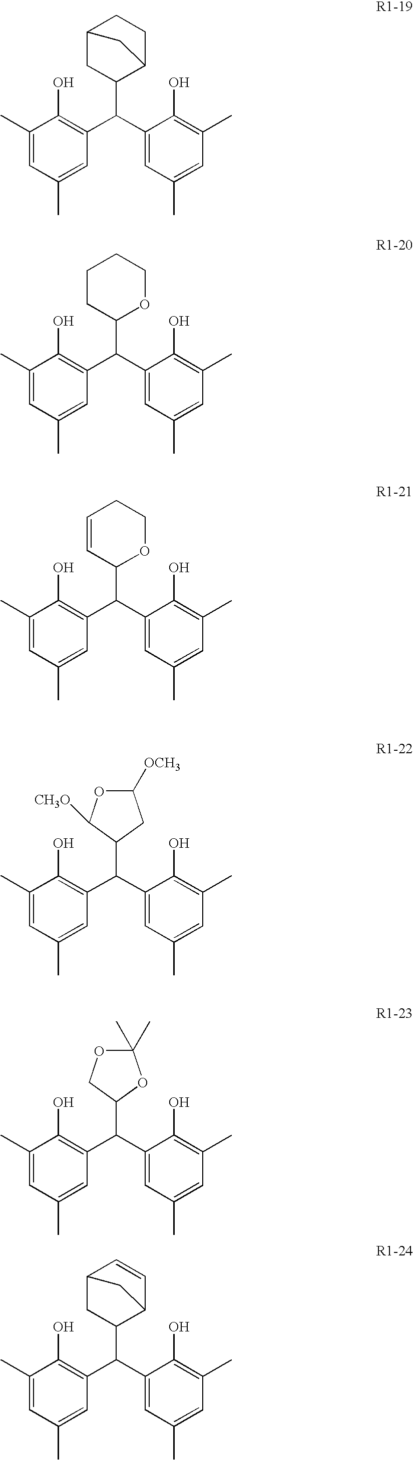

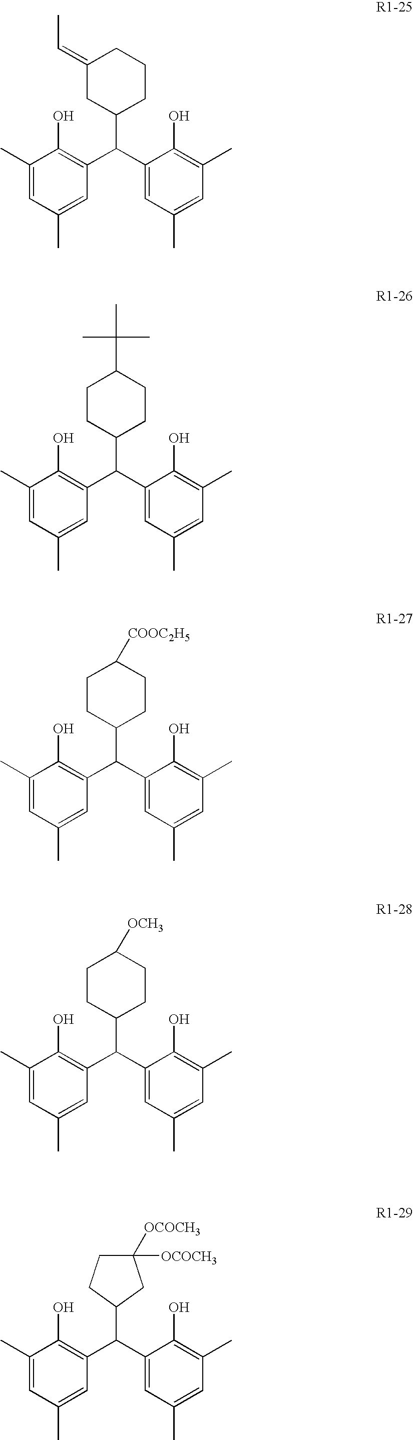

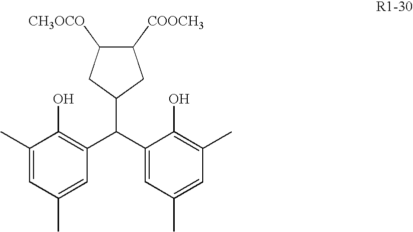

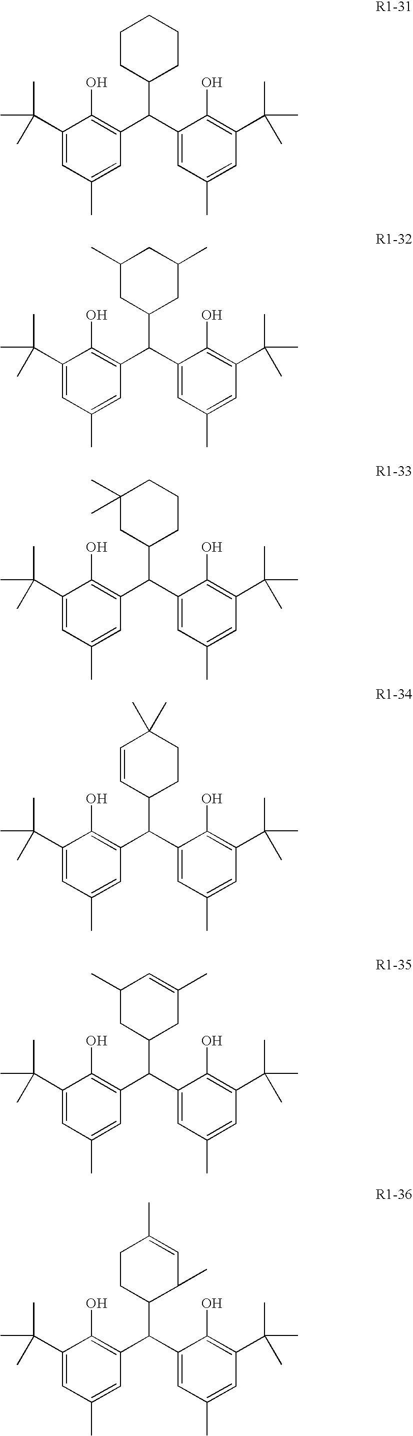

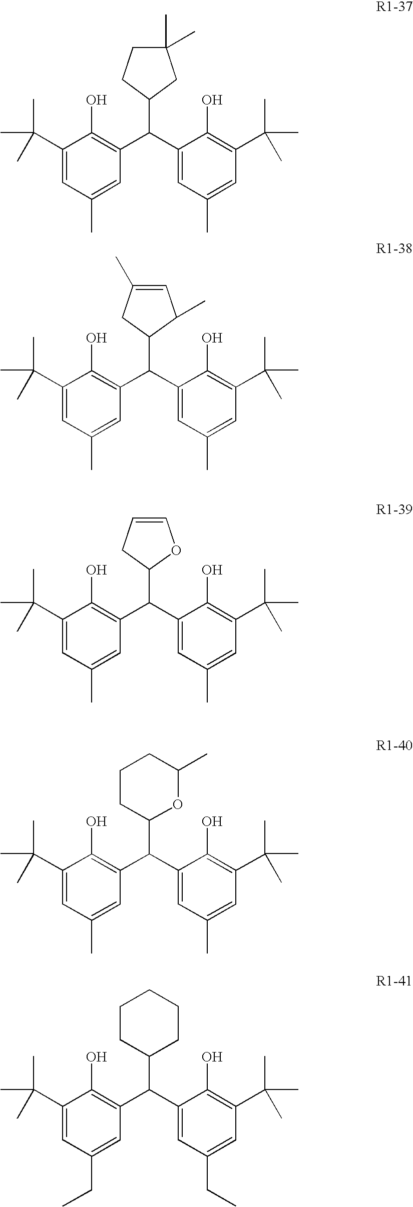

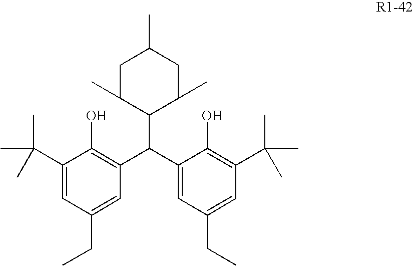

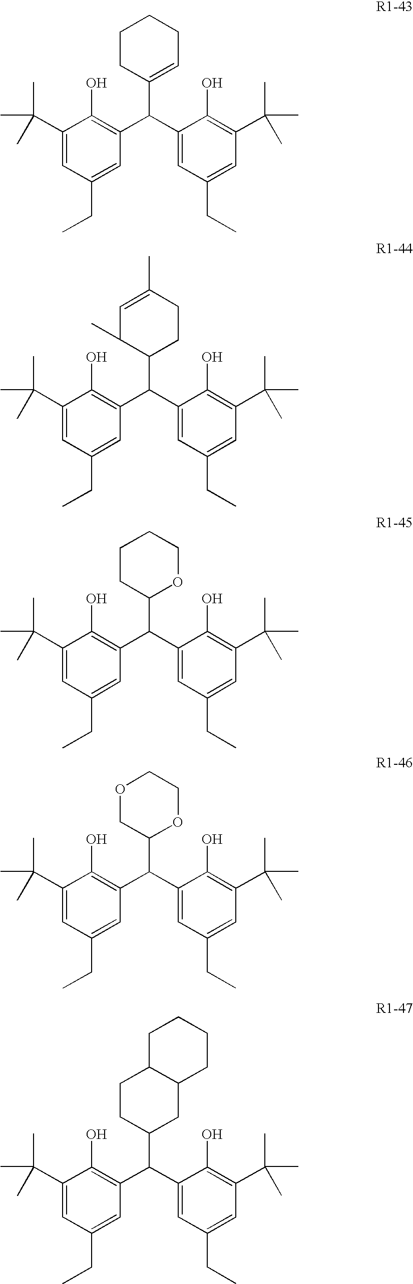

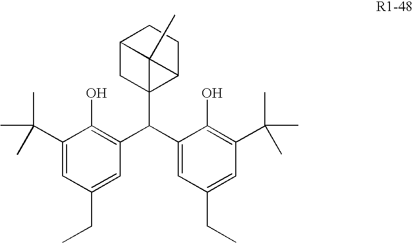

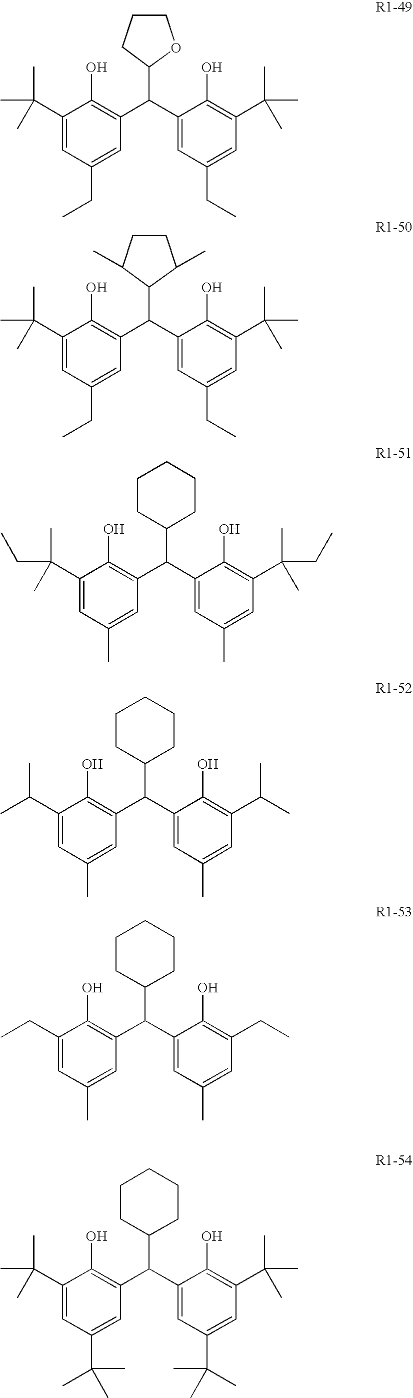

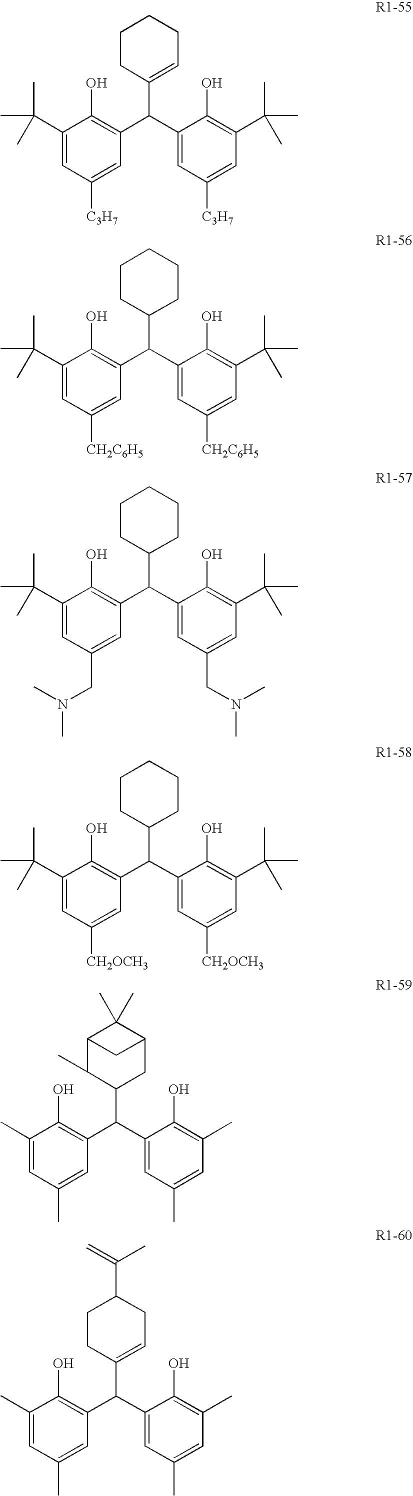

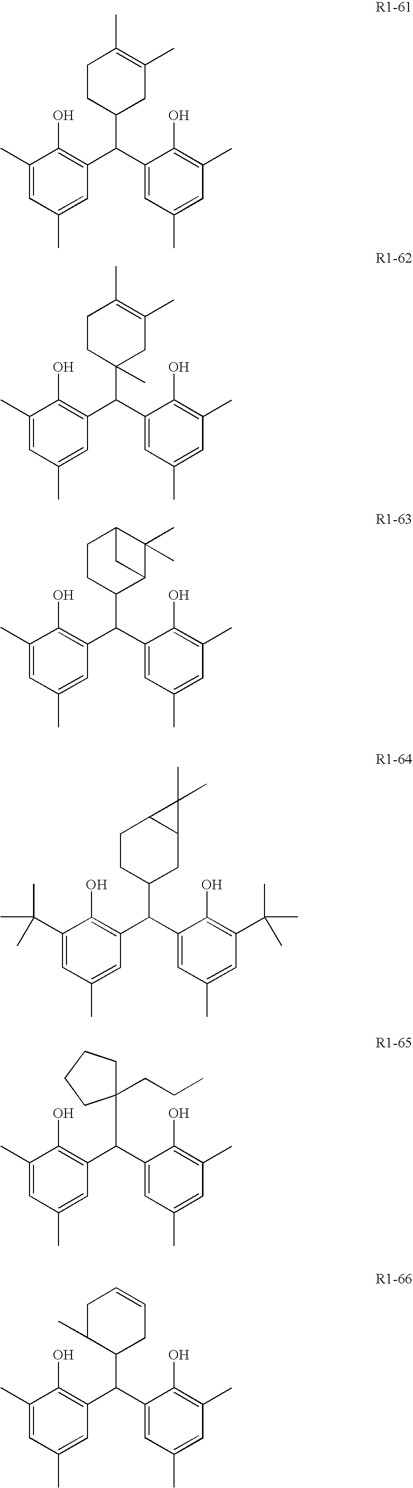

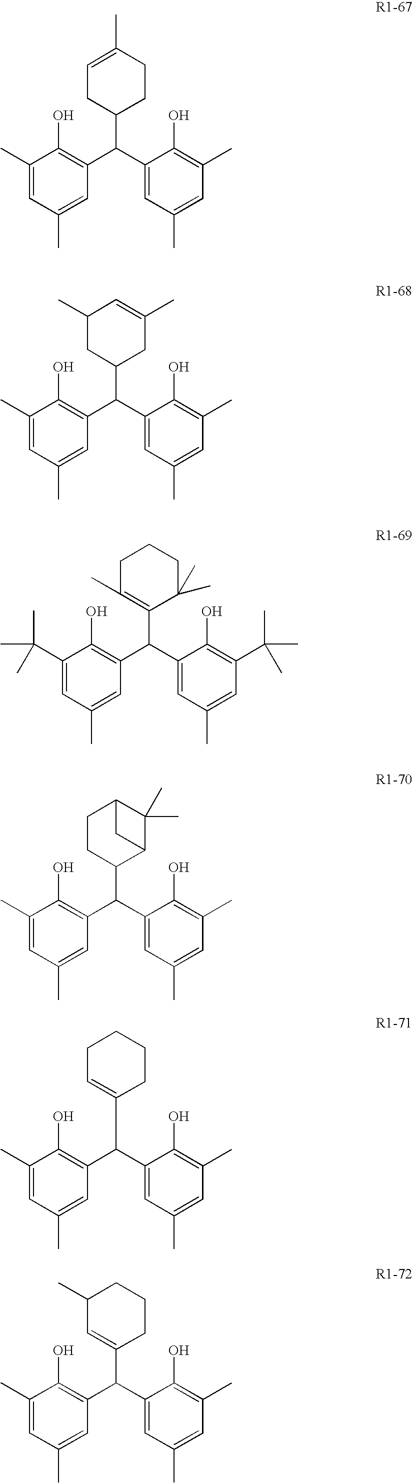

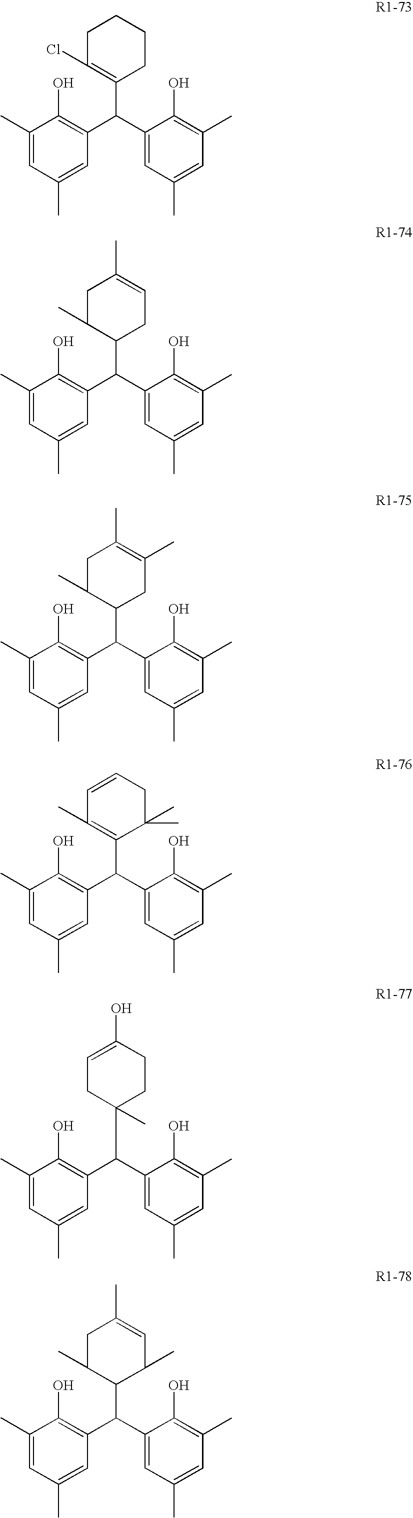

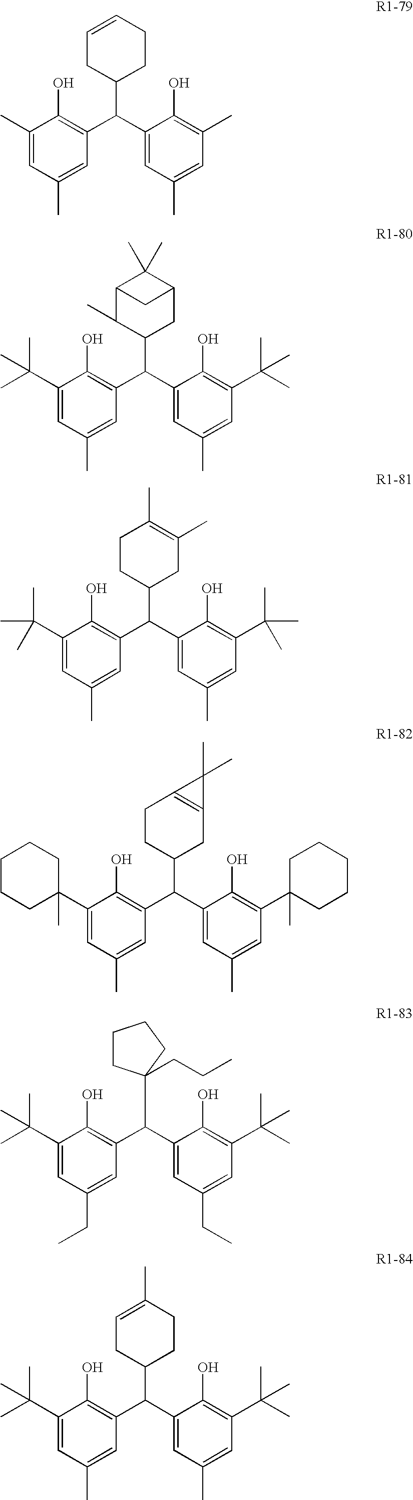

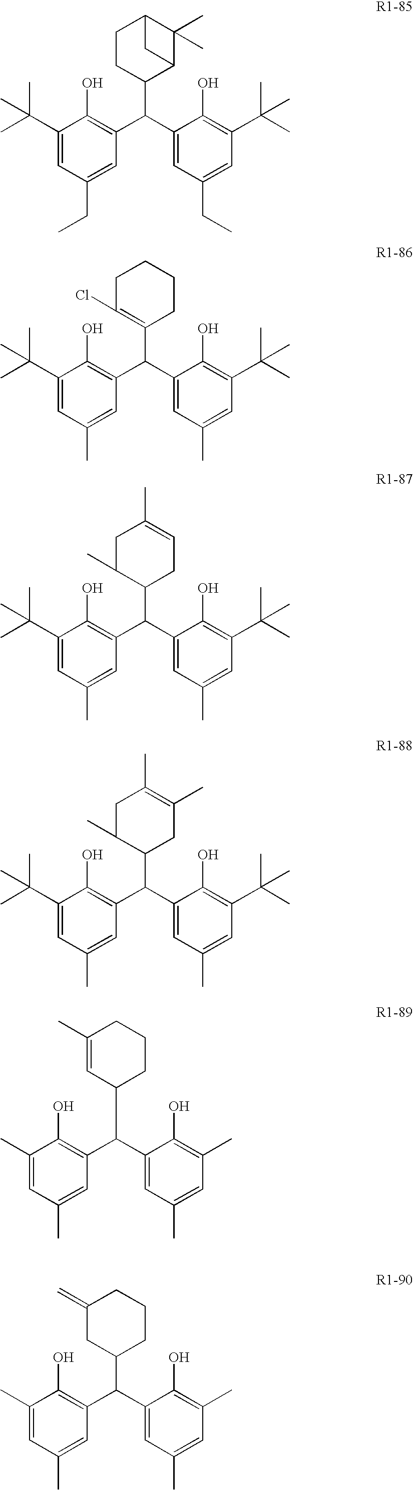

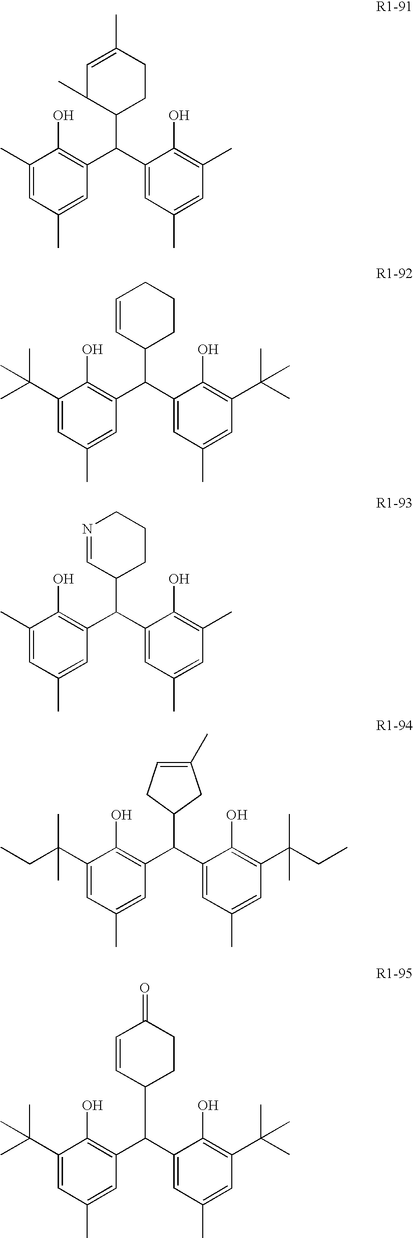

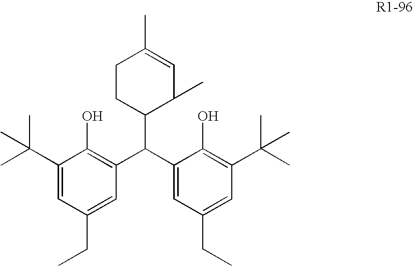

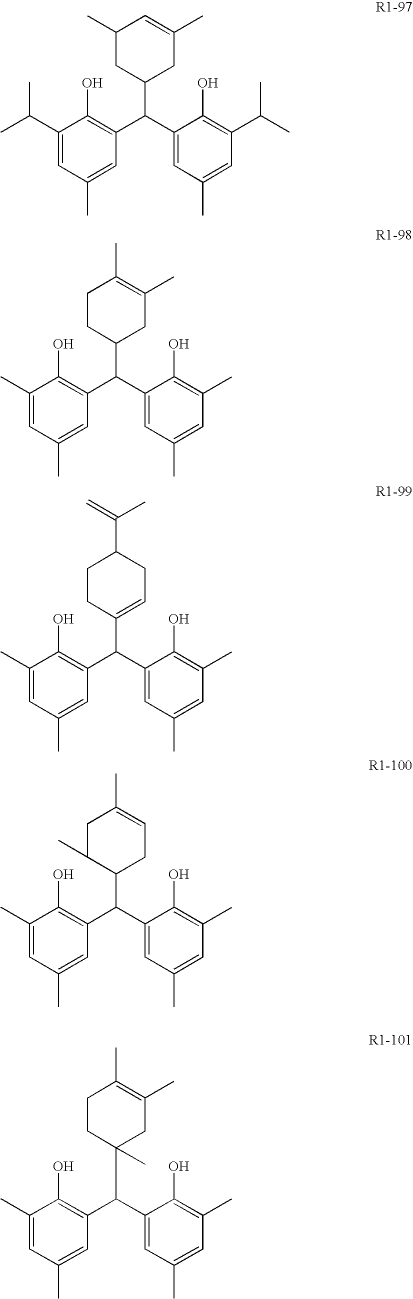

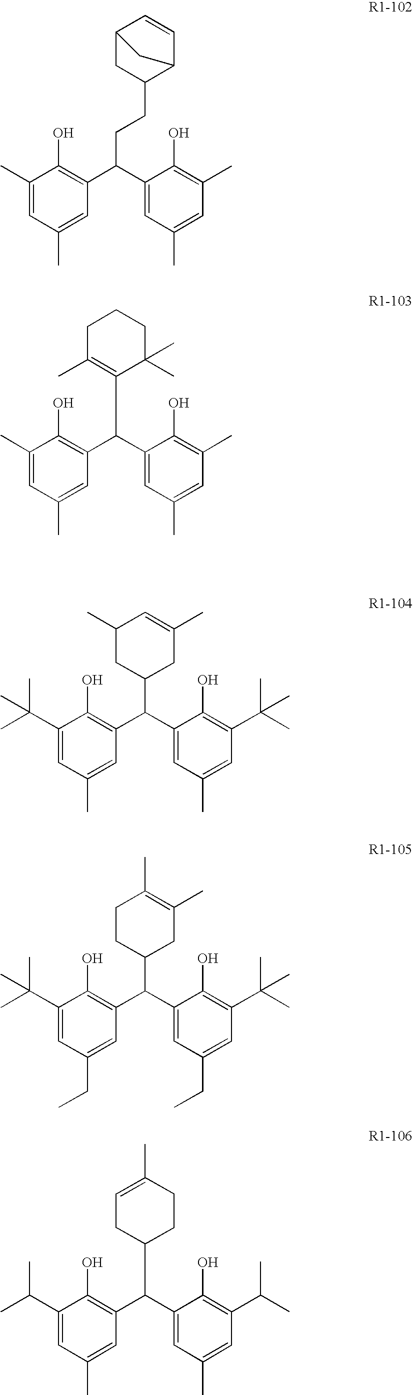

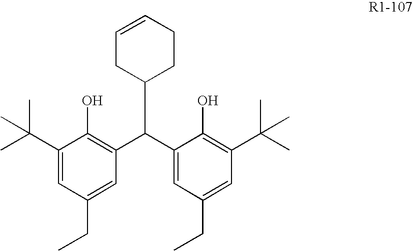

In the present invention, the addition amount of the compound represented by formula (R1) is preferably from 2.0 g/m² to 4.0 g/m², more preferably from 2.2 g/m² to 3.5 g/m², and even more preferably from 2.5 g/m² to 3.0 g/m². The compound represented by formula (R1) is preferably added in an amount of from 10 mol % to 100 mol %, more preferably from 20 mol % to 80 mol %, and even more preferably from 30 mol % to 50 mol %, with respect to 1 mol of silver on the side having the image forming layer.

The compound represented by formula (R1) may be incorporated into the photothermographic material by being contained into the coating solution by any method such as in the form of a solution, an emulsified dispersion, a solid fine particle dispersion, or the like.

As an emulsified dispersing method that is well known in the technical field, there can be mentioned a method comprising dissolving the compound in an oil such as dibutyl phthalate, tricresyl phosphate, glyceryl triacetate, diethyl phthalate, or the like, and an auxiliary solvent such as ethyl acetate, cyclohexanone, or the like, followed by mechanically forming an emulsified dispersion.

As a solid fine particle dispersing method, there is mentioned a method comprising dispersing the powder of the reducing agent in a proper solvent such as water or the like, by means of ball mill, colloid mill, vibrating ball mill, sand mill, jet mill, roller mill, or ultrasonics, thereby obtaining a solid dispersion. In this process, there may be used a protective colloid (such as poly(vinyl alcohol)), or a surfactant (for instance, an anionic surfactant such as sodium triisopropylnaphthalenesulfonate (a mixture of compounds having the three isopropyl groups in different substitution sites)). In the mills enumerated above, generally used as the dispersion media are beads made of zirconia or the like, and Zr or the like eluting from the beads may be incorporated in the dispersion. Although depending on the dispersing conditions, the amount of Zr or the like incorporated in the dispersion is generally in a range of from 1 ppm to 1000 ppm. It is practically acceptable so long as Zr is incorporated in the photothermographic material in an amount of 0.5 mg or less per 1 g of silver.

Preferably, an antiseptic (for instance, benzisothiazolinone sodium salt) is added in an aqueous dispersion.

(Compound Represented by Formula (R))

The reducing agent which can be used in combination with the reducing agent represented by formula (R1) according to the invention is preferably a reducing agent represented by the following formula (R).

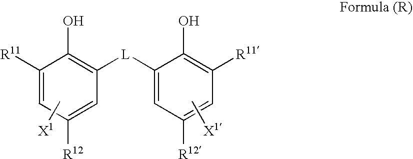

In formula (R), R¹¹ and R^{11′} each independently represent an alkyl group having 1 to 20 carbon atoms. R¹² and R^{12′} each independently represent a hydrogen atom or a substituent which substitutes for a hydrogen atom on a benzene ring. L represents an —S— group or a —CHR¹³— group. R¹³ represents a hydrogen atom or an alkyl group having 1 to 20 carbon atoms. X¹ and X^{1′} each independently represent a hydrogen atom or a group substituting for a hydrogen atom on a benzene ring.

Formula (R) is to be described in detail.

1) R¹¹ and R^{11′}

R¹¹ and R^{11′} each independently represent a substituted or unsubstituted alkyl group having 1 to 20 carbon atoms. The substituent of the alkyl group is not particularly restricted and include, preferably, an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group, a ureido group, a urethane group, a halogen atom, and the like.

2) R¹² and R^{12′}, X¹ and X^{1′}

R¹² and R^{12′} each independently represent a hydrogen atom or a substituent which substitutes for a hydrogen atom on a benzene ring. X¹ and X^{1′} each independently represent a hydrogen atom or a group substituting for a hydrogen atom on a benzene ring. As each of the groups substituting for a hydrogen atom on the benzene ring, an alkyl group, an aryl group, a halogen atom, an alkoxy group, and an acylamino group are described preferably.

3) L

L represents an —S— group or a —CHR¹³— group. R¹³ represents a hydrogen atom or an alkyl group having 1 to 20 carbon atoms in which the alkyl group may have a substituent. Specific examples of the unsubstituted alkyl group for R¹³ include a methyl group, an ethyl group, a propyl group, a butyl group, a heptyl group, an undecyl group, an isopropyl group, a 1-ethylpentyl group, a 2,4,4-trimethylpentyl group, and the like. Examples of the substituent of the alkyl group include, similar to the substituent of R¹¹, a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, a sulfamoyl group, and the like.

4) Preferred Substituents

R¹¹ and R^{11′} are preferably a primary, secondary, or tertiary alkyl group having 1 to 15 carbon atoms; and examples thereof include, specifically, a methyl group, an isopropyl group, a t-butyl group, a t-amyl group, a t-octyl group, a cyclohexyl group, a cyclopentyl group, a 1-methylcyclohexyl group, a 1-methylcyclopropyl group, and the like. R¹¹ and R^{11′} each represent, more preferably, an alkyl group having 1 to 8 carbon atoms and, among them, a methyl group, a t-butyl group, a t-amyl group, and a 1-methylcyclohexyl group are even more preferred, a methyl group and a t-butyl group being most preferred.

R¹² and R^{12′} are preferably an alkyl group having 1 to 20 carbon atoms; and examples thereof include, specifically, a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, a methoxyethyl group, and the like. More preferred are a methyl group, an ethyl group, a propyl group, an isopropyl group, and a t-butyl group, and particularly preferred are a methyl group and an ethyl group.

X¹ and X^{1′} are preferably a hydrogen atom, a halogen atom, or an alkyl group, and more preferably a hydrogen atom.

L is preferably a —CHR¹³— group.

R¹³ is preferably a hydrogen atom or an alkyl group having 1 to 15 carbon atoms. The alkyl group is preferably a chain alkyl group. And, groups which have a C═C bond in these alkyl groups are also preferably used. Preferable examples of the alkyl group include a methyl group, an ethyl group, a propyl group, an isopropyl group, a 2,4,4-trimethylpentyl group, and the like. Particularly preferable R¹³ is a hydrogen atom, a methyl group, an ethyl group, a propyl group, or an isopropyl group.

In the case where R¹¹ and R^{11′} are a tertiary alkyl group and R¹² and R^{12′} are a methyl group, R¹³ is preferably a primary or secondary alkyl group having 1 to 8 carbon atoms (a methyl group, an ethyl group, a propyl group, an isopropyl group, or the like).

In the case where R¹¹ and R^{11′} are a tertiary alkyl group and R¹² and R^{12′} are an alkyl group other than a methyl group, R¹³ is preferably a hydrogen atom.

In the case where R¹¹ and R^{11′} are not a tertiary alkyl group, R¹³ is preferably a hydrogen atom or a secondary alkyl group, and particularly preferably a secondary alkyl group. As the secondary alkyl group for R¹³, an isopropyl group is preferred.

Specific examples of the reducing agent represented by formula (R) are shown below, but the invention is not restricted to these examples.

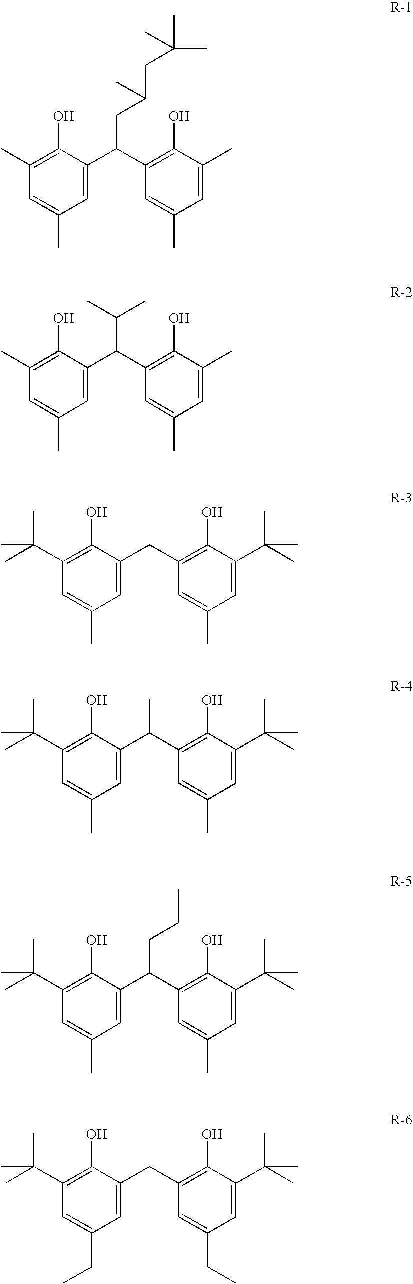

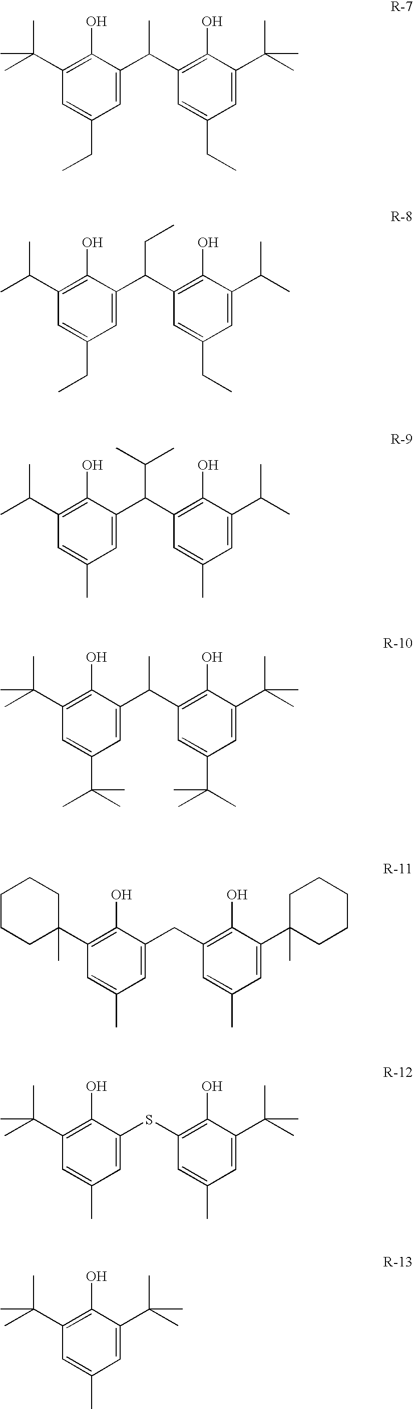

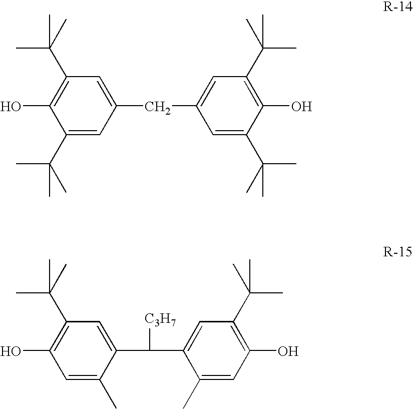

(Development Accelerator)

In the photothermographic material of the invention, as a development accelerator, sulfonamido phenol compounds described in the specification of JP-A No. 2000-267222, and represented by formula (A) described in the specification of JP-A No. 2000-330234; hindered phenol compounds represented by formula (II) described in JP-A No. 2001-92075; hydrazine compounds described in the specification of JP-A No. 10-62895, represented by formula (I) described in the specification of JP-A No. 11-15116, represented by formula (D) described in the specification of JP-A No. 2002-156727, and represented by formula (1) described in the specification of JP-A No. 2002-278017; and phenol or naphthol compounds represented by formula (2) described in the specification of JP-A No. 2001-264929 are used preferably. Further, phenol compounds described in JP-A Nos. 2002-311533 and 2002-341484 are also preferable. Naphthol compounds described in JP-A No. 2003-66558 are particularly preferable. The development accelerator is used in a range of from 0.1 mol % to 20 mol %, preferably in a range of from 0.5 mol % to 10 mol %, and more preferably in a range of from 1 mol % to 5 mol %, with respect to the reducing agent. The introducing methods to the photothermographic material include similar methods to those for the reducing agent, and it is particularly preferred to add the development accelerator as a solid dispersion or an emulsified dispersion. In the case of adding the development accelerator as an emulsified dispersion, it is preferred to add it as an emulsified dispersion dispersed by using a solvent having a high boiling point which is solid at ordinary temperature and an auxiliary solvent having a low boiling point, or to add as a so-called oilless emulsified dispersion not using a solvent having a high boiling point.

In the present invention, among the development accelerators described above, it is more preferred to use hydrazine compounds described in the specifications of JP-A Nos. 2002-156727 and 2002-278017, and naphthol compounds described in the specification of JP-A No. 2003-66558.

Particularly preferred development accelerators used for the invention are compounds represented by the following formulae (A-1) or (A-2).

Q₁-NHNH-Q₂ Formula (A-1)

In the formula, Q₁ represents an aromatic group or heterocyclic group which bonds to —NHNH-Q₂ at a carbon atom, and Q₂ represents one selected from a carbamoyl group, an acyl group, an alkoxycarbonyl group, an aryloxycarbonyl group, a sulfonyl group, or a sulfamoyl group.

In formula (A-1), the aromatic group or heterocyclic group represented by Q₁ is preferably a 5- to 7-membered unsaturated ring. Preferred examples thereof include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring, a thiophene ring, and the like. Condensed rings in which the rings described above are condensed to each other are also preferred.

The rings described above may have substituents, and in the case where they have two or more substituents, the substituents may be identical or different from each other. Examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. In the case where the substituents are groups capable of substitution, they may further have a substituent, and examples of preferred substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group represented by Q₂ is a carbamoyl group preferably having 1 to 50 carbon atoms, and more preferably having 6 to 40 carbon atoms; and examples thereof include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl, and N-benzylcarbamoyl.

The acyl group represented by Q₂ is an acyl group preferably having 1 to 50 carbon atoms, and more preferably having 6 to 40 carbon atoms; and examples thereof include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. The alkoxycarbonyl group represented by Q₂ is an alkoxycarbonyl group preferably having 2 to 50 carbon atoms, and more preferably having 6 to 40 carbon atoms; and examples thereof include methoxycarbonyl, ethoxycarbonyl, isobutyloxycarbonyl, cyclohexyloxycarbonyl, dodecyloxycarbonyl, and benzyloxycarbonyl.

The aryloxycarbonyl group represented by Q₂ is an aryloxycarbonyl group preferably having 7 to 50 carbon atoms, and more preferably having 7 to 40 carbon atoms; and examples thereof include phenoxycarbonyl, 4-octyloxyphenoxycarbonyl, 2-hydroxymethylphenoxycarbonyl, and 4-dodecyloxyphenoxycarbonyl. The sulfonyl group represented by Q₂ is a sulfonyl group preferably having 1 to 50 carbon atoms, and more preferably having 6 to 40 carbon atoms; and examples thereof include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

The sulfamoyl group represented by Q₂ is a sulfamoyl group preferably having 0 to 50 carbon atoms, and more preferably having 6 to 40 carbon atoms; and examples thereof include unsubstituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. The group represented by Q₂ may further have a group mentioned as the example of the substituent of 5- to 7-membered unsaturated ring represented by Q₁ described above at the position capable of substitution. In the case where the group represented by Q₂ has two or more substituents, such substituents may be identical or different from one another.

Next, preferred range for the compound represented by formula (A-1) is to be described. A 5- or 6-membered unsaturated ring is preferred for Q₁, and a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring, and a ring in which the ring described above is condensed with a benzene ring or unsaturated heterocycle are more preferred. Further, Q₂ is preferably a carbamoyl group, and particularly preferably a carbamoyl group having a hydrogen atom on the nitrogen atom.

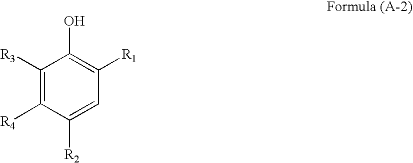

In formula (A-2), R₁ represents one selected from an alkyl group, an acyl group, an acylamino group, a sulfonamido group, an alkoxycarbonyl group, or a carbamoyl group. R₂ represents one selected from a hydrogen atom, a halogen atom, an alkyl group, an alkoxy group, an aryloxy group, an alkylthio group, an arylthio group, an acyloxy group, or a carbonic acid ester group. R₃ and R₄ each independently represent a group substituting for a hydrogen atom on a benzene ring which is mentioned as the example of the substituent of formula (A-1). R₃ and R₄ may link together to form a condensed ring.

R₁ is preferably an alkyl group having 1 to 20 carbon atoms (for example, a methyl group, an ethyl group, an isopropyl group, a butyl group, a tert-octyl group, a cyclohexyl group, or the like), an acylamino group (for example, an acetylamino group, a benzoylamino group, a methylureido group, a 4-cyanophenylureido group, or the like), or a carbamoyl group (for example, a n-butylcarbamoyl group, an N,N-diethylcarbamoyl group, a phenylcarbamoyl group, a 2-chlorophenylcarbamoyl group, a 2,4-dichlorophenylcarbamoyl group, or the like). An acylamino group (including a ureido group and a urethane group) is more preferred. R₂ is preferably a halogen atom (more preferably, a chlorine atom or a bromine atom), an alkoxy group (for example, a methoxy group, a butoxy group, an n-hexyloxy group, an n-decyloxy group, a cyclohexyloxy group, a benzyloxy group, or the like), or an aryloxy group (for example, a phenoxy group, a naphthoxy group, or the like).

R₃ is preferably a hydrogen atom, a halogen atom, or an alkyl group having 1 to 20 carbon atoms, and most preferably a halogen atom. R₄ is preferably a hydrogen atom, an alkyl group, or an acylamino group, and more preferably an alkyl group or an acylamino group. Examples of the preferred substituent thereof are similar to those for R₁. In the case where R₄ is an acylamino group, R₄ may preferably link with R₃ to form a carbostyryl ring.

In the case where R₃ and R₄ in formula (A-2) link together to form a condensed ring, a naphthalene ring is particularly preferred as the condensed ring. The same substituent as the example of the substituent referred to for formula (A-1) may bond to the naphthalene ring. In the case where formula (A-2) is a naphthol compound, R₁ is preferably a carbamoyl group. Among them, a benzoyl group is particularly preferred. R₂ is preferably an alkoxy group or an aryloxy group, and particularly preferably an alkoxy group.

Preferred specific examples for the development accelerator used for the invention are to be described below. The invention is not restricted to these examples.

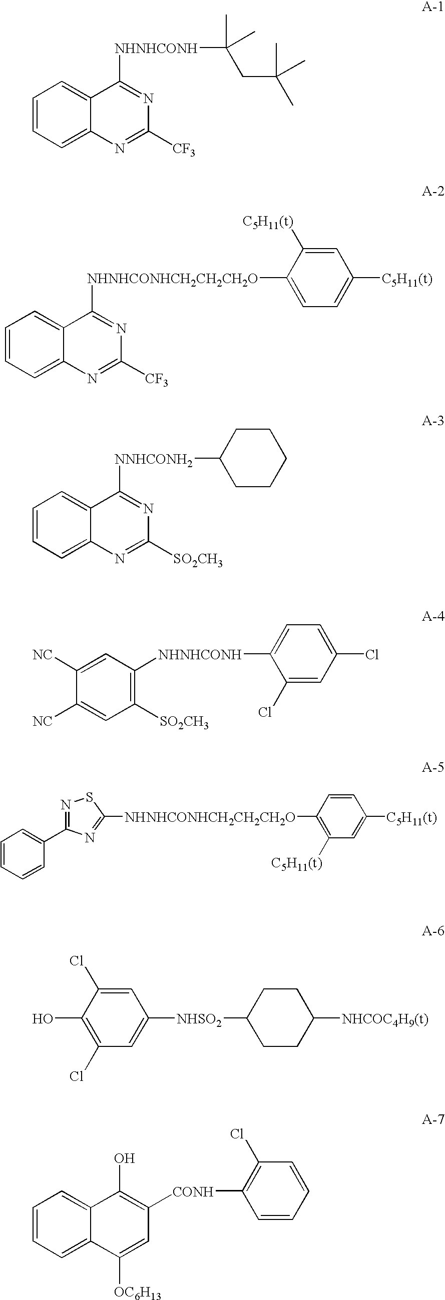

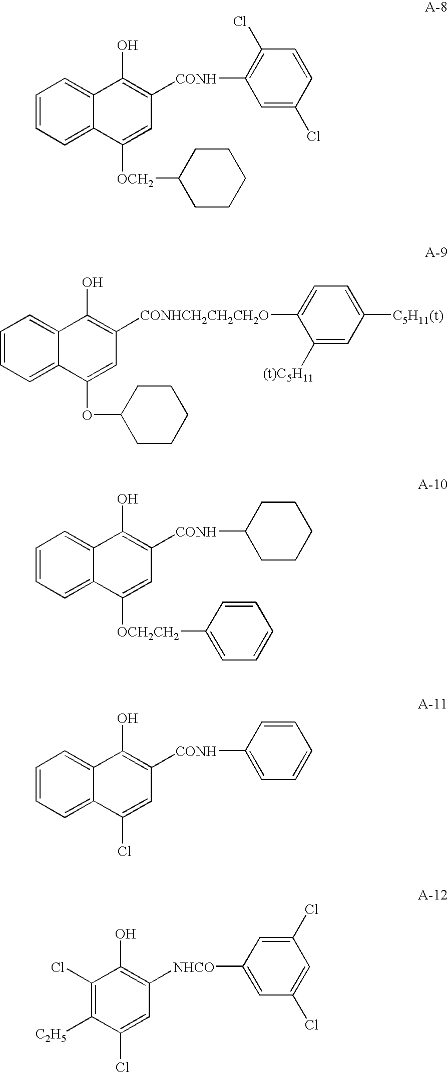

(Hydrogen Bonding Compound)

In the case where the reducing agent according to the invention has an aromatic hydroxy group (—OH) or an amino group (—NHR, R represents a hydrogen atom or an alkyl group), particularly in the case where the reducing agent is a bisphenol described above, it is preferred to use in combination a non-reducing compound having a group which forms a hydrogen bond with these groups of the reducing agent.

Examples of the group forming a hydrogen bond with the hydroxy group or amino group include a phosphoryl group, a sulfoxide group, a sulfonyl group, a carbonyl group, an amido group, an ester group, a urethane group, a ureido group, a tertiary amino group, a nitrogen-containing aromatic group, and the like. Preferred among them are a phosphoryl group, a sulfoxide group, an amido group (not having —N(H)— group but being blocked in the form of —N(Ra)— (where Ra represents a substituent other than H)), a urethane group (not having —N(H)— group but being blocked in the form of —N(Ra)— (where Ra represents a substituent other than H)), and a ureido group (not having —N(H)— group but being blocked in the form of —N(Ra)— (where Ra represents a substituent other than H)).

In the invention, particularly preferable hydrogen bonding compound is the compound represented by the following formula (D).

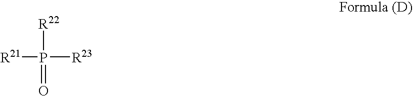

In formula (D), R²¹ to R²³ each independently represent one selected from an alkyl group, an aryl group, an alkoxy group, an aryloxy group, an amino group, or a heterocyclic group, which may be substituted or unsubstituted.

In the case where R²¹ to R²³ has a substituent, examples of the substituent include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, in which preferred as the substituents are an alkyl group and an aryl group, e.g., a methyl group, an ethyl group, an isopropyl group, a t-butyl group, a t-octyl group, a phenyl group, a 4-alkoxyphenyl group, a 4-acyloxyphenyl group, and the like.

Specific examples of the alkyl group represented by R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, a 2-phenoxypropyl group, and the like.

Examples of the aryl group include a phenyl group, a cresyl group, a xylyl group, a naphthyl group, a 4-t-butylphenyl group, a 4-t-octylphenyl group, a 4-anisidyl group, a 3,5-dichlorophenyl group, and the like.

Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group, and the like.

Examples of the aryloxy group include a phenoxy group, a cresyloxy group, an isopropylphenoxy group, a 4-t-butylphenoxy group, a naphthoxy group, a biphenyloxy group, and the like.

Examples of the amino group include a dimethylamino group, a diethylamino group, a dibutylamino group, a dioctylamino group, an N-methyl-N-hexylamino group, a dicyclohexylamino group, a diphenylamino group, an N-methyl-N-phenylamino group, and the like.

Preferred as R²¹ to R²³ are an alkyl group, an aryl group, an alkoxy group, and an aryloxy group. From the viewpoint of the effect of the invention, it is preferred that at least one of R²¹ to R²³ is an alkyl group or an aryl group, and it is more preferred that two or more of them are an alkyl group or an aryl group. Further, from the viewpoint of low cost availability, it is preferred that R²¹ to R²³ are of the same group.

Specific examples of the hydrogen bonding compound represented by formula (D) according to the invention and others are shown below, but the invention is not limited thereto.

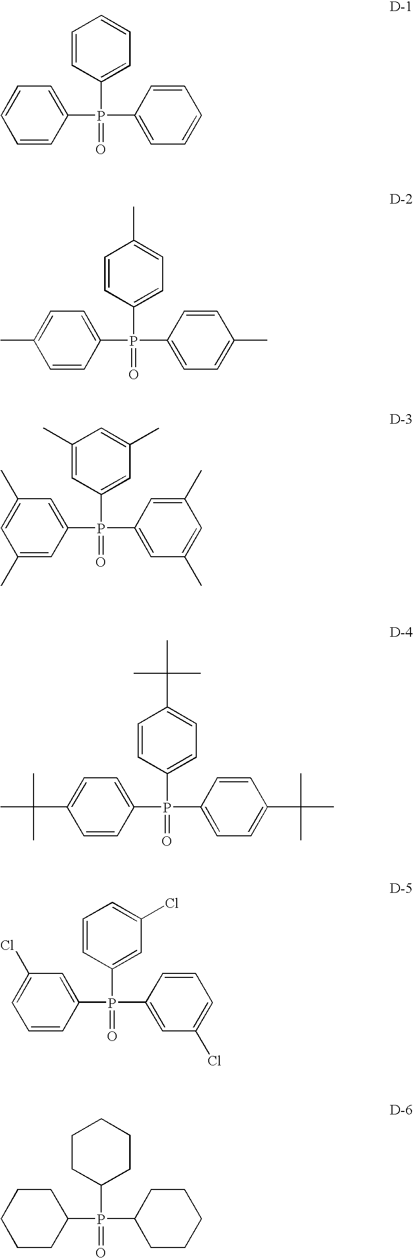

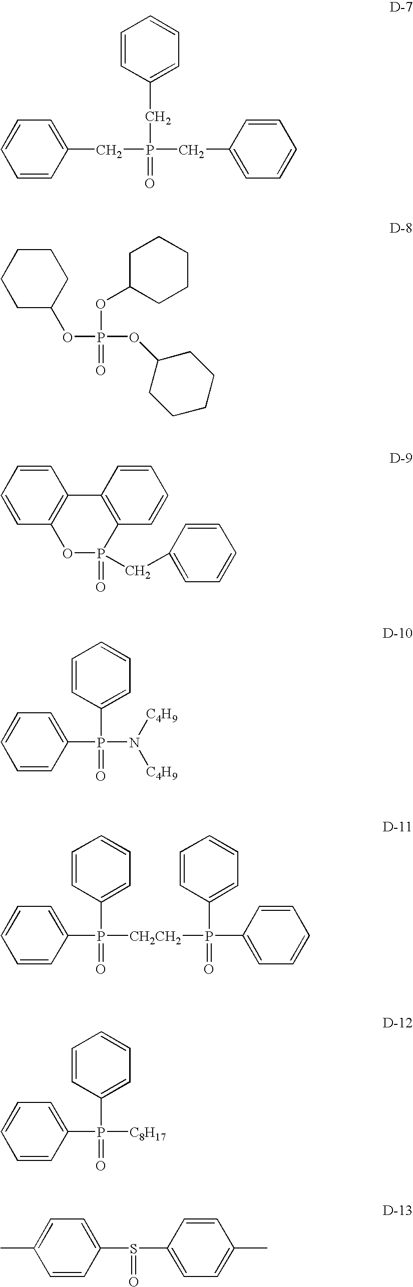

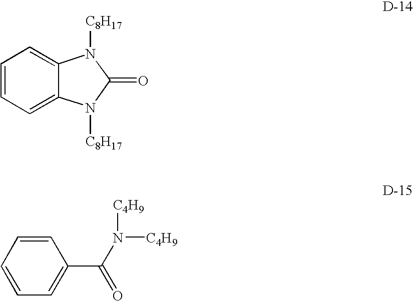

Specific examples of hydrogen bonding compounds other than those enumerated above can be found in those described in EP No. 1096310 and in JP-A Nos. 2002-156727 and 2002-318431.

The compound represented by formula (D) according to the invention can be used in the photothermographic material by being incorporated into the coating solution in the form of a solution, an emulsified dispersion, or a solid fine particle dispersion, similar to the case of reducing agent. However, it is preferably used in the form of a solid dispersion. In a solution state, the compound according to the invention forms a hydrogen-bonded complex with a compound having a phenolic hydroxy group or an amino group, and can be isolated as a complex in crystalline state depending on the combination of the reducing agent and the compound represented by formula (D) according to the invention.

It is particularly preferred to use the crystal powder thus isolated in the form of a solid fine particle dispersion, because it provides stable performance. Further, it is also preferred to use a method of leading to form complex during dispersion by mixing the reducing agent and the compound represented by formula (D) according to the invention in the form of powder, and dispersing them with a proper dispersing agent using sand grinder mill or the like.

The compound represented by formula (D) according to the invention is preferably used in a range of from 1 mol % to 200 mol %, more preferably from 10 mol % to 150 mol %, and even more preferably, from 20 mol % to 100 mol %, with respect to the reducing agent.

(Binder)

Any polymer may be used as the binder for the image forming layer according to the invention. Suitable as the binder are those that are transparent or translucent, and that are generally colorless, such as natural resin or polymer and their copolymers; synthetic resin or polymer and their copolymer; or media forming a film; for example, included are gelatins, rubbers, poly(vinyl alcohols), hydroxyethyl celluloses, cellulose acetates, cellulose acetate butyrates, poly(vinyl pyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinyl acetals) (e.g., poly(vinyl formal) or poly(vinyl butyral)), polyesters, polyurethanes, phenoxy resin, poly(vinylidene chlorides), polyepoxides, polycarbonates, poly(vinyl acetates), polyolefins, cellulose esters, and polyamides. A binder may be used with water, an organic solvent, or emulsion to form a coating solution.

<Binder Used in the Case of Solvent Coating Method>

As the binder used in the case of solvent coating, in which coating is performed using an organic solvent as a coating solvent, poly(vinyl butyral) is preferable. Specifically, poly(vinyl butyral) is used in an amount of 50% by weight or more with respect to the entire constituent content of the binder in the image forming layer. Copolymer and terpolymer are naturally included.

It is preferred that the poly(vinyl butyral) is a mixture of a poly(vinyl acetal) resin (hereinafter, sometimes referred to as a resin of a low polymerization degree) having a residual acetyl group in an amount of 25 mol % or less, a residual hydroxy group in an amount of from 17 mol % to 35 mol %, and a weight-average polymerization degree of from 200 to 600, and a poly(vinyl acetal) resin (hereinafter, sometimes referred to as a resin of a high polymerization degree) having a residual acetyl group in an amount of 25 mol % or less, a residual hydroxy group in an amount of from 17 mol % to 35 mol %, and a weight-average polymerization degree of from 900 to 3,000.

The resin of a low polymerization degree described above is used for the purpose of enhancing the adhesive strength between the image forming layer and the support. Concerning the resin of a low polymerization degree, the lower limit of the weight-average polymerization degree is 200 and the upper limit thereof is 600. When the polymerization degree is less than 200, coating ability is not sufficiently obtained, and the mechanical strength of the obtained image forming layer is deteriorated, even if a resin of a high polymerization degree is used in combination. When the polymerization degree exceeds 600, improvement effect with respect to adhesive property is not sufficiently obtained. The lower limit is preferably 300, and the upper limit is preferably 500.

The resin of a high polymerization degree described above is used for the purpose of enhancing the mechanical strength of the image forming layer and keeping the coating ability. Concerning the resin of a high polymerization degree, the lower limit of the weight-average polymerization degree is 900 and the upper limit thereof is 3,000. When the polymerization degree is less than 900, coating ability and the mechanical strength of the image forming layer are deteriorated. When the polymerization degree exceeds 3,000, coating ability and dispersibility are deteriorated. The lower limit is preferably 1,000, and the upper limit is preferably 1,500.

The weight ratio of the resin of a low polymerization degree to the resin of a high polymerization degree is preferably from 5/95 to 95/5. When the ratio is outside of this range, sufficient adhesive property between the image forming layer and the support is not obtained, and the mechanical strength of the image forming layer is deteriorated.

Concerning the poly(vinyl acetal) resin described above, the upper limit of the amount of residual acetyl group is preferably 25 mol %. When the amount of residual acetyl group exceeds 25 mol %, blocking tends to occur between the obtained photothermographic materials, or sharpness of the obtained image is deteriorated. The upper limit is more preferably 15 mol %.

The lower limit of the amount of residual hydroxy group of the poly(vinyl acetal) resin described above is preferably 17 mol %, and the upper limit thereof is preferably 35 mol %. When the amount of residual hydroxy group is less than 17 mol %, the poly(vinyl acetal) resin used as the binder resin deteriorates the dispersibility of silver salts and tends to lower the sensitivity. When the amount of residual hydroxy group exceeds 35 mol %, the image forming layer of the obtained photothermographic material has high moisture permeability, resulting in occurrence of fog, deterioration of storage stability, or lowering of image density.

The lower limit of the acetalization degree of the poly(vinyl acetal) resin described above is preferably 40 mol %, and the upper limit thereof is preferably 78 mol %. When the acetalization degree is less than 40 mol %, the poly(vinyl acetal) resin is insoluble in organic solvent so that it cannot be used as the binder resin of the image forming layer of the photothermographic material. When the acetalization degree exceeds 78 mol %, the amount of residual hydroxy group becomes so small that the poly(vinyl acetal) resin loses its toughness and the mechanical strength of the coated membrane is deteriorated.

In the present specification, as a method for calculating the acetalization degree, a method of counting pairs of acetalized hydroxy groups is applied for the calculation of acetalization degree, which is expressed by mol %, because the acetal group of poly(vinyl acetal) resin is formed by acetalizing two hydroxy groups.

The poly(vinyl acetal) resin described above is preferably a modified poly(vinyl acetal) resin having, at the side chain, at least one functional group selected from the group consisting of a functional group represented by the following formula (1), a functional group represented by the following formula (2), a functional group represented by the following formula (3), a functional group represented by the following formula (4), a functional group represented by the following formula (5), a functional group represented by the following formula (6), a tertiary amine group, and a quaternary ammonium salt group. By having such a hydrophilic functional group in the side chain, dispersibility of organic silver salts can be improved.

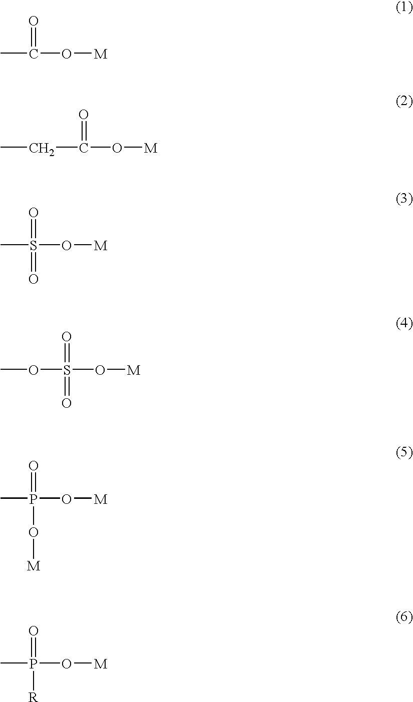

In the formulae, M represents H, Li, Na, or K; and R represents a hydrogen atom or an alkyl group having 1 to 20 carbon atoms.

Examples of the tertiary amine group described above include trimethylamine, triethylamine, triethanolamine, tripropylamine, tributylamine, and the like. When R represents an alkyl group, an alkyl group having 1 to 10 carbon atoms is preferred, and examples thereof include a methyl group, an ethyl group, an isopropyl group, a butyl group, a t-butyl group, a cyclohexyl group and the like.

The lower limit of the amount of functional groups in the modified poly(vinyl acetal) resin described above is preferably 0.1 mol %, and the upper limit thereof is preferably 5 mol %. When the amount is less than 0.1 mol %, improvement effect with respect to dispersibility of the organic silver salt cannot be obtained. When the amount exceeds 5 mol %, solubility in organic solvent is lowered.

As the poly(vinyl acetal) resin, a modified poly(vinyl acetal) resin having an α-olefin unit in the main chain is also preferable. The α-olefin unit is not particularly limited, but for example, an α-olefin unit derived from a straight-chain or cyclic alkyl group having 1 to 20 carbon atoms is preferable.

As long as the α-olefin unit is within the above range, it may include both of a branched or straight-chain part and a cyclic part. When the α-olefin unit has more than 20 carbon atoms, solvent solubility of modified poly(vinyl alcohol) resin used as a raw material may be lowered so that acetalization reaction does not proceed sufficiently to obtain modified poly(vinyl acetal) resin, or solvent solubility of the obtained modified poly(vinyl acetal) resin may be so low that the resin cannot be used as the binder resin for the image forming layer of the photothermographic material. The α-olefin unit is more preferably derived from a straight-chain or cyclic alkyl group having 1 to 10 carbon atoms, and even more preferably, the α-olefin unit is derived from a straight-chain alkyl group having 2 to 6 carbon atoms. Specific preferred examples thereof include units derived from methylene, ethylene, propylene, isopropylene, butylene, isobutylene, pentylene, hexylene, cyclohexylene, cyclohexylethylene, cyclohexylpropylene, or the like.

Concerning the content of the α-olefin unit in the main chain of the modified poly(vinyl acetal) resin described above, the lower limit is preferably 1 mol % and the upper limit is preferably 20 mol %. When the content is less than 1 mol %, the effect of decreasing moisture permeability cannot be sufficiently obtained. When the content exceeds 20 mol %, solvent solubility of modified poly(vinyl alcohol) resin used as a raw material is lowered so that acetalization reaction does not proceed sufficiently to obtain modified poly(vinyl acetal) resin. Even if obtained, solvent solubility of the obtained modified poly(vinyl acetal) resin is so low that the resin cannot be used as the binder resin for the image forming layer of the photothermographic material. The upper limit is more preferably 10 mol %.

Concerning the amount of residual halide of the poly(vinyl acetal) resin described above, the upper limit is preferably 100 ppm. When the amount exceeds 100 ppm, the residual halide acts as a formation material of photosensitive silver halide and causes deterioration in storage stability of coating solution, deterioration in storability of the photothermographic material, fogging, or the like. Examples of the method for adjusting the amount of residual halide to an amount of 100 ppm or less include a method of selecting a non-halogen type catalyst for use in acetalization, a method of refining the resulting product by a washing operation using water, a mixed solution of water and alcohol, or the like to remove the residual halide to reach the defined amount or less in the case where a halogen type catalyst is used, and the like. The upper limit is more preferably 50 ppm.

The poly(vinyl acetal) resin described above can be synthesized by an acetalization reaction of poly(vinyl alcohol) having a saponification degree of 75 mol % or more with various types of aldehydes. Generally, the poly(vinyl acetal) resin is synthesized by reacting poly(vinyl alcohol) with various types of aldehydes using an acid catalyst in an aqueous solution, alcohol solution, mixed solution of water and alcohol, dimethyl sulfoxide solution (DMSO), or the like. Furthermore, the poly(vinyl acetal) resin can also be synthesized by adding an acid catalyst and aldehyde in an alcohol solution containing poly(vinyl acetate) or modified poly(vinyl acetate).

Any aldehydes capable of being acetalized, such as formaldehyde, acetaldehyde, butyraldehyde, propyl aldehyde, and the like may be used for the aldehyde described above. Acetaldehyde and butyraldehyde are preferably used alone or in combination. Furthermore, a proportion of the portion acetalized by acetaldehyde based on the total acetalized portion of the poly(vinyl acetal) resin is preferably 30% or higher. In the case where the proportion of the portion acetalized by acetaldehyde is lower than 30%, the glass transition temperature of the obtained poly(vinyl acetal) resin becomes 80° C. or lower, so that the nucleus growth of the photosensitive silver salt proceeds too much and dispersibility of the silver salt is not sufficiently obtained, whereby resolution and sharpness of the image cannot be sufficiently provided. More preferably, the proportion of the portion acetalized by acetaldehyde is 50% or higher. By using the poly(vinyl acetal) resin in which the acetoacetal portion is introduced, dispersibility of the silver salt is improved, and thermal melting property, cool-hardening property, and the like become sharper. As a result, it is possible to control the nucleus growth of the silver salt precisely, resulting in improved sharpness of the image and gradation portion.

The acid catalyst described above is not particularly limited, and either organic acid or inorganic acid can be applied. Examples of the acid catalyst include acetic acid, p-toluene sulfonic acid, nitric acid, sulfuric acid, hydrochloric acid, and the like. Examples of alkali which is used upon stopping the synthesizing reaction include sodium hydroxide, potassium hydroxide, ammonia, sodium acetate, sodium carbonate, sodium hydrogencarbonate, potassium carbonate, potassium hydrogencarbonate, and the like.

In the acetalization reaction of poly(vinyl alcohol) and aldehyde, an antioxidant is usually added in the reaction system or in the resin system for the purpose of inhibiting oxidation of the aldehyde or inhibiting oxidation of the obtained resin and enhancing heat resistance. However, in the synthesis of the above-described poly(vinyl acetal) resin, an antioxidant which is used normally such as a hindered phenol antioxidant, bisphenol antioxidant, phosphoric acid type antioxidant, or the like is not used. When these antioxidants are used, the antioxidant used remains in the poly(vinyl acetal) resin and causes deterioration in the pot life of coating solution, deterioration in storage stability of the photothermographic material, and the like, resulting in fogging and spoiling sharpness of the image and gradation portion.

Further, examples of the method for preparing the modified poly(vinyl acetal) resin having the above functional group in the side chain include a method of using, as a raw material, a modified poly(vinyl alcohol) resin, which is obtained by saponifying a copolymer copolymerized by vinyl ester and a monomer having the above functional group, and acetalizing the resin; a method of introducing the functional group by utilizing the hydroxy group which bonds to the main chain of poly(vinyl alcohol) resin or poly(vinyl acetal) resin; and the like.

Examples of the monomer having the functional group described above include acrylic acid, maleic acid, itaconic acid, and the like.

Further, examples of the method for obtaining the above-described modified poly(vinyl acetal) resin having an α-olefin unit in the main chain include a method of using, as a raw material, a modified poly(vinyl alcohol) resin, which is obtained by saponifying a copolymer copolymerized by vinyl ester and α-olefin, and acetalizing the resin, and the like.

The mixed resin described above is preferably obtained by acetalizing poly(vinyl alcohol) having a polymerization degree of from 200 to 600 and poly(vinyl alcohol) having a polymerization degree of from 900 to 3,000.

In the mixed resin prepared by the above method, intermolecular crosslinking is partially performed by aldehyde so that solubility of the entire resin in the solvent, transparency, and dispersibility of compounds are improved, and further, occurrence of fog can be suppressed and coating ability can be improved.

Concerning the mixed resin described above, the lower limit of the ratio of weight-average molecular weight relative to number-average molecular weight (Mw/Mn) is preferably 3.5. When the ratio is less than 3.5, thixotropic property is lowered, and viscosity increases at the time of coating, whereby productivity of the photothermographic material of the present invention would be deteriorated. Incidentally, the ratio of molecular distribution Mw/Mn can be measured by gel permeation chromatography (GPC) or the like using THF or the like as solvent and standard polystyrene or the like as a correction sample.

The total amount of the binder is set to an amount sufficient to maintain the components of the image forming layer therein. Namely, the binder is used within a range effective to exert the function as binder. The effective range can be appropriately determined by one skilled in the art. As a standard amount in the case of maintaining at least the organic silver salt, the weight ratio of the binder to the organic silver salt is from 15:1 to 1:3, and particularly preferably from 8:1 to 1:2.

<Binder Used in the Case of Aqueous Coating Method>

Concerning the binder used in the case of aqueous coating method, the glass transition temperature (Tg) of the binder is preferably in a range of from 0° C. to 80° C. (hereinafter, sometimes referred to as “high-Tg binder”), more preferably from 10° C. to 70° C., and even more preferably from 15° C. to 60° C.

In the specification, Tg is calculated according to the following equation:

1/Tg=Σ(Xi/Tgi)

where the polymer is obtained by copolymerization of n monomer components (from i=1 to i=n); Xi represents the weight fraction of the ith monomer (ΣXi=1), and Tgi is the glass transition temperature (absolute temperature) of the homopolymer obtained with the ith monomer. The symbol Σ stands for the summation from i=1 to i=n.

Values for the glass transition temperature (Tgi) of the homopolymers derived from each of the monomers were obtained from the values of J. Brandrup and E. H. Immergut, Polymer Handbook (3rd Edition) (Wiley-Interscience, 1989).

The binder may be of two or more types depending on needs. And, the polymer having Tg of 20° C. or higher and the polymer having Tg of lower than 20° C. may be used in combination. In the case where two or more polymers differing in Tg are blended for use, it is preferred that the weight-average Tg is within the range mentioned above.

In the invention, in the case where the image forming layer is formed by first applying a coating solution containing 30% by weight or more of water in the solvent and by then drying, furthermore, in the case where the binder of the image forming layer is soluble or dispersible in an aqueous solvent (water solvent), and particularly in the case where a polymer latex having an equilibrium water content of 2% by weight or lower at 25° C. and 60% RH is used, the performance is enhanced. Most preferred embodiment is such prepared to yield an ion conductivity of 2.5 mS/cm or lower, and as such a preparing method, there is mentioned a refining treatment using a separation function membrane after synthesizing the polymer.

The aqueous solvent in which the polymer is soluble or dispersible, as referred herein, signifies water or water containing mixed therein 70% by weight or less of a water-miscible organic solvent. Examples of the water-miscible organic solvent include alcohols such as methyl alcohol, ethyl alcohol, propyl alcohol, or the like; cellosolves such as methyl cellosolve, ethyl cellosolve, butyl cellosolve, or the like; ethyl acetate; dimethylformamide, and the like.

The term “aqueous solvent” is also used in the case where the polymer is not thermodynamically dissolved, but is present in a so-called dispersed state.

The term “equilibrium water content at 25° C. and 60% RH” as referred herein can be expressed as follows:

Equilibrium water content at 25° C. and 60% RH=[(W1−W0)/W0]×100 (% by weight)

wherein W1 is the weight of the polymer in moisture-controlled equilibrium under an atmosphere of 25° C. and 60% RH, and WO is the absolutely dried weight at 25° C. of the polymer.

For the definition and the method of measurement for water content, reference can be made to Polymer Engineering Series 14, “Testing methods for polymeric materials” (The Society of Polymer Science, Japan, published by Chijin Shokan).

The equilibrium water content at 25° C. and 60% RH is preferably 2% by weight or lower, more preferably in a range of from 0.01% by weight to 1.5% by weight, and even more preferably from 0.02% by weight to 1% by weight.

The binders used in the invention are particularly preferably polymers capable of being dispersed in an aqueous solvent. Examples of dispersed states may include a latex, in which water-insoluble fine particles of hydrophobic polymer are dispersed, or such in which polymer molecules are dispersed in molecular states or by forming micelles, but preferred are latex-dispersed particles. The mean particle diameter of the dispersed particles is in a range of from 1 nm to 50,000 nm, preferably from 5 nm to 1,000 nm, more preferably from 10 nm to 500 nm, and even more preferably from 50 nm to 200 nm. There is no particular limitation concerning particle diameter distribution of the dispersed particles, and the particles may be widely distributed or may exhibit a monodispersed particle diameter distribution. From the viewpoint of controlling the physical properties of the coating solution, preferred mode of usage includes mixing two or more types of dispersed particles each having monodispersed particle diameter distribution.

In the invention, preferred embodiment of the polymers capable of being dispersed in aqueous solvent includes hydrophobic polymers such as acrylic polymer, polyesters, rubbers (e.g., SBR resin), polyurethanes, poly(vinyl chlorides), poly(vinyl acetates), poly(vinylidene chlorides), polyolefins, or the like. As the polymers above, usable are straight-chain polymers, branched polymers, or crosslinked polymers; also usable are the so-called homopolymers in which one type of monomer is polymerized, or copolymers in which two or more types of monomers are polymerized. In the case of a copolymer, it may be a random copolymer or a block copolymer. The molecular weight of the polymer is, in number average molecular weight, in a range of from 5,000 to 1,000,000, and preferably from 10,000 to 200,000. Those having too small molecular weight exhibit insufficient mechanical strength on forming the image forming layer, and those having too large molecular weight are also not preferred because the resulting film-forming properties are poor. Further, crosslinking polymer latexes are particularly preferred for use.

—Specific Examples of Latex—

Specific examples of preferable polymer latex are given below, which are expressed by the starting monomers with % by weight given in parenthesis. The molecular weight is given in number average molecular weight. In the case where polyfunctional monomer is used, the concept of molecular weight is not applicable because they build a crosslinked structure. Hence, they are denoted as “crosslinking”, and the description of the molecular weight is omitted. Tg represents glass transition temperature.

P-1: Latex of -MMA(70) -EA(27) -MAA(3)—(molecular weight 37000, Tg 61° C.)

P-2: Latex of -MMA(70) -2EHA(20) -St(5) -AA(5)—(molecular weight 40000, Tg 59° C.)

P-3: Latex of -St(50) -Bu(47) -MAA(3)—(crosslinking, Tg −17° C.)

P-4: Latex of -St(68) -Bu(29) -AA(3)—(crosslinking, Tg 17° C.)

P-5: Latex of -St(71) -Bu(26) -AA(3)—(crosslinking, Tg 24° C.)

P-6: Latex of -St(70) -Bu(27) -IA(3)—(crosslinking)

P-7: Latex of -St(75) -Bu(24) -AA(1)—(crosslinking, Tg 29° C.)

P-8: Latex of -St(60) -Bu(35) -DVB(3) -MAA(2)—(crosslinking)

P-9: Latex of -St(70) -Bu(25) -DVB(2) -AA(3)—(crosslinking)

P-10: Latex of -VC(50) -MMA(20) -EA(20) -AN(5) -AA(5)—(molecular weight 80000)

P-11: Latex of -VDC(85) -MMA(5) -EA(5) -MAA(5)—(molecular weight 67000)

P-12: Latex of -Et(90) -MAA(10)—(molecular weight 12000)

P-13: Latex of -St(70) -2EHA(27) -AA(3)—(molecular weight 130000, Tg 43° C.)

P-14: Latex of -MMA(63) -EA(35) -AA(2)—(molecular weight 33000, Tg 47° C.)

P-15: Latex of -St(70.5) -Bu(26.5) -AA(3)—(crosslinking, Tg 23° C.)

P-16: Latex of -St(69.5) -Bu(27.5) -AA(3)—(crosslinking, Tg 20.5° C.)

P-17: Latex of -St(61.3) -Isoprene(35.5) -AA(3)—(crosslinking, Tg 17° C.)

P-18: Latex of -St(67) -Isoprene(28) -Bu(2) -AA(3)—(crosslinking, Tg 27° C.)

In the structures above, abbreviations represent monomers as follows. MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, IA: itaconic acid.

The polymer latexes described above are also commercially available, and polymers below can be used. Examples of acrylic polymer include Cevian A-4635, 4718, and 4601 (all manufactured by Daicel Chemical Industries, Ltd.), Nipol Lx811, 814, 821, 820, and 857 (all manufactured by Nippon Zeon Co., Ltd.), and the like; examples of polyesters include FINETEX ES650, 611, 675, and 850 (all manufactured by Dainippon Ink and Chemicals, Inc.), WD-size and WMS (all manufactured by Eastman Chemical Co.), and the like; examples of polyurethanes include HYDRAN AP10, 20, 30, and 40 (all manufactured by Dainippon Ink and Chemicals, Inc.), and the like; examples of rubbers include LACSTAR 7310K, 3307B, 4700H, and 7132C (all manufactured by Dainippon Ink and Chemicals, Inc.), Nipol Lx416, 410, 438C, and 2507 (all manufactured by Nippon Zeon Co., Ltd.), and the like; examples of poly(vinyl chlorides) include G351 and G576 (all manufactured by Nippon Zeon Co., Ltd.), and the like; examples of poly(vinylidene chlorides) include L502 and L513 (all manufactured by Asahi Chemical Industry Co., Ltd.), and the like; and examples of polyolefins include Chemipearl S120 and SA100 (all manufactured by Mitsui Petrochemical Industries, Ltd.), and the like.

The polymer latex above may be used alone, or may be used by blending two or more of them depending on needs.

—Preferable Latex—

Particularly preferable as the polymer latex for use in the invention is that of styrene-butadiene copolymer or that of styrene-isoprene copolymer. The weight ratio of the monomer unit of styrene relative to that of butadiene or isoprene constituting the styrene-butadiene copolymer or the styrene-isoprene copolymer is preferably in a range of from 40:60 to 95:5. Further, the monomer unit of styrene and that of butadiene or isoprene preferably account for 60% by weight to 99% by weight with respect to the copolymer. Further, the polymer latex according to the invention preferably contains acrylic acid or methacrylic acid in a range of from 1% by weight to 6% by weight with respect to the sum of styrene and butadiene or isoprene, and more preferably from 2% by weight to 5% by weight.

The polymer latex according to the invention preferably contains acrylic acid. Preferable range of molecular weight is similar to that described above.

As the latex of styrene-butadiene copolymer preferably used in the invention, there are mentioned P-3 to P-9 and P-15 described above, and commercially available LACSTAR-3307B, 7132C, Nipol Lx416, and the like. And as examples of the latex of styrene-isoprene copolymer, there are mentioned P-17 and P-18 described above.

In the image forming layer of the photothermographic material of the invention, if necessary, there may be added hydrophilic polymer such as gelatin, poly(vinyl alcohol), methyl cellulose, hydroxypropyl cellulose, carboxymethyl cellulose, or the like. The hydrophilic polymer is preferably added in an amount of 30% by weight or less, and more preferably 20% by weight or less, with respect to the total weight of binder incorporated in the image forming layer.

The image forming layer according to the invention is preferably formed by using polymer latex.

Concerning the amount of the binder for the image forming layer, the weight ratio of total binder to organic silver salt is preferably in a range of from 1/10 to 10/1, more preferably from 1/3 to 5/1, and even more preferably from 1/1 to 3/1.

The image forming layer is, in general, a photosensitive layer containing a photosensitive silver halide, i.e., the photosensitive silver salt; and in such a case, the weight ratio of total binder to silver halide is in a range of from 5 to 400, and more preferably from 10 to 200.

The total amount of binder in the image forming layer according to the invention is preferably in a range of from 0.2 g/m² to 30 g/m², more preferably from 1 g/m² to 15 g/m², and even more preferably from 2 g/m² to 10 g/m². To the image forming layer according to the invention, there may be added a crosslinking agent for crosslinking, a surfactant to improve coating ability, or the like.

—Preferred Solvent of Coating Solution—

In the invention, a solvent of a coating solution for the image forming layer of the photothermographic material (wherein a solvent and dispersion medium are collectively represented as a solvent for simplicity) is preferably an aqueous solvent containing water at 30% by weight or more. Examples of components other than water may include any of water-miscible organic solvents such as methyl alcohol, ethyl alcohol, isopropyl alcohol, methyl cellosolve, ethyl cellosolve, dimethylformamide and ethyl acetate. The water content in a solvent of a coating solution is more preferably 50% by weight or higher, and even more preferably 70% by weight or higher. Examples of a preferable solvent composition include, in addition to water, water/methyl alcohol=90/10, water/methyl alcohol=70/30, water/methyl alcohol/dimethylformamide=80/15/5, water/methyl alcohol/ethyl cellosolve=85/10/5, water/methyl alcohol/isopropyl alcohol=85/10/5, and the like (wherein the numerals are values in % by weight).

(Antifoggant)

As an antifoggant, stabilizer, and stabilizer precursor which can be used in the invention, there are mentioned those of patents described in paragraph No. 0070 of JP-A No. 10-62899 and in line 57 of page 20 to line 7 of page 21 of EP-A No. 0803764A1, the compounds described in JP-A Nos. 9-281637 and 9-329864, and the compounds described in U.S. Pat. No. 6,083,681, and EP-A No. 1048975.

1) Organic Polyhalogen Compound

Preferable organic polyhalogen compound that can be used in the invention is the compound represented by the following formula (H).

Q-(Y)n-C(Z₁)(Z₂)X Formula (H)

In formula (H), Q represents an alkyl group, an aryl group, or a heterocyclic group; Y represents a divalent linking group; n represents 0 or 1; Z₁ and Z₂ each represent a halogen atom; and X represents a hydrogen atom or an electron-attracting group.

In formula (H), Q is preferably an alkyl group having 1 to 6 carbon atoms, an aryl group having 6 to 12 carbon atoms, or a heterocyclic group comprising at least one nitrogen atom (pyridine, quinoline, or the like).

In the case where Q is an aryl group in formula (H), Q is preferably a phenyl group substituted by an electron-attracting group whose Hammett substituent constant σp yields a positive value. For the details of Hammett substituent constant, reference can be made to Journal of Medicinal Chemistry, vol. 16, No. 11 (1973), pp. 1207 to 1216, and the like. As such electron-attracting groups, examples include a halogen atom, an alkyl group substituted by an electron-attracting group, an aryl group substituted by an electron-attracting group, a heterocyclic group, an arylsulfonyl group, an alkylsulfonyl group, an acyl group, an alkoxycarbonyl group, a carbamoyl group, a sulfamoyl group, and the like. Preferable as the electron-attracting group is a halogen atom, a carbamoyl group, or an arylsulfonyl group, and particularly preferred is a carbamoyl group.

X is preferably an electron-attracting group. As the electron-attracting group, preferable are a halogen atom, an aliphatic arylsulfonyl group, a heterocyclic sulfonyl group, an aliphatic arylacyl group, a heterocyclic acyl group, an aliphatic aryloxycarbonyl group, a heterocyclic oxycarbonyl group, a carbamoyl group, and a sulfamoyl group; more preferable are a halogen atom and a carbamoyl group; and particularly preferable is a bromine atom.

Z₁ and Z₂ each are preferably a bromine atom or an iodine atom, and more preferably, a bromine atom.

Y preferably represents —C(═O)—, —SO—, —SO₂—, —C(═O)N(R)—, or —SO₂N(R)—; more preferably, —C(═O)—, —SO₂—, or —C(═O)N(R)—; and particularly preferably, —SO₂— or —C(═O)N(R)—. Herein, R represents a hydrogen atom, a substituted or unsubstituted aryl group, or a substituted or unsubstituted alkyl group. R is preferably a hydrogen atom or an alkyl group, and particularly preferably a hydrogen atom.

n represents 0 or 1, and is preferably 1.

In formula (H), in the case where Q is an alkyl group, Y is preferably —C(═O)N(R)—. And, in the case where Q is an aryl group or a heterocyclic group, Y is preferably —SO₂—.

In formula (H), the embodiment where the residues, which are obtained by removing a hydrogen atom from the compound, bond to each other (generally called bis type, tris type, or tetrakis type) is also preferably used.

In formula (H), the embodiment having, as a substituent, a dissociative group (for example, a COOH group or a salt thereof, an SO₃H group or a salt thereof, a PO₃H group or a salt thereof, or the like), a group containing a quaternary nitrogen cation (for example, an ammonio group, a pyridinio group, or the like), a polyethyleneoxy group, a hydroxy group, or the like is also preferable.

Specific examples of the compound represented by formula (H) according to the invention are shown below.

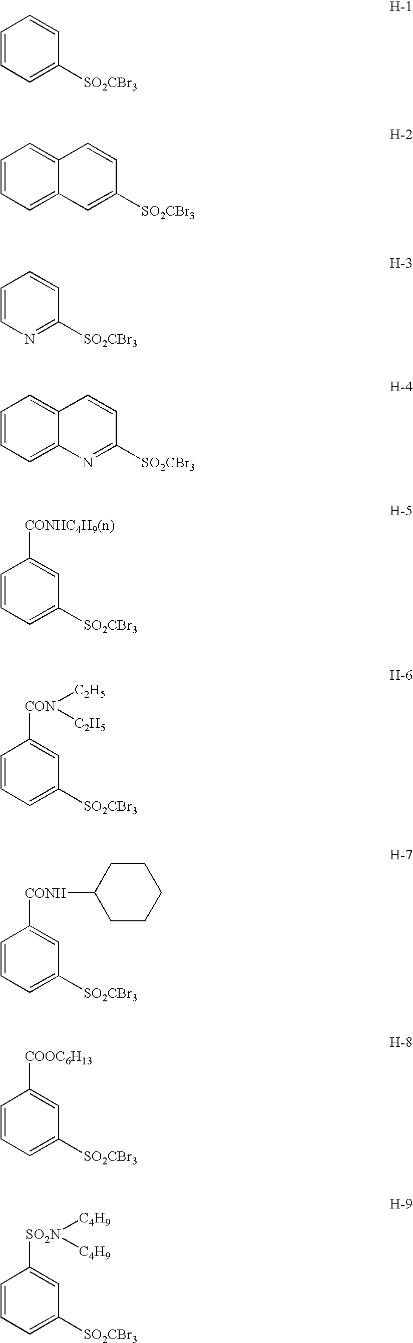

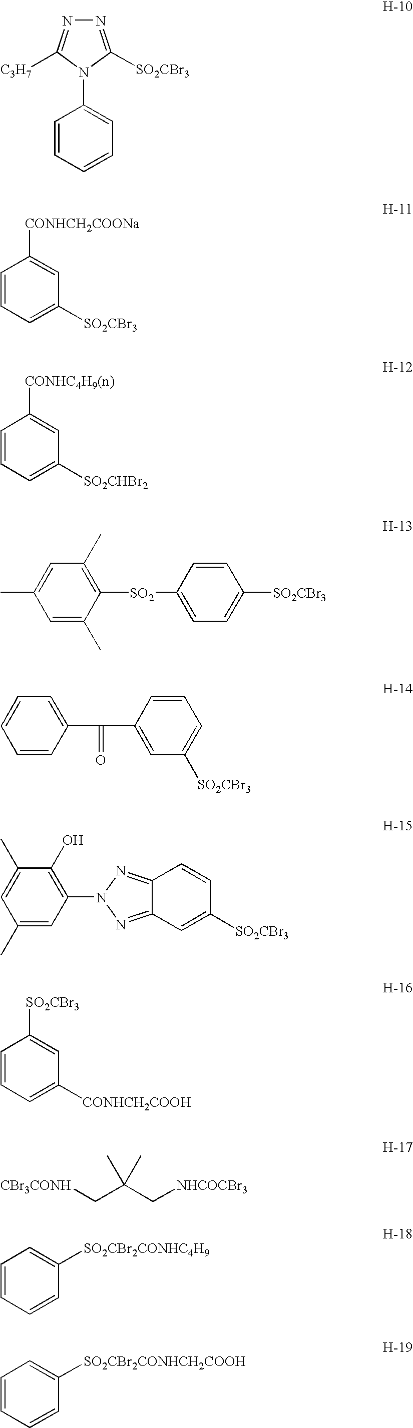

As preferred organic polyhalogen compounds which can be used in the present invention other than those above, there are mentioned compounds described as illustrated compounds of the relevant invention in the specifications of U.S. Pat. Nos. 3,874,946, 4,756,999, 5,340,712, 5,369,000, 5,464,737, and 6,506,548, and JP-A Nos. 50-137126, 50-89020, 50-119624, 59-57234, 7-2781, 7-5621, 9-160164, 9-244177, 9-244178, 9-160167, 9-319022, 9-258367, 9-265150, 10-197988, 10-197989, 11-242304, 2000-2963, 2000-112070, 2000-284410, 2000-284412, 2001-33911, 2001-31644, 2001-312027, and 2003-50441. Particularly, the compounds specifically illustrated in JP-A Nos. 7-2781, 2001-33911, and 2001-312027 are preferable.

The compound represented by formula (H) according to the invention is preferably used in an amount of from 10⁻⁴ mol to 1 mol, more preferably from 10⁻³ mol to 0.5 mol, and even more preferably from 1×10⁻² mol to 0.2 mol, per 1 mol of non-photosensitive silver salt incorporated in the image forming layer.

In the invention, methods which can be used for incorporating the antifoggant into the photothermographic material are those described above in the method for incorporating the reducing agent, and also for the organic polyhalogen compound, it is preferably added in the form of a solid fine particle dispersion.

2) Other Antifoggants

As other antifoggants, there are mentioned a mercury (II) salt described in paragraph number 0113 of JP-A No. 11-65021, benzoic acids described in paragraph number 0114 of the same literature, a salicylic acid derivative described in JP-A No. 2000-206642, a formalin scavenger compound represented by formula (S) in JP-A No. 2000-221634, a triazine compound related to Claim 9 of JP-A No. 11-352624, a compound represented by formula (III), 4-hydroxy-6-methyl-1,3,3a,7-tetrazaindene, described in JP-A No. 6-11791, and the like.

The photothermographic material of the invention may further contain an azolium salt in order to prevent fogging. Azolium salts useful in the present invention include a compound represented by formula (XI) described in JP-A No. 59-193447, a compound described in Japanese Patent Application Publication (JP-B) No. 55-12581, and a compound represented by formula (II) described in JP-A No. 60-153039. The azolium salt may be added to any part of the photothermographic material, but as the layer to be added, it is preferred to select a layer on the side having the image forming layer, and more preferred is to select the image forming layer itself. The azolium salt may be added at any time of the process of preparing the coating solution; in the case where the azolium salt is added into the image forming layer, any time of the process may be selected from the preparation of the organic silver salt to the preparation of the coating solution, but preferred is to add the azolium salt at the time after preparation of the organic silver salt and just prior to coating. As the method for adding the azolium salt, any method such as in the form of powder, a solution, a fine particle dispersion, or the like may be used.

Furthermore, the azolium salt may be added as a solution having mixed therein other additives such as a sensitizing agent, reducing agent, toner, or the like.

In the invention, the azolium salt may be added in any amount, but preferably, it is added in an amount of from 1×10⁻⁶ mol to 2 mol, and more preferably from 1×10⁻³ mol to 0.5 mol, per 1 mol of silver.

(Other Additives)

1) Mercapto Compounds, Disulfides, and Thiones

In the invention, mercapto compounds, disulfide compounds, and thione compounds can be added in order to control the development by suppressing or enhancing development, to improve spectral sensitization efficiency, and to improve storability before development and storability after development. Descriptions can be found in paragraph numbers 0067 to 0069 of JP-A No. 10-62899, as compounds represented by formula (I) of JP-A No. 10-186572 and specific examples thereof shown in paragraph numbers 0033 to 0052, and in lines 36 to 56 in page 20 of EP No. 803,764A 1. Among them, mercapto-substituted heterocyclic aromatic compounds described in JP-A Nos. 9-297367, 9-304875, 2001-100358, 2002-303954, 2002-303951, and the like are preferred.

2) Toner

In the photothermographic material of the present invention, addition of a toner is preferred. Description on the toner can be found in JP-A No. 10-62899 (paragraph numbers 0054 and 0055), EP No. 803,764A1 (page 21, lines 23 to 48), JP-A Nos. 2000-356317 and 2000-187298. Preferred are phthalazinones (phthalazinone, phthalazinone derivatives, or metal salts thereof; for example, 4-(1-naphthyl)phthalazinone, 6-chlorophthalazinone, 5,7-dimethoxyphthalazinone, and 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, and tetrachlorophthalic anhydride); phthalazines (phthalazine, phthalazine derivatives, or metal salts thereof; for example, 4-(1-naphthyl)phthalazine, 6-isopropylphthalazine, 6-tert-butylphthalazine, 6-chlorophthalazine, 5,7-dimethoxyphthalazine, and 2,3-dihydrophthalazine); and combinations of phthalazines and phthalic acids. Particularly preferred are combinations of phthalazines and phthalic acids. Among them, particularly preferable are the combination of 6-isopropylphthalazine and phthalic acid, and the combination of 6-isopropylphthalazine and 4-methylphthalic acid.

3) Plasticizer and Lubricant

In the invention, well-known plasticizer and lubricant can be used to improve physical properties of film. Particularly, to improve handling facility during manufacturing process or resistance to scratch during thermal development, it is preferred to use a lubricant such as liquid paraffin, a long chain fatty acid, an amide of a fatty acid, an ester of a fatty acid, or the like. Particularly preferred are liquid paraffin, in which components having a low boiling point are removed, and an ester of a fatty acid which has a branched structure and a molecular weight of 1000 or more.

Concerning plasticizers and lubricants usable in the image forming layer and in the non-photosensitive layer, compounds described in paragraph No. 0117 of JP-A No. 11-65021 and in JP-A Nos. 2000-5137, 2004-219794, 2004-219802, and 2004-334077 are preferable.

4) Dyes and Pigments

From the viewpoints of improving color tone, preventing the generation of interference fringes and preventing irradiation upon laser exposure, various dyes and pigments (for instance, C.I. Pigment Blue 60, C.I. Pigment Blue 64, and C.I. Pigment Blue 15:6) can be used in the image forming layer according to the invention. Detailed description can be found in WO No. 98/36322, JP-A Nos. 10-268465 and 11-338098, and the like.

5) Nucleator

Concerning the photothermographic material of the invention, it is preferred to add a nucleator into the image forming layer. Details on the nucleators, method for their addition, and addition amount can be found in paragraph No. 0118 of JP-A No. 11-65021, paragraph Nos. 0136 to 0193 of JP-A No. 11-223898, as compounds represented by formulae (H), (1) to (3), (A), or (B) in JP-A No. 2000-284399; as for a nucleation accelerator, description can be found in paragraph No. 0102 of JP-A No. 11-65021, and in paragraph Nos. 0194 and 0195 of JP-A No. 11-223898.

In the case of using formic acid or formates as a strong fogging agent, it is preferably incorporated into the side having the image forming layer containing a photosensitive silver halide in an amount of 5 mmol or less, and more preferably 1 mmol or less, per 1 mol of silver.

In the case of using a nucleator in the photothermographic material of the invention, it is preferred to use an acid obtained by hydration of diphosphorus pentaoxide, or a salt thereof in combination. Acids obtained by hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like. Particularly preferred acids obtained by hydration of diphosphorus pentaoxide or salts thereof include orthophosphoric acid (salt) and hexametaphosphoric acid (salt). Specific examples of the salt include sodium orthophosphate, sodium dihydrogen orthophosphate, sodium hexametaphosphate, ammonium hexametaphosphate, and the like.

The addition amount of the acid obtained by hydration of diphoshorus pentaoxide or the salt thereof (i.e., the coating amount per 1 m² of the photothermographic material) may be set as desired depending on sensitivity and fogging, but preferred is an amount of from 0.1 mg/m² to 500 mg/m², and more preferably from 0.5 mg/m² to 100 mg/m².

(Preparation of Coating Solution and Coating)

The temperature for preparing the coating solution for the image forming layer according to the invention is preferably from 30° C. to 65° C., more preferably 35° C. or higher and lower than 60° C., and even more preferably from 35° C. to 55° C. Furthermore, the temperature of the coating solution for the image forming layer immediately after adding the polymer latex is preferably maintained within the temperature range of from 30° C. to 65° C.

(Layer Constitution)

The constitution of each layer and preferable components thereof are described in detail.

Usually, photothermographic materials have one or more image forming layers constructed on a support. Further, photothermographic materials have a non-photosensitive layer in addition to the image forming layer.

Non-photosensitive layers can be classified depending on the layer arrangement into (a) a surface protective layer provided on the image forming layer (on the side farther from the support), (b) an intermediate layer provided among plural image forming layers or between the image forming layer and the surface protective layer, (c) an undercoat layer provided between the image forming layer and the support, and (d) a back layer which is provided on the opposite side of the support from the image forming layer. These layers may be each independently a single layer or plural layers.

1) Surface Protective Layer

The photothermographic material of the invention can comprise a surface protective layer with an object to prevent adhesion of the image forming layer, or the like. The surface protective layer may be a single layer or plural layers.

Description on the surface protective layer may be found in paragraph Nos. 0119 and 0120 of JP-A No. 11-65021 and in JP-A No. 2000-171936.

Preferred as the binder of the surface protective layer according to the invention is gelatin, but poly(vinyl alcohol) (PVA) is also preferably used instead, or in combination. As gelatin, there can be used inert gelatin (e.g., Nitta gelatin 750), phthalated gelatin (e.g., Nitta gelatin 801), and the like. Usable as PVA are those described in paragraph Nos. 0009 to 0020 of JP-A No. 2000-171936, and preferred are the completely saponified product PVA-105, the partially saponified product PVA-205 and PVA-335, as well as modified poly(vinyl alcohol) MP-203 (all of them are trade names of products from Kuraray Ltd.), and the like. The amount of coated poly(vinyl alcohol) (per 1 m² of support) in the surface protective layer (per one layer) is preferably in a range of from 0.3 g/m² to 4.0 g/m², and more preferably from 0.3 g/m² to 2.0 g/m².

The total amount of the coated binder (including water-soluble polymer and latex polymer) (per 1 m² of support) in the surface protective layer (per one layer) is preferably in a range of from 0.3 g/m² to 5.0 g/m², and more preferably from 0.3 g/m² to 2.0 g/m².

Further, it is preferable to use a lubricant such as liquid paraffin, an ester of a fatty acid, or the like in the surface protective layer. The addition amount of the lubricant is in the range of from 1 mg/m² to 200 mg/m², preferably from 10 mg/m² to 150 mg/m², and more preferably from 20 mg/m² to 100 mg/m².

2) Antihalation Layer

The photothermographic material of the present invention can comprise an antihalation layer provided to the side farther from the light source than the image forming layer.

Descriptions on the antihalation layer can be found in paragraph Nos. 0123 and 0124 of JP-A No. 11-65021, in JP-A Nos. 11-223898, 9-230531, 10-36695, 10-104779, 11-231457, 11-352625, 11-352626, and the like.

The antihalation layer contains an antihalation dye having its absorption at the wavelength of the exposure light. In the case where the exposure wavelength is in the infrared region, it is enough that an infrared-absorbing dye is used, and in such a case, preferred are dyes having no absorption in the visible light region.

In the case of preventing halation from occurring by using a dye having absorption in the visible light region, it is preferred that the color of the dye would not substantially reside after image formation, and is preferred to employ a means for bleaching color by the heat of thermal development; in particular, it is preferred to add a thermal bleaching dye and a base precursor to the non-photosensitive layer to impart function as an antihalation layer. Those techniques are described in JP-A No. 11-231457 and the like.

The addition amount of the thermal bleaching dye is determined depending on the usage of the dye. In general, it is used at an amount as such that the optical density (absorbance) exceeds 0.1 when measured at the desired wavelength. The optical density is preferably in a range of from 0.15 to 2, and more preferably from 0.2 to 1. The addition amount of the dye to obtain optical density in the above range is generally from 0.001 g/m² to 1 g/m².

By decoloring the dye in such a manner, the optical density after thermal development can be lowered to 0.1 or lower. Two or more thermal bleaching dyes may be used in combination in a thermal bleaching type recording material or in a photothermographic material. Similarly, two or more base precursors may be used in combination.

In the case of thermal decolorization by the combined use of a bleaching dye and a base precursor, it is preferable from the viewpoints of thermal decoloring property or the like to further use a substance lowering the melting point by at least 3° C. when mixed with the base precursor (e.g., diphenylsulfone, 4-chlorophenyl(phenyl)sulfone, 2-naphthylbenzoate, or the like) as described in JP-A No. 11-352626.

3) Non-Photosensitive Intermediate Layer

The photothermographic material of the present invention has preferably a non-photosensitive intermediate layer between the surface protective layer and the image forming layer.

Preferably, 50% by weight or more of the binder for the non-photosensitive intermediate layer according to the invention is a polymer latex.

The intermediate layer which includes the aqueous dispersion of hydrophobic polymer used in the present invention in an amount of 50% or more is explained.

(1) Intermediate Layer Including Aqueous Dispersion of Hydrophobic Polymer in an Amount of 50% or More

In the present invention, the binder of at least one non-photosensitive intermediate layer contains an aqueous dispersion of hydrophobic polymer in an amount of 50% by weight or more, preferably in a range of from 60% by weight to 100% by weight, and more preferably from 65% by weight to 90% by weight. When the amount is less than 50% by weight, it is not preferred because the effect of improving image storability is reduced.

In the present invention, the aqueous dispersion of hydrophobic polymer may be a latex in which water-insoluble fine particles of hydrophobic polymer are dispersed in an aqueous solvent or such in which polymer molecules are dispersed in molecular states or by forming micelles, but preferred are latex-dispersed particles.

A mean particle size of the dispersed particles is in a range of from 1 nm to 50000 nm, preferably from 5 nm to 1000 nm, more preferably from 10 nm to 500 nm, and even more preferably from 50 nm to 200 nm. There is no particular limitation concerning particle size distribution of the dispersed particles, and the particles may be widely distributed or may exhibit a monodispersed particle size distribution. From the viewpoint of controlling the physical properties of the coating solution, preferred mode of usage includes mixing two or more types of particles each having monodispersed particle distribution.

In the invention, there is no particular limitation concerning the hydrophobic binder, but hydrophobic polymers such as acrylic polymers, polyesters, rubbers (e.g., SBR resin), polyurethanes, poly(vinyl chlorides), poly(vinyl acetates), poly(vinylidene chlorides), polyolefins, or the like can be preferably used. As the polymers above, usable are straight-chain polymers, branched polymers, or crosslinked polymers; also usable are the so-called homopolymers in which one type of monomer is polymerized, or copolymers in which two or more types of monomers are polymerized. In the case of a copolymer, it may be a random copolymer or a block copolymer. The molecular weight of the polymer is, in number average molecular weight, in a range of from 5,000 to 1,000,000, and preferably from 10,000 to 200,000. Those having too small molecular weight exhibit insufficient mechanical strength on forming the image forming layer, and those having too large molecular weight are also not preferred because the resulting film-forming properties are poor. Further, crosslinking polymer latexes are particularly preferred for use.

The glass transition temperature (Tg) of the hydrophobic polymer according to the present invention is preferably in a range of from −30° C. to 70° C., more preferably from −10° C. to 35° C., and most preferably from 0° C. to 35° C. In a case where Tg is lower than −30° C., film-forming property is excellent, but the formed film is poor in heat resistant strength. In a case where Tg is higher than 70° C., heat resistant strength of the polymer is excellent, but film-forming property is not enough to perform film coating. However, it is possible to use two or more polymers to make Tg fall in the above range. Namely, even if a polymer has a Tg outside the above range, it is preferred that the weight-average Tg thereof is in the range mentioned above.

The I/O value of the hydrophobic polymer is preferably in a range of from 0.025 to 0.5, and more preferably from 0.05 to 0.3. The I/O value used herein means a value of an inorganic value divided by an organic value based on an organic conceptual diagram. In a case where the I/O value is smaller than 0.025, hydrophilicity with respect to the aqueous solvent is so poor that it becomes difficult to perform coating using an aqueous coating solution. In a case where the value is greater than 0.5, the formed film is so hydrophilic that the film may give unfavorable effects on photographic performance against moisture, photographic properties are extremely deteriorated, and therefore it is not preferred. The I/O value can be calculated by a method described in “Yuuki Gainen Zu—Kiso To Oyo—(Organic Conceptual Diagram—Fundamentals and Applications—)”, written by Yoshio Kohda, published by Sankyo Shuppan (1984).

Here, the organic conceptual diagram is to indicate the entire organic compounds at each position on the orthogonal coordinate whose axes indicate, respectively, the organic axis and the inorganic axis, where the characteristics of the compounds are categorized into an organic value representing a covalent bond tendency and an inorganic value representing an ionic bond tendency. The inorganic value based on this diagram is determined with respect to inorganic property or the magnitude of affecting force to the boiling point by various substituents on a basis of hydroxy group, and is a value in which an affecting force per hydroxy group is defined taken as 100 in numerical, since it is about 100° C. when a distance between the boiling point curve of a straight chain alcohol and the boiling point curve of a straight chain paraffin is taken around a carbon atom number of five. In a meantime, the organic value is determined based on that the number of carbon atoms representing the methylene group where each methylene group in the molecule is treated as a unit can measure the magnitude of the number of the organic value. The organic value is set with a standard in which a single piece number of the carbon atom number as the basis is determined as 20 from the average boiling point increase of 20° C. caused by one carbon atom addition to the straight chain compound having around 5 to 10 carbon atoms. The inorganic value and the organic value are set to correspond one to one on the graph. The I/O value is calculated from those values.

More preferable as the binder of the non-photosensitive intermediate layer according to the present invention is a polymer which is obtained by copolymerizing the monomer component represented by formula (M).

In the binder of the non-photosensitive intermediate layer, the content of the polymer which is obtained by copolymerizing the monomer represented by formula (M) is preferably 60% by weight or higher, more preferably in a range of from 65% by weight to 100% by weight, and even more preferably from 90% by weight to 100% by weight.

CH₂═CR⁰¹—CR⁰²═CH₂ Formula (M)

In the formula, R^{01 and R}⁰² each independently represent a hydrogen atom, an alkyl group having 1 to 6 carbon atoms, a halogen atom, or a cyano group.

As the alkyl group for R⁰¹ or R⁰², an alkyl group having 1 to 4 carbon atoms is preferred, and more preferred is an alkyl group having one or two carbon atoms. As the halogen atom for R⁰¹ or R⁰², a fluorine atom, a chlorine atom, and a bromine atom are preferred, and more preferred is a chlorine atom.

Particularly preferably, both of R⁰¹ and R⁰² represent a hydrogen atom, or one of R⁰¹ and R⁰² represents a hydrogen atom and the other represents a methyl group or a chlorine atom.

Specific examples of the monomer represented by formula (M) according to the present invention include 1,3-butadiene, 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

In the invention, the other monomers, which are capable to copolymerize with the monomer represented by formula (M), are not particularly restricted, and any monomers may be preferably used provided that they are polymerizable by usual radical polymerization or ion polymerization.

Concerning the monomer which can be used preferably, it is capable to select the combination independently and freely from the monomer groups (a) to (j) described below.

—Monomer Groups (a) to (j)—

(a) conjugated dienes: 1,3-butadiene, 1,3-pentadiene, 1-phenyl-1,3-butadiene, 1-α-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene, and the like;

(b) olefins: ethylene, propylene, vinyl chloride, vinylidene chloride, 6-hydroxy-1-hexene, 4-pentenoic acid, methyl 8-nonenate, vinylsulfonic acid, trimethylvinylsilane, trimethoxyvinylsilane, 1,4-divinylcyclohexane, 1,2,5-trivinylcyclohexane, and the like;

(c) α,β-unsaturated carboxylic acid and salts thereof: acrylic acid, methacrylic acid, itaconic acid, maleic acid, sodium acrylate, ammonium methacrylate, potassium itaconate, and the like;

(d) α,β-unsaturated carboxylic acid esters: alkyl acrylate (for example, methyl acrylate, ethyl acrylate, butyl acrylate, cyclohexyl acrylate, 2-ethylhexyl acrylate, dodecyl acrylate, and the like), substituted alkyl acrylate (for example, 2-chloroethyl acrylate, benzyl acrylate, 2-cyanoethyl acrylate, and the like), alkyl methacrylate (for example, methyl methacrylate, butyl methacrylate, 2-ethylhexyl methacrylate, dodecyl methacrylate, and the like), substituted alkyl methacrylate (for example, 2-hydroxyethyl methacrylate, glycidyl methacrylate, glycerine monomethacrylate, 2-acetoxyethyl methacrylate, tetrahydrofurfuryl methacrylate, 2-methoxyethyl methacrylate, polypropylene glycol monomethacrylate (which has an addition mole number of polyoxypropylene of from 2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, 2-isocyanatoethyl methacrylate, and the like), derivatives of unsaturated dicarboxylic acid (for example, monobutyl maleate, dimethyl maleate, monomethyl itaconate, dibutyl itaconate, and the like), and polyfunctional esters (for example, ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate, and the like);

(e) amides of β-unsaturated carboxylic acid: for example, acrylamide, methacrylamide, N-methylacrylamide, N,N-dimethylacrylamide, N-methyl-N-hydroxyethyl methacrylamide, N-tert-butylacrylamide, N-tert-octyl methacrylamide, N-cyclohexylacrylamide, N-phenylacrylamide, N-(2-acetoacetoxyethyl)acrylamide, N-acryloyl morpholine, diacetone acrylamide, diamido itaconate, N-methyl maleimide, 2-acrylamido-methylpropanesulfonic acid, methylenebisacrylamide, dimethacryloyl piperazine, and the like;

(f) unsaturated nitriles: acrylonitrile, methacrylonitrile, and the like;

(g) styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, and the like;

(h) vinyl ethers: methyl vinyl ether, butyl vinyl ether, methoxyethyl vinyl ether, and the like;

(i) vinyl esters: vinyl acetate, vinyl propionate, vinyl benzoate, vinyl salicylate, vinyl chloroacetate, and the like; and

(j) other polymerizable monomers: N-vinylimidazole, 4-vinylpyridine, N-vinylpyrrolidone, 2-vinyloxazoline, 2-isopropenylozazoline, divinylsulfone, and the like.

Preferable is a copolymer with styrene, acrylic acid, and/or acrylic ester.

More preferable is a copolymer containing styrene and acrylic acid as the monomer units, since the resulting hydrophobic polymer can be used in the form of an aqueous dispersion having good dispersion stability.

There is no particular restriction concerning the copolymerization ratio of the monomer represented by formula (M) and other monomer, but preferred is the case where the monomer represented by formula (M) is copolymerized within a range of from 10% by weight to 70% by weight, more preferably from 15% by weight to 65% by weight, and even more preferably from 20% by weight to 60% by weight.

<<Specific Examples of Hydrophobic Polymer>>

Specific examples of preferred hydrophobic polymer are given below, which are expressed by the starting monomers with % by weight given in parenthesis. The molecular weight is given in number average molecular weight. In the case where polyfunctional monomer is used, the concept of molecular weight is not applicable because they build a crosslinked structure. Hence, they are denoted as “crosslinking”, and the description of the molecular weight is omitted. Tg represents a glass transition temperature.

LP-1; latex of -MMA(55) -EA(42) -MAA(3)—(Tg: 39° C., I/O value: 0.636)

LP-2; latex of -MMA(47) -EA(50) -MAA(3)—(Tg: 29° C., I/O value: 0.636)

LP-3; latex of -MMA(17) -EA(80) -MAA(3)—(Tg: −4° C., I/O value: 0.636)

LP-4; latex of -EA(97) -MAA(3)—(Tg: −20° C., I/O value: 0.636)

LP-5; latex of -EA(97) -AA(3)—(Tg: −21° C., I/O value: 0.648)

LP-6; latex of -EA(90) -AA(10)—(Tg: −15° C., I/O value: 0.761)

LP-7; latex of -MMA(50) -2EHA(35) -St(10) -AA(5)—(Tg: 34° C., I/O value: 0.461)

LP-8; latex of -MMA(30) -2EHA(55) -St(10) -AA(5)—(Tg: 3° C., I/O value: 0.398)

LP-9; latex of -MMA(10) -2EHA(75) -St(10) -AA(5)—(Tg: −23° C., I/O value: 0.339)

LP-10; latex of -MMA(60) -BA(36) -AA(4)—(Tg: 29° C., I/O value: 0.581)

LP-11; latex of -MMA(40) -BA(56) -AA(4)—(Tg: −2° C., I/O value: 0.545)

LP-12; latex of -MMA(25) -BA(71) -AA(4)—(Tg: −22° C., I/O value: 0.519)

LP-13; latex of -MMA(42) -BA(56) -AA(2)—(molecular weight: 540,000, Tg: −4° C., I/O value: 0.530)

LP-14; latex of -St(40) -BA(55) -AA(5)—(Tg: −2° C., I/O value: 0.319)

LP-15; latex of -St(25) -BA(70) -AA(5)—(Tg: −21° C., I/O value: 0.377)

LP-16; latex of -MMA(58) -St(8) -BA(32) -AA(2)—(Tg: 34° C., I/O value: 0.515)

LP-17; latex of -MMA(50) -St(8) -BA(35) -HEMA(5) -AA(2)—(Tg: 27° C., I/O value: 0.542)

LP-18; latex of -MMA(42) -St(8) -BA(43) -HEMA(5) -AA(2)—(Tg: 14° C., I/O value: 0.528)

LP-19; latex of -MMA(24) -St(8) -BA(61) -HEMA(5) -AA(2)—(Tg: −12° C., I/O value: 0.498)

LP-20; latex of -MMA(48) -St(8) -BA(27) -HEMA(15) -AA(2)—(Tg: 39° C., I/O value: 0.619)

LP-21; latex of -EA(96) -AA(4)—(Tg: −21° C., I/O value: 0.664)

LP-22; latex of -EA(46) -MA(50) -AA(4)—(Tg: −4° C., I/O value: 0.739)

LP-23; latex of -EA(80) -HEMA(16) -AA(4)—(Tg: −9° C., I/O value: 0.775)

LP-24; latex of -EA(86) -HEMA(10) -AA(4)—(Tg: −13° C., I/O value: 0.733)

LP-25; latex of -St(45) -Bu(52) -MAA(3)—(Tg: −26° C., I/O value: 0.990)

LP-26; latex of -St(55) -Bu(42) -MAA(3)—(Tg: −9° C., I/O value: 0.105)

LP-27; latex of -St(60) -Bu(37) -MAA(3)—(Tg: 1° C., I/O value: 0.109)

LP-28; latex of -St(68) -Bu(29) -MAA(3)—(Tg: 17° C., I/O value: 0.114)

LP-29; latex of -St(75) -Bu(22) -MAA(3)—(Tg: 34° C., I/O value: 0.119)

LP-30; latex of -St(40) -BA(58) -AA(2)—(Tg: −8.1° C., I/O value: 0.293)

LP-31; latex of -St(40) -BA(58) -MAA(2)—(Tg: −7.1° C., I/O value: 0.287)

LP-32; latex of -St(57.2) -BA(27.7) -MMA(8.7) -HEMA(4.8) -AA(1.6)—(Tg: 37.8° C., I/O value: 0.269)

LP-33; latex of -St(49.6) -BA(40) -MMA(4) -HEMA(4.8) -AA(1.6)—(Tg: 16.7° C., I/O value: 0.289)

LP-34; latex of -St(80) -2EHA(18) -AA(2)—(Tg: 59.7° C., I/O value: 0.148)

LP-35; latex of -St(70) -2EHA(28) -AA(2)—(Tg: 40.9° C., I/O value: 0.164)

LP-36; latex of -St(10) -2EHA(38) -MMA(50) -AA(2)—(Tg: 25.6° C., I/O value: 0.427)

LP-37; latex of -St(10) -2EHA(58) -MMA(30) -AA(2)—(Tg: −3.9° C., I/O value: 0.365)

LP-38; latex of -St(10) -2EHA(78) -MMA(10) -AA(2)—(Tg: −28.1° C., I/O value: 0.308)

LP-39; latex of -St(20) -2EHA(68) -MMA(10) -AA(2)—(Tg: −16.8° C., I/O value: 0.285)

LP-40; latex of -St(30) -2EHA(58) -MMA(10) -AA(2)—(Tg: −4.4° C., I/O value: 0.263)

LP-41; latex of -MMA(45) -BA(52) -IA(3)—(Tg: 4° C., I/O value: 0.560)

LP-42; latex of -St(62) -Bu(35) -MAA(3)—(crosslinking, Tg: 5° C.)

LP-43; latex of -St(68) -Bu(29) -AA(3)—(crosslinking, Tg: 17° C.)

LP-44; latex of -St(71) -Bu(26) -AA(3)—(crosslinking, Tg: 24° C.)

LP-45; latex of -St(70) -Bu(27) -IA(3)—(crosslinking, Tg: 23° C.)

LP-46; latex of -St(75) -Bu(24) -AA(1)—(crosslinking, Tg: 29° C.)

LP-47; latex of -St(60) -Bu(35) -DVB(3) -MAA(2)—(crosslinking, Tg: 6° C.)

LP-48; latex of -St(70) -Bu(25) -DVB(2) -AA(3)—(crosslinking, Tg: 26° C.)

LP-49; latex of -St(70.5) -Bu(26.5) -AA(3)—(crosslinking, Tg: 23° C.)

LP-50; latex of -St(69.5) -Bu(27.5) -AA(3)—(crosslinking, Tg: 20.5° C.)

LP-51; latex of -St(61.3) -Isoprene(35.5) -AA(3)—(crosslinking, Tg: 17° C.)

LP-52; latex of -St(67) -Isoprene(28) -Bu(2) -AA(3)—(crosslinking, Tg: 27° C.)

In the structures above, abbreviations represent monomers as follows. MMA: methyl methacrylate, EA: ethyl acrylate, MA: methyl acrylate, MAA: methacrylic acid, 2EHA: 2-ethylhexyl acrylate, HEMA: hydroxyethyl methacrylate, St: styrene, Bu: butadiene, AA: acrylic acid, DVB: divinyl benzene, IA: itaconic acid, and BA: butyl acrylate.

The aqueous dispersions of hydrophobic polymer described above are commercially available, and polymers below can be used. Examples of acrylic polymers include Cevian A-4635, 4718, and 4601 (all manufactured by Daicel Chemical Industries, Ltd.), Nipol Lx811, 814, 821, 820, and 857 (all manufactured by Nippon Zeon Co., Ltd.), and the like; examples of polyesters include FINETEX ES650, 611, 675, and 850 (all manufactured by Dainippon Ink and Chemicals, Inc.), WD-size and WMS (all manufactured by Eastman Chemical Co.), and the like; examples of polyurethanes include HYDRAN AP10, 20, 30, and 40 (all manufactured by Dainippon Ink and Chemicals, Inc.), and the like; examples of rubbers include LACSTAR 7310K, 3307B, 4700H, and 7132C (all manufactured by Dainippon Ink and Chemicals, Inc.), Nipol Lx416, 410, 438C, and 2507 (all manufactured by Nippon Zeon Co., Ltd.), and the like; examples of poly(vinyl chlorides) include G351 and G576 (all manufactured by Nippon Zeon Co., Ltd.), and the like; examples of poly(vinylidene chlorides) include L502 and L513 (all manufactured by Asahi Chemical Industry Co., Ltd.), and the like; and examples of polyolefins include Chemipearl S120 and SA100 (all manufactured by Mitsui Petrochemical Industries, Ltd.), and the like.

As the latex of styrene-butadiene copolymer preferably used in the invention, there can be mentioned the above-described LP-42 to LP-50, or commercially available LACSTAR 3307B, LACSTAR 7132C (all manufactured by Dainippon Ink and Chemicals, Inc.), Nipol Lx416 (manufactured by Nippon Zeon Co., Ltd.), and the like.

As the latex of styrene-isoprene copolymer preferably used in the invention, there can be mentioned the above-described LP-51, LP-52, and the like.

The aqueous dispersion of hydrophobic polymer may be used alone, or may be used by blending two or more of them depending on needs.

<<Preferable Aqueous Dispersion of Hydrophobic Polymer>>

Concerning the aqueous dispersion of hydrophobic polymer used for the present invention, the composition thereof is not particularly limited, but the one which falls within the ranges of Tg and I/O value according to the present invention is preferred.

<<Binder which can be Used in Combination>>

In the non-photosensitive intermediate layer according to the present invention, if necessary, there can be added hydrophilic polymers such as gelatin, poly(vinyl alcohol), methyl cellulose, hydroxypropyl cellulose, carboxymethyl cellulose, or the like.

<<Auxiliary Film-Forming Agent which can be Used in Combination>>

To control the minimum film-forming temperature of the aqueous dispersion of hydrophobic polymer, an auxiliary film-forming agent may be added. The auxiliary film-forming agent is also called a plasticizer and is an organic compound (usually an organic solvent) which makes the minimum film-forming temperature of polymer latex decrease, and for instance, is described in the above “GOUSEI LATEX NO KAGAKU” (Soichi Muroi, published by Kobunshi Kankokai (1970)). Preferred auxiliary film-forming agents are the following compounds, but the compound which can be used in the present invention is not limited to the following specific examples.

Z-1; Benzyl alcohol

Z-2; 2,2,4-Trimethyl-1,3-pentanediol monoisobutyrate

Z-3; 2-Dimethylaminoethanol

Z-4; Diethylene glycol

<<Addition Amount>>

The content of the hydrophobic polymer is preferably in a range of from 5% by weight to 50% by weight, and more preferably from 10% by weight to 40% by weight, with respect to the entire coating solution for the non-photosensitive intermediate layer.

<<Coating Amount>>

The coating amount of the hydrophobic polymer for the non-photosensitive intermediate layer is preferably in a range of from 0.1 g/m² to 10 g/m², more preferably from 0.3 g/m² to 7 g/m², and most preferably from 0.5 g/m² to 5 g/m².

4) Back Layer

Back layers which can be used in the invention are described in paragraph Nos. 0128 to 0130 of JP-A No. 11-65021.

In the invention, coloring matters having maximum absorption in the wavelength range from 300 nm to 450 nm can be added in order to improve color tone of developed silver images and deterioration of the images during aging. Such coloring matters are described in, for example, JP-A Nos. 62-210458, 63-104046, 63-103235, 63-208846, 63-306436, 63-314535, 01-61745, 2001-100363, and the like.

Such coloring matters are generally added in a range of from 0.1 mg/m² to 1 g/m², preferably to the back layer which is provided on the opposite side of the support from the image forming layer.

Further, in order to control the basic color tone, it is preferred to use a dye having an absorption peak in a wavelength range from 580 nm to 680 nm. As a dye satisfying this purpose, preferred are oil-soluble azomethine dyes described in JP-A Nos. 4-359967 and 4-359968, or water-soluble phthalocyanine dyes described in JP-A No. 2003-295388, which have low absorption intensity on the short wavelength side. The dyes for this purpose may be added to any of the layers, but more preferred is to add them in the image forming layer or non-photosensitive layer on the image forming layer side, or on the backside.

The photothermographic material of the invention is preferably a so-called one-side photosensitive material, which comprises at least one image forming layer containing silver halide emulsion on one side of the support, and a back layer on the other side.

Concerning the layer constitution of the back layer, it is constituted of two layers including a layer containing a dye and a protective layer, but such as described in JP-A No. 2006-189508, it is preferred to dispose further an undercoat layer between the layer containing a dye and the support in order to improve coating ability. It is preferred that these two or three layers are simultaneously coated and dried.

5) Matting Agent

A matting agent is preferably added to the photothermographic material of the invention in order to improve transportability. Description on the matting agent can be found in paragraphs Nos. 0126 and 0127 of JP-A No. 11-65021. The addition amount of the matting agent is preferably in a range of from 1 mg/m² to 400 mg/m², and more preferably from 5 mg/m² to 300 mg/m², when expressed by the coating amount per 1 m² of the photothermographic material.

In the invention, the shape of the matting agent may be a fixed form or non-fixed form, but preferred is to use those having a fixed form and a spherical shape.

The volume-weighted mean equivalent spherical diameter of the matting agent used in the image forming layer surface is preferably in a range of from 0.3 μm to 10 μm, and more preferably, from 0.5 μm to 7 μm. Further, the particle distribution of the matting agent is preferably set as such that the variation coefficient is from 5% to 80%, and more preferably from 20% to 80%. Herein, the variation coefficient is defined by (the standard deviation of particle diameter)/(mean diameter of the particle)×100. Furthermore, two or more types of matting agents having different mean particle size can be used in the image forming layer surface. In this case, the difference between the mean particle size of the biggest matting agent and the mean particle size of the smallest matting agent is preferably from 2 μm to 8 μm, and more preferably from 2 μm to 6 μm.

Volume weighted mean equivalent spherical diameter of the matting agent used in the back surface is preferably in a range of from 1 μm to 15 μm, and more preferably, from 3 μm to 10 μm. Further, the particle distribution of the matting agent is preferably set as such that the variation coefficient is from 3% to 50%, and more preferably from 5% to 30%. Furthermore, two or more types of matting agents having different mean particle size can be used in the back surface. In this case, the difference between the mean particle size of the biggest matting agent and the mean particle size of the smallest matting agent is preferably from 2 μm to 14 μm, and more preferably from 2 μm to 9 μm.

The level of matting on the image forming layer surface is not restricted as long as star-dust trouble does not occur, but the level of matting is preferably from 30 sec to 2000 sec, and particularly preferably from 40 sec to 1500 sec, when expressed by a Beck's smoothness. Beck's smoothness can be calculated easily, using Japan Industrial Standard (JIS) P8119 “The method of testing Beck's smoothness for papers and sheets using a Beck's test apparatus”, or TAPPI standard method T479.

In the invention, the level of matting of the back layer is preferably in a range of 1200 sec or less and 10 sec or more; more preferably, 800 sec or less and 20 sec or more; and even more preferably, 500 sec or less and 40 sec or more, when expressed by a Beck's smoothness.

In the present invention, a matting agent is preferably contained in an outermost layer of the photothermographic material, in a layer which functions as an outermost layer, or in a layer nearer to outer surface, and is also preferably contained in a layer which functions as a so-called protective layer.

6) Hardener

A hardener may be used in each of the image forming layer, protective layer, back layer, and the like according to the invention. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylenebis(vinylsulfonacetamide), and N,N-propylenebis(vinylsulfonacetamide), polyvalent metal ions described in page 78 of the above literature and the like, polyisocyanates described in U.S. Pat. No. 4,281,060, JP-A No. 6-208193, and the like, epoxy compounds of U.S. Pat. No. 4,791,042 and the like, and vinylsulfone compounds of JP-A No. 62-89048 and the like.

The hardener is added as a solution, and this solution is added to the coating solution for the protective layer at the time from 180 minutes before coating to just before coating, and preferably at the time from 60 minutes before coating to 10 seconds before coating. However, so long as the effects of the invention are sufficiently realized, there is no particular restriction concerning the mixing method and the conditions of mixing. As specific mixing methods, there can be mentioned a method of mixing in the tank, in which the average stay time calculated from the flow rate of addition and the feed rate to the coater is controlled to yield a desired time, a method using static mixer such as described in Chapter 8 of N. Harnby, M. F. Edwards, and A. W. Nienow (translated by Koji Takahashi) “Ekitai Kongo Gijutu (Liquid Mixing Technology)” (Nikkan Kogyo Shinbunsha, 1989), and the like.

7) Antistatic Agent

The photothermographic material of the invention preferably has an antistatic layer including metal oxides or electrically conductive polymer. The antistatic layer may serve as an undercoat layer, a back surface protective layer, or the like, but can also be placed specially. As an electrically conductive material of the antistatic layer, metal oxides having enhanced electric conductivity by the method of introducing oxygen defects or different types of metallic atoms into the metal oxides are preferable for use. Examples of the metal oxide preferably include ZnO, TiO₂, and SnO₂; and the addition of Al, or In with respect to ZnO, the addition of Sb, Nb, P, halogen element, or the like with respect to SnO₂, and the addition of Nb, Ta, or the like with respect to TiO₂ are preferred.

Particularly preferred for use is SnO₂ combined with Sb. The addition amount of heteroatom is preferably in a range of from 0.01 mol % to 30 mol %, and more preferably in a range of from 0.1 mol % to 10 mol %. The shape of the metal oxide includes, for example, spherical, needle-like, or tabular shape. Needle-like particle, in which a ratio of (the major axis)/(the minor axis) is 2.0 or higher, and more preferably from 3.0 to 50, is preferred viewed from the standpoint of the electric conductivity effect. The metal oxide is preferably used in a range of from 1 mg/m² to 1000 mg/m², more preferably from 10 mg/m² to 500 mg/m², and even more preferably from 20 mg/m² to 200 mg/m². The antistatic layer according to the invention may be disposed on either side of the image forming layer side or the backside, but it is preferred to set between the support and the back layer. Specific examples of the antistatic layer according to the invention are described in paragraph Nos. 0135 of JP-A No. 11-65021, in JP-A Nos. 56-143430, 56-143431, 58-62646, and 56-120519, and in paragraph Nos. 0040 to 0051 of JP-A No. 11-84573, in U.S. Pat. No. 5,575,957, and in paragraph Nos. 0078 to 0084 of JP-A No. 11-223898.

8) Support

As the transparent support, preferably used is polyester, particularly, polyethylene terephthalate, which is subjected to heat treatment in the temperature range of from 130° C. to 185° C. in order to relax the internal strain which is caused by biaxial stretching and remaining inside the film, and to remove strain ascribed to heat shrinkage generated during thermal development. In the case of a photothermographic material for medical use, the transparent support may be colored with a blue dye (for instance, dye-1 described in the Example of JP-A No. 8-240877), or may be uncolored. Concerning the support, it is preferred to apply undercoating technology such as water-soluble polyester described in JP-A No. 11-84574, a styrene-butadiene copolymer described in JP-A No. 10-186565, a vinylidene chloride copolymer described in JP-A No. 2000-39684, or the like. The moisture content of the support is preferably 0.5% by weight or lower, when coating for the image forming layer or back layer is conducted on the support.

9) Other Additives

Furthermore, an antioxidant, stabilizer, plasticizer, ultraviolet absorber, or film-forming promoting agent may be added to the photothermographic material. Each of the additives is added to either of the image forming layer or the non-photosensitive layer. Reference can be made to WO No. 98/36322, EP No. 803,764A1, JP-A Nos. 10-186567 and 10-18568, and the like.

(Coating Method)

The photothermographic material of the invention may be coated by any method. Specifically, various types of coating operations including extrusion coating, slide coating, curtain coating, immersion coating, knife coating, flow coating, or an extrusion coating using the type of hopper described in U.S. Pat. No. 2,681,294 are used. Preferably used is slide coating or extrusion coating described in pages 399 to 536 of Stephen F. Kistler and Petert M. Schweizer, “LIQUID FILM COATING” (Chapman & Hall, 1997), and particularly preferably used is slide coating. An example of the shape of the slide coater for use in slide coating is shown in FIG. 11b.1, page 427, of the same literature. If desired, two or more layers can be coated simultaneously by the method described in pages 399 to 536 of the same literature or by the method described in U.S. Pat. No. 2,761,791 and British Patent No. 837,095. Particularly preferable coating method in the invention is the method described in JP-A Nos. 2001-194748, 2002-153808, 2002-153803, and 2002-182333.

The coating solution for the image forming layer according to the invention is preferably a so-called thixotropic fluid. For the details of this technology, reference can be made to JP-A No. 11-52509. Viscosity of the coating solution for the image forming layer according to the invention at a shear velocity of 0.1 S⁻¹ is preferably from 400 mPa·s to 100,000 mPa·s, and more preferably from 500 mPa·s to 20,000 mPa·s. At a shear velocity of 100 S⁻¹, the viscosity is preferably from 1 mPa·s to 200 mPa·s, and more preferably from 5 mPa·s to 80 mPa·s.

In the case of mixing two types of liquids on preparing the coating solution used for the invention, known in-line mixer or in-plant mixer is preferably used. Preferred in-line mixer used for the invention is described in JP-A No. 2002-85948, and preferred in-plant mixer used for the invention is described in JP-A No. 2002-90940.

The coating solution according to the invention is preferably subjected to antifoaming treatment to maintain the coated surface in a good state. Preferred method for antifoaming treatment in the invention is described in JP-A No. 2002-66431.

In the case of applying the coating solution according to the invention to the support, it is preferred to perform diselectrification in order to prevent adhesion of dust, particulates, and the like due to charging of the support. Preferred example of the method of diselectrification for use in the invention is described in JP-A No. 2002-143747.

Since a non-setting coating solution is used for the image forming layer in the invention, it is important to precisely control the drying air and the drying temperature. Preferred drying method for use in the invention is described in detail in JP-A Nos. 2001-194749 and 2002-139814.

In order to improve film-forming properties in the photothermographic material of the invention, it is preferred to apply heat treatment immediately after coating and drying. The temperature of the heat treatment is preferably in a range of from 60° C. to 100° C. at the film surface, and the time period for heating is preferably in a range of from 1 sec to 60 sec. More preferably, heating is performed in a temperature range of from 70° C. to 90° C. at the film surface, and the time period for heating is from 2 sec to 10 sec. A preferred method of heat treatment for the invention is described in JP-A No. 2002-107872.

Furthermore, the production methods described in JP-A Nos. 2002-156728 and 2002-182333 are preferably employed in order to produce the photothermographic material of the invention stably and successively.

The photothermographic material is preferably of mono-sheet type (i.e., a type which forms an image on the photothermographic material without using other sheets such as an image-receiving material).

(Wrapping Material)

In order to suppress fluctuation from occurring on photographic performance during raw stock storage of the photothermographic material of the invention, or in order to improve curling or winding tendencies when the photothermographic material is manufactured in a roll state, it is preferred that a wrapping material having low oxygen permeability and/or moisture permeability is used. Preferably, oxygen permeability is 50 mL·atm⁻¹m⁻²day⁻¹ or lower at 25° C., more preferably 10 mL·atm⁻¹m⁻²day⁻¹ or lower, and even more preferably 1.0 mL·atm⁻¹m⁻²day⁻¹ or lower. Preferably, moisture permeability is 10 g·atm⁻¹m⁻²day⁻¹ or lower, more preferably 5 g·atm⁻¹m⁻²day⁻¹ or lower, and even more preferably 1 g·atm⁻¹m⁻²day⁻¹ or lower.

As specific examples of a wrapping material having low oxygen permeability and/or moisture permeability, reference can be made to, for instance, the wrapping material described in JP-A Nos. 8-254793 and 2000-206653.

(Other Applicable Techniques)

Techniques which can be used for the photothermographic material of the invention also include those in EP No. 803764A1, EP No. 883022A1, WO No. 98/36322, JP-A Nos. 56-62648 and 58-62644, JP-A Nos. 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, and 11-343420, JP-A Nos. 2001-200414, 2001-234635, 2002-020699, 2001-275471, 2001-275461, 2000-313204, 2001-292844, 2000-324888, 2001-293864, 2001-348546, and 2000-187298.

(Image Forming Method)

1) Imagewise Exposure

The photothermographic material of the invention may be subjected to imagewise exposure by any methods. Preferably, the photothermographic material of the present invention is subjected to scanning exposure using a laser beam as an exposure light source. As laser beam which can be used in the invention, He—Ne laser of red through infrared emission, red laser diode, or Ar⁺, He—Ne, He—Cd laser of blue through green emission, and blue laser diode are described. Preferred is red to infrared laser diode and the peak wavelength of laser beam is 600 nm to 900 nm, and preferably 620 nm to 850 nm.

In recent years, development has been made particularly on a light source module with an SHG (a second harmonic generator) device and a laser diode integrated into a single piece, and on a blue laser diode, whereby a laser output apparatus in a short wavelength region has become popular. A blue laser diode enables high definition image recording and makes it possible to obtain an increase in recording density and a stable output over a long lifetime, which results in expectation of an expanded demand in the future. The peak wavelength of blue laser beam is preferably from 300 nm to 500 nm, and particularly preferably from 400 nm to 500 nm.

Laser beam which oscillates in a longitudinal multiple modulation by a method such as high frequency superposition is also preferably employed.

2) Thermal Development

Although any method may be used for developing the photothermographic material of the present invention, development is usually performed by elevating the temperature of the photothermographic material exposed imagewise. The temperature of development is preferably from 100° C. to 250° C., more preferably from 100° C. to 150° C., and even more preferably from 110° C. to 130° C. The time period for development is preferably from 1 sec to 60 sec, more preferably from 3 sec to 30 sec, even more preferably from 5 sec to 25 sec, and particularly preferably from 7 sec to 15 sec.

In the process of thermal development, either a drum type heater or a plate type heater may be used, although a plate type heater is preferred. A preferable process of thermal development by a plate type heater is a process described in JP-A No. 11-133572, which discloses a thermal developing apparatus in which a visible image is obtained by bringing a photothermographic material with a formed latent image into contact with a heating means at a thermal developing portion, wherein the heating means comprises a plate heater, and a plurality of pressing rollers are oppositely provided along one surface of the plate heater, and the thermal developing apparatus is characterized in that thermal development is performed by passing the photothermographic material between the pressing rollers and the plate heater. It is preferred that the plate heater is divided into 2 to 6 steps, with the leading end having a lower temperature by 1° C. to 1° C. For example, 4 sets of plate heaters which can be independently subjected to the temperature control are used, and are controlled so that they respectively become 112° C., 119° C., 121° C., and 120° C.

Such a process is also described in JP-A No. 54-30032, which allows for passage of moisture and organic solvents included in the photothermographic material out of the system, and also allows for suppressing the change in shapes of the support of the photothermographic material upon rapid heating of the photothermographic material.

For downsizing the thermal developing apparatus and for reducing the time period for thermal development, it is preferred that the heater is more stably controlled and that the top part of one sheet of the photothermographic material is exposed and thermal development of the exposed part is started before imagewise exposure of the end part of the sheet has completed. Preferable imagers which enable a rapid processing according to the invention are described in, for example, JP-A Nos. 2002-289804 and 2003-285455. Using such imagers, thermal development within 14 sec is possible with a plate type heater having three heating plates which are controlled, for example, at 107° C., 121° C. and 121° C., respectively. Thus, the output time period for the first sheet can be reduced to about 60 sec.

3) System

Examples of a medical laser imager equipped with a light exposing portion and a thermal developing portion include Fuji Medical Dry Laser Imager FM-DPL and DRYPIX 7000. In connection with FM-DPL, description is found in Fuji Medical Review No. 8, pages 39 to 55. Those techniques are applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

(Application of the Invention)

The photothermographic material and the image forming method of the invention are preferably employed as photothermographic materials and image forming methods for photothermographic materials for use in medical diagnosis, photothermographic materials for use in industrial photographs, photothermographic materials for use in graphic arts, as well as for COM, through forming black and white images by silver imaging.

All publications, patent applications, and technical standards mentioned in this specification are herein incorporated by reference to the same extent as if each individual publication, patent application, or technical standard was specifically and individually indicated to be incorporated by reference.

### EXAMPLES

The present invention is specifically explained by way of Examples below, which should not be construed as limiting the invention thereto.

### Example 1

### (Preparation of PET Support)

1) Film Manufacturing

PET having IV (intrinsic viscosity) of 0.66 (measured in phenol/tetrachloroethane=6/4 (by weight ratio) at 25° C.) was obtained according to a conventional manner using terephthalic acid and ethylene glycol. The product was pelletized, dried at 130° C. for 4 hours, and melted at 300° C. Thereafter, the mixture was extruded from a T-die and rapidly cooled to form a non-tentered film.

The film was stretched along the longitudinal direction by 3.3 times using rollers of different peripheral speeds, and then stretched along the transverse direction by 4.5 times using a tenter machine. The temperatures used for these operations were 110° C. and 130° C., respectively. Then, the film was subjected to thermal fixation at 240° C. for 20 seconds, and relaxed by 4% along the transverse direction at the same temperature. Thereafter, the chucking part of the tenter machine was slit off, and both edges of the film were knurled. Then the film was rolled up at the tension of 4 kg/cm² to obtain a roll having a thickness of 175 μm.

2) Surface Corona Discharge Treatment

Both surfaces of the support were treated at room temperature at 20 m/minute using Solid State Corona Discharge Treatment Machine Model 6 KVA manufactured by Piller GmbH. It was proven that treatment of 0.375 kV·A·minute/m² was executed, judging from the readings of current and voltage on that occasion. The frequency upon this treatment was 9.6 kHz, and the gap clearance between the electrode and dielectric roll was 1.6 mm.

3) Undercoating
Formula a (for undercoat layer on the image forming layer side)

| | | |
|---|---|---|
| Pesresin A-520 manufactured by Takamatsu Oil & Fat Co., Ltd. (30% by | 46.8 | g |
| weight solution) | | |
| BAIRONAARU MD-1200 manufactured by Toyo Boseki Co., Ltd. | 10.4 | g |
| Polyethylene glycol monononylphenyl ether (average number of | 11.0 | g |
| ethylene oxide of 8.5) 1% by weight solution | | |
| MP-1000 manufactured by Soken Chemical & Engineering Co., Ltd. | 0.91 | g |
| (PMMA polymer fine particles, mean particle diameter of 0.4 μm) | | |
| Distilled water | 931 | mL |

Formula b (for first layer on the backside)

| | | |
|---|---|---|
| Styrene-butadiene copolymer latex (solid content of 40% by weight, | 130.8 | g |
| styrene/butadiene weight ratio of 68/32) | | |
| Sodium salt of 2,4-dichloro-6-hydroxy-s-triazine (8% by weight | 5.2 | g |
| aqueous solution) | | |
| 1% by weight aqueous solution of sodium laurylbenzenesulfonate | 10 | mL |
| Polystyrene particle dispersion (mean particle diameter of 2 μm, 20% | 0.5 | g |
| by weight) | | |
| Distilled water | 854 | mL |

Formula c (for second layer on the backside)

| | | |
|---|---|---|
| SnO₂/SbO (9/1 by weight ratio, mean particle diameter of 0.5 μm, 17% | 84 | g |
| by weight dispersion) | | |
| Gelatin | 7.9 | g |
| METOLOSE TC-5 manufactured by Shin-Etsu Chemical Co., Ltd. (2% | 10 | g |
| by weight aqueous solution) | | |
| 1% by weight aqueous solution of sodium dodecylbenzenesulfonate | 10 | mL |
| NaOH (1% by weight) | 7 | g |
| Proxel (manufactured by Imperial Chemical Industries PLC) | 0.5 | g |
| Distilled water | 881 | mL |

Both surfaces of the biaxially stretched polyethylene terephthalate support having the thickness of 175 μm were each subjected to the corona discharge treatment described above. Thereafter, the aforementioned formula a of the coating solution for the undercoat was coated on one side (image forming layer side) with a wire bar so that the amount of wet coating became 6.6 mL/m² (per one side), and dried at 180° C. for 5 minutes. Then, the aforementioned formula b of the coating solution for the undercoat was coated on the reverse side (backside) with a wire bar so that the amount of wet coating became 5.7 mL/m², and dried at 180° C. for 5 minutes. Furthermore, the aforementioned formula c of the coating solution for the undercoat was coated on the reverse side (backside) with a wire bar so that the amount of wet coating became 8.4 mL/m², and dried at 180° C. for 6 minutes. Thus, an undercoated support was produced.

(Back Layer)

1) Preparations of Coating Solution for Back Layer

(Preparation of Dispersion of Solid Fine Particles (a) of Base Precursor)

2.5 kg of base precursor compound-1, 300 g of surfactant (trade name: DEMOL N, manufactured by Kao Corporation), 800 g of diphenyl sulfone, and 1.0 g of benzisothiazolinone sodium salt were mixed with distilled water to give the total amount of 8.0 kg. This mixed liquid was subjected to beads dispersion using a horizontal sand mill (UVM-2: manufactured by AIMEX Co., Ltd.). The process of dispersion includes feeding the mixed liquid to UVM-2 packed with zirconia beads having a mean particle diameter of 0.5 mm with a diaphragm pump, followed by dispersion at the inner pressure of 50 hPa or higher until desired mean particle diameter could be achieved.

Dispersion was continued until the ratio of the optical density at 450 nm to the optical density at 650 nm for the spectral absorption of the dispersion (D₄₅₀/D₆₅₀) became 3.0 upon spectral absorption measurement. The resulting dispersion was diluted with distilled water so that the concentration of the base precursor became 25% by weight, and filtrated (with a polypropylene filter having a mean fine pore diameter of 3 μm) for eliminating dust to put into practical use.

2) Preparation of Solid Fine Particle Dispersion of Dye

Cyanine dye-1 in an amount of 6.0 kg, 3.0 kg of sodium p-dodecylbenzenesulfonate, 0.6 kg of surfactant DEMOL SNB (manufactured by Kao Corporation), and 0.15 kg of antifoaming agent (trade name: SURFYNOL 104E, manufactured by Nissin Chemical Industry Co., Ltd.) were mixed with distilled water to give the total amount of 60 kg. The mixed liquid was subjected to dispersion with 0.5 mm zirconia beads using a horizontal sand mill (UVM-2: manufactured by AIMEX Co., Ltd.).

Dispersion was continued until the ratio of the optical density at 650 nm to the optical density at 750 nm for the spectral absorption of the dispersion (D₆₅₀/D₇₅₀) became 5.0 or higher upon spectral absorption measurement. The resulting dispersion was diluted with distilled water so that the concentration of the cyanine dye became 6% by weight, and filtrated with a filter (mean fine pore diameter: 1 μm) for eliminating dust to put into practical use.

3) Preparation of Coating Solution for Antihalation Layer

A vessel was kept at 40° C., and thereto were added 37 g of gelatin having an isoelectric point of 6.6 (ABA gelatin, manufactured by Nippi Co., Ltd.), 0.1 g of benzisothiazolinone, and water to allow gelatin to be dissolved. Additionally, 36 g of the above-mentioned dispersion of the solid fine particles of the dye, 73 g of the above-mentioned dispersion of the solid fine particles (a) of the base precursor, 43 mL of a 3% by weight aqueous solution of sodium polystyrenesulfonate, and 82 g of a 10% by weight liquid of SBR latex (styrene/butadiene/acrylic acid copolymer; weight ratio of the copolymerization of 68.3/28.7/3.0) were admixed to provide a coating solution for the antihalation layer in an amount of 773 mL. The pH of the resulting coating solution was 6.3.

4) Preparation of Coating Solution for Back Surface Protective Layer

A vessel was kept at 40° C., and thereto were added 43 g of gelatin having an isoelectric point of 4.8 (PZ gelatin, manufactured by Miyagi Chemical Industry Co., Ltd.), 0.21 g of benzisothiazolinone, and water to allow gelatin to be dissolved. Additionally, 8.1 mL of 1 mol/L sodium acetate aqueous solution, 0.93 g of fine particles of monodispersed poly(ethylene glycol dimethacrylate-co-methyl methacrylate) (mean particle size of 7.7 μm, standard deviation of particle diameter of 0.3), 5 g of a 10% by weight emulsified dispersion of liquid paraffin, 10 g of a 10% by weight emulsified dispersion of dipentaerythritol hexaisostearate, 10 mL of a 5% by weight aqueous solution of di(2-ethylhexyl) sodium sulfosuccinate, 17 mL of a 3% by weight aqueous solution of sodium polystyrenesulfonate, 2.4 mL of a 2% by weight solution of fluorocarbon surfactant (F-1), 2.4 mL of a 2% by weight solution of fluorocarbon surfactant (F-2), and 30 mL of a 20% by weight liquid of ethyl acrylate/acrylic acid copolymer (weight ratio of the copolymerization of 96.4/3.6) latex were admixed. Just prior to coating, 50 mL of a 4% by weight aqueous solution of N,N-ethylenebis(vinylsulfone acetamide) was admixed to provide a coating solution for the back surface protective layer in an amount of 855 mL. The pH of the resulting coating solution was 6.2.

5) Coating of Back Layer

The backside of the undercoated support described above was subjected to simultaneous double coating so that the coating solution for the antihalation layer gave the coating amount of gelatin of 0.54 g/m², and so that the coating solution for the back surface protective layer gave the coating amount of gelatin of 1.85 g/m², followed by drying to produce a back layer.

(Image Forming Layer, Intermediate Layer, and Surface Protective Layer)

### 1. Preparation of Coating Materials

1) Silver Halide Emulsion

<Preparation of Silver Halide Emulsion 1 for Comparison>

A liquid was prepared by adding 3.1 mL of a 1% by weight solution of potassium bromide, and then 3.5 mL of 0.5 mol/L sulfuric acid and 31.7 g of phthalated gelatin to 1421 mL of distilled water. The liquid was kept at 30° C. while stirring in a stainless-steel reaction vessel, and thereto was added a total amount of: solution A prepared through diluting 22.22 g of silver nitrate by adding distilled water to give the volume of 95.4 mL; and solution B prepared through diluting 15.3 g of potassium bromide and 0.8 g of potassium iodide with distilled water to give the volume of 97.4 mL, over 45 seconds at a constant flow rate. Thereafter, 10 mL of a 3.5% by weight aqueous solution of hydrogen peroxide was added thereto, and 10.8 mL of a 10% by weight aqueous solution of benzimidazole was further added. Moreover, solution C prepared through diluting 51.86 g of silver nitrate by adding distilled water to give the volume of 317.5 mL and solution D prepared through diluting 44.2 g of potassium bromide and 2.2 g of potassium iodide with distilled water to give the volume of 400 mL were added. A controlled double jet method was executed through adding the solution C in its entirety at a constant flow rate over 20 minutes, accompanied by adding the solution D while maintaining the pAg at 8.1. Potassium hexachloroiridate (III) was added in its entirety to give 1×10⁻⁴ mol per 1 mol of silver, at 10 minutes post initiation of the addition of the solution C and the solution D. Moreover, at 5 seconds after completing the addition of the solution C, an aqueous solution of potassium hexacyanoferrate (II) was added in its entirety to give 3×10⁻⁴ mol per 1 mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-described silver halide dispersion was kept at 38° C. with stirring, and thereto was added 5 mL of a 0.34% by weight methanol solution of 1,2-benzisothiazolin-3-one, followed by elevating the temperature to 47° C. at 40 minutes thereafter. At 20 minutes after elevating the temperature, sodium benzenethiosulfonate in a methanol solution was added at 7.6×10⁻⁵ mol per 1 mol of silver. At additional 5 minutes later, tellurium sensitizer C in a methanol solution was added at 2.9×10⁻⁴ mol per 1 mol of silver, and the mixture was subjected to ripening for 91 minutes. Thereafter, a methanol solution of spectral sensitizing dye A and spectral sensitizing dye B with a molar ratio of 3:1 was added thereto at 1.2×10⁻³ mol in total of the spectral sensitizing dyes A and B per 1 mol of silver. At one minute later, 1.3 mL of a 0.8% by weight methanol solution of N,N′-dihydroxy-N″,N″-diethylmelamine was added thereto, and at additional 4 minutes thereafter, 5-methyl-2-mercaptobenzimidazole in a methanol solution at 4.8×10⁻³ mol per 1 mol of silver, 1-phenyl-2-heptyl-5-mercapto-1,3,4-triazole in a methanol solution at 5.4×10⁻³ mol per 1 mol of silver, and 1-(3-methylureidophenyl)-5-mercaptotetrazole in an aqueous solution at 8.5×10⁻³ mol per 1 mol of silver were added to produce silver halide emulsion 1.

Grains in thus prepared silver halide emulsion were silver iodobromide grains having a mean equivalent spherical diameter of 0.042 μm, a variation coefficient of an equivalent spherical diameter distribution of 20%, which uniformly include iodine at 3.5 mol %. Grain size and the like were determined from the average of 1000 grains using an electron microscope. The {100} face ratio of these grains was found to be 80% using a Kubelka-Munk method.

<Preparation of Silver Halide Emulsion 2 for Comparison>

Preparation of silver halide emulsion 2 was conducted in a similar manner to the process in the preparation of the silver halide emulsion 1 except that: the temperature of the liquid at the time of grain formation was altered from 30° C. to 47° C.; the solution B was changed to that prepared through diluting 15.9 g of potassium bromide with distilled water to give the volume of 97.4 mL; the solution D was changed to that prepared through diluting 45.8 g of potassium bromide with distilled water to give the volume of 400 mL; and the time period for adding the solution C was changed to 30 minutes.

Precipitation/desalting/water washing/dispersion were carried out similar to the silver halide emulsion 1. Furthermore, spectral sensitization, chemical sensitization, and addition of 5-methyl-2-mercaptobenzimidazole and 1-phenyl-2-heptyl-5-mercapto-1,3,4-triazole were executed similar to those in the preparation of the silver halide emulsion 1. Thereby, silver halide emulsion 2 was obtained. Grains in the silver halide emulsion 2 were cubic pure silver bromide grains having a mean equivalent spherical diameter of 0.080 μm and a variation coefficient of an equivalent spherical diameter distribution of 20%.

<Preparation of Silver Halide Emulsion 3>

Preparation of silver halide emulsion 3 was conducted in a similar manner to the process in the preparation of the silver halide emulsion 1 except that the temperature of the liquid upon grain formation was altered from 30° C. to 27° C. Further, precipitation/desalting/water washing/dispersion were carried out similar to the silver halide emulsion 1. Furthermore, spectral sensitization, chemical sensitization, and addition of 5-methyl-2-mercaptobenzimidazole and 1-phenyl-2-heptyl-5-mercapto-1,3,4-triazole were executed similar to those in the preparation of the silver halide emulsion 1. Thereby, silver halide emulsion 3 was obtained. Grains in the silver halide emulsion 3 were silver iodobromide grains having a mean equivalent spherical diameter of 0.034 μm and a variation coefficient of an equivalent spherical diameter distribution of 20%, which uniformly include iodine at 3.5 mol %.

<Preparation of Silver Halide Emulsions 4 to 6>

Gelatin-1 to -4 used as a dispersing medium for preparing silver halide hyperfine grains including formation of the silver halide hyperfine grains are gelatins which have the following characteristics.

Gelatin-1: conventional alkali-processed osein gelatin whose raw material is cattle bone. In the gelatin, —NH₂ groups are not chemically modified.

Gelatin-2: gelatin prepared by reacting an enzyme with the gelatin-1 to provide a low molecular weight gelatin having a weight-average molecular weight of 20,000 and deactivating the residual enzyme followed by drying. In the gelatin, —NH₂ groups are not chemically modified. The content of methionine group in the gelatin is 42 μmol/g.

Gelatin-3: gelatin prepared by adding hydrogen peroxide to the aqueous solution of the gelatin-2 and deactivating the residual hydrogen peroxide by catalase after the chemical reaction.

—NH₂ groups in the gelatin are not chemically modified. The content of methionine group in the gelatin is 3.4 μmol/g.

Gelatin-1 to -3 each were subjected to deionization process, and then the pH of the 5% by weight aqueous solution thereof was adjusted to 6.0 at 35° C. The aqueous solution of silver salt and aqueous solution of halide salt used for the following preparation of silver halide hyperfine grains are described below.

Ag-a aqueous solution: containing 32.0 g of silver nitrate in 100 mL thereof.

X-a aqueous solution: containing 22.5 g of potassium bromide and 20 g of the gelatin-3 in 100 mL thereof.

By using a stirring apparatus described in JP-A No. 10-43570 as a mixing vessel of the aqueous solution of silver salt and aqueous solution of halide salt, silver halide hyperfine grains were prepared by mixing the Ag-a aqueous solution and the X-a aqueous solution. In this process, the mixing ratio of the aqueous solution of silver salt and the aqueous solution of halide salt was changed, and the pAg of the mixture part was controlled, to obtain silver halide hyperfine grain 4 and 5. Further, precipitation/desalting/water washing/dispersion were carried out similar to the silver halide emulsion 1. Furthermore, spectral sensitization, chemical sensitization, and addition of 5-methyl-2-mercaptobenzimidazole and 1-phenyl-2-heptyl-5-mercapto-1,3,4-triazole were executed similar to those in the preparation of the silver halide emulsion 1. Thereby, silver halide emulsions 4 and 5 were obtained. The conditions are shown below in more detail. Furthermore, in a similar condition to that in the preparation of the silver halide emulsion 5 except that grain formation was performed by adding sodium hydroxide to the X-a aqueous solution to make the pH thereof at 8.0, silver halide emulsion 6 was prepared. At this time, the pH inside the mixing vessel was 7.6. Further, the average grain size (mean equivalent spherical diameter) of the hyperfine grains and the variation coefficient thereof were determined by a cool electron microscopic photography. Details are shown below.

TABLE 1

| | | | Mean Equivalent | |
|---|---|---|---|---|
| | | | Spherical | Variation |
| Silver Halide | | | Diameter | Coefficient |
| Emulsion No. | Mixing Ratio | pAg | (μm) | (%) |
| 4 | 101:100 | 8.8 | 0.028 | 36 |
| 5 | 95:100 | 2.1 | 0.023 | 28 |
| 6 | 95:100 | 2.1 | 0.021 | 25 |

(Mixing ratio is expressed by silver molar ratio.)

<Preparation of Silver Halide Emulsions 7 and 8>

—Polymer Synthesis—

A 0.3 L four-necked separable flask equipped with a dropping funnel, thermometer, nitrogen gas introduction tube, stirrer, and reflex cooling tube was charged with 20 g of methyl ethyl ketone and heated to 70° C. The mixed solution prepared by weighing the monomer having the composition proportion described below (expressed by g) and adding lauryl peroxide thereto was dropped into the above flask over a period of two hours and allowed to react for five hours while keeping the temperature. Thereafter, 80 g of methyl ethyl ketone was added thereto and the resulting mixture was cooled. Thereby a polymer solution containing 50% by weight of polymer was obtained. The molecular weight was determined by GPC measurement in terms of polystyrene-reduced weight-average molecular weight.

TABLE 2

| | R-1 | R-2 |
|---|---|---|
| BLEMMER PME-400 | 20 | 20 |
| BLEMMER PSE-400 | 20 | 20 |
| MAA | 10 | 10 |
| DAAM | 50 | 50 |
| Molecular weight | 8500 | 86000 |
| Solubility in Water (1%) | soluble | soluble |
| Solubility in MEK (1%) | soluble | soluble |

BLEMMER PME-400: Methacrylate having -(EO)ₘ-CH₃ (m = 9)
BLEMMER PSE-400: Methacrylate having -(EO)ₘ-C₁₈H₃₇ (m = 9) (EO; Ethyleneoxy group)
The above chemicals are all manufactured by NOF Corporation.
MAA: Methacrylic acid
DAAM: Diacetone acrylamide (manufactured by Kyowa Hakko Chemical Co., Ltd.)
Solubility in water (1%): The solubility is determined by whether each polymer can be dissolved in water at a concentration of 1% at 25° C. or not.
Solubility in MEK (1%): The solubility is determined by whether each polymer can be dissolved in MEK (methyl ethyl ketone) at a concentration of 1% at 25° C. or not.

—Preparation of Silver Halide Emulsion—

A liquid was prepared by adding 8.6 mL of a 1% by weight solution of potassium bromide, and then 23.7 g of the mixture of polymer and gelatin shown in the following Table 3, which was adjusted to the pH of 6.0 with potassium hydroxide, and 2.7 mL of a 10% methanol solution of compound A to 1433 mL of distilled water. The liquid was kept at the temperature shown in the following Table 3, while stirring in a stainless-steel reaction vessel, and thereto was added a total amount of: solution A prepared through diluting 20.16 g of silver nitrate by adding distilled water to give the volume of 177.1 mL; and solution B prepared through diluting 13.6 g of potassium bromide and 0.5 g of potassium iodide with distilled water to give the volume of 177.4 mL, over 4 minutes and 45 seconds, while controlling the pAg to 8.09. Thereafter, 5.4 mL of a 3.5% by weight aqueous solution of potassium hydroxide and 9.1 mL of a 3.5% by weight aqueous solution of hydrogen peroxide was added thereto, and further, 9.8 mL of a 10% by weight aqueous solution of benzimidazole was added. Moreover, solution C prepared through diluting 60.47 g of silver nitrate by adding distilled water to give the volume of 533.2 mL and solution D prepared through diluting 41.0 g of potassium bromide, 1.5 g of potassium iodide, and potassium hexachloroiridate (III) (4×10⁻⁵ mol per 1 mol of silver) with distilled water to give the volume of 533 mL were added. A controlled double jet method was executed through adding the solution C in its entirety at a constant flow rate over 14 minutes and 45 seconds, accompanied by adding the solution D while maintaining the pAg at 8.09. Moreover, at 5 seconds after completing the addition of the solution C, an aqueous solution of potassium hexacyanoferrate (II) was added in its entirety to give 3×10⁻⁴ mol per 1 mol of silver. Thereafter, precipitation/desalting/water washing/dispersion were carried out similar to the silver halide emulsion 1. Furthermore, spectral sensitization, chemical sensitization, and addition of 5-methyl-2-mercaptobenzimidazole and 1-phenyl-2-heptyl-5-mercapto-1,3,4-triazole were executed similar to those in the preparation of the silver halide emulsion 1. Thereby, silver halide emulsions 7 and 8 were obtained.

Further, mean equivalent spherical diameter and variation coefficient were determined by a cool electron microscopic photography of the silver halide emulsion.

Details are shown in the following Table 3.

TABLE 3

| | | | Mean | |
|---|---|---|---|---|
| | | | Equivalent | |
| Silver Halide | Polymer/Gelatin | Temperature | Spherical | Variation |
| Emulsion | Ratio | for | Diameter | Coefficient |
| No. | (by weight ratio) | Preparation | (μm) | (%) |
| 7 | R-1/Gel = 80/20 | 35 | 0.030 | 15 |
| 8 | R-2/Gel = 50/50 | 10 | 0.018 | 14 |

### (Compound A)

HO(CH₂CH₂O)ₙ(CH(CH₃)CH₂O)₁₇(CH₂CH₂O)ₘH (m+n=5 to 7)

<Preparation of Silver Halide Emulsion for Coating>

Each of the silver halide emulsion was dissolved, and thereto was added benzothiazolium iodide in a 1% by weight aqueous solution to give 7×10⁻³ mol per 1 mol of silver.

Further, as “a compound that is one-electron-oxidized to provide a one-electron oxidation product which releases one or more electrons”, the compounds Nos. 1, 2, and 3 were added respectively in an amount of 2×10⁻³ mol per 1 mol of silver in silver halide.

Thereafter, as “a compound having an adsorptive group and a reducing group”, the compound Nos. 1 and 2 were added respectively in an amount of 5×10⁻³ mol per 1 mol of silver halide.

Further, water was added thereto to give the content of silver halide of 38.2 g per 1 kg of the silver halide emulsion for coating on the basis of silver content, and 1-(3-methylureidophenyl)-5-mercaptotetrazole was added to give 0.34 g per 1 kg of the silver halide emulsion for coating.

2) Preparation of Dispersion of Silver Salt of Fatty Acid

(Preparation of Dispersion A of Silver Salt of Fatty Acid)

<Preparation of Recrystallized Behenic Acid>

Behenic acid manufactured by Henkel Co. (trade name: Edenor C22-85R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystallization was controlled to be 3° C./hour. The resulting crystal was subjected to centrifugal filtration, and washing was performed with 100 kg of isopropyl alcohol. Thereafter, the crystal was dried. The resulting crystal was esterified, and subjected to GC-FID analysis to give the result of the content of behenic acid being 96 mol %. In addition, lignoceric acid, arachidic acid, and erucic acid were included at 2 mol %, 2 mol %, and 0.001 mol %, respectively.

<Preparation of Dispersion of Silver Salt of Fatty Acid>

88 kg of the recrystallized behenic acid, 422 L of distilled water, 49.2 L of 5 mol/L sodium hydroxide aqueous solution, and 120 L of t-butyl alcohol were admixed, and subjected to reaction with stirring at 75° C. for one hour to provide solution B of sodium behenate. Separately, 206.2 L of an aqueous solution containing 40.4 kg of silver nitrate (pH 4.0) was provided, and kept at a temperature of 10° C. A reaction vessel charged with 635 L of distilled water and 30 L of t-butyl alcohol was kept at 30° C., and thereto were added the total amount of the solution B of sodium behenate and the total amount of the aqueous solution of silver nitrate with sufficient stirring at a constant flow rate over 93 minutes and 15 seconds, and 90 minutes, respectively.

In this process, during first 11 minutes following the initiation of adding the aqueous solution of silver nitrate, the added material was restricted to the aqueous solution of silver nitrate alone. The addition of the solution B of sodium behenate was thereafter started, and during 14 minutes and 15 seconds following the completion of adding the aqueous solution of silver nitrate, the added material was restricted to the solution B of sodium behenate alone.

In this process, the temperature inside of the reaction vessel was set to be 30° C., and the temperature outside was controlled so that the temperature of the liquid could be kept constant. In addition, the temperature of a pipeline for the addition system of the solution B of sodium behenate was kept constant by circulation of warm water outside of a double wall pipe, so that the temperature of the liquid at an outlet in the leading edge of the nozzle for addition was adjusted to be 75° C.

Further, the temperature of a pipeline for the addition system of the aqueous solution of silver nitrate was kept constant by circulation of cool water outside of a double wall pipe. The position at which the solution B of sodium behenate was added and the position at which the aqueous solution of silver nitrate was added were arranged symmetrically with a shaft for stirring located at a center. Moreover, both of the positions were adjusted to avoid contact with the reaction liquid.

After completing the addition of the solution B of sodium behenate, the mixture was left to stand at the temperature as it was for 20 minutes while stirring. The temperature of the mixture was then elevated to 35° C. over 30 minutes followed by ripening for 210 minutes. Immediately after completing the ripening, solid matters were filtered out with centrifugal filtration. The solid matters were washed with water until the electric conductivity of the filtrated water became 30 μS/cm. Silver salt of a fatty acid was thus obtained. The resulting solid matters were stored as a wet cake without drying.

When the shape of the obtained particles of silver behenate was evaluated by electron micrography, a crystal was revealed having a=0.21 μm, b=0.4 μm and c=0.4 μm on the average value, with a mean aspect ratio of 2.1, a mean equivalent spherical diameter of 0.55 μm, and a variation coefficient of an equivalent spherical diameter distribution of 11% (a, b, and c are as defined aforementioned.).

To the wet cake corresponding to 260 kg of a dry solid matter content, were added 19.3 kg of poly(vinyl alcohol) (trade name: PVA-217) and water to give the total amount of 1000 kg. Then, slurry was obtained from the mixture using a dissolver blade. Additionally, the slurry was subjected to preliminary dispersion with a pipeline mixer (manufactured by MIZUHO Industrial Co., Ltd.: PM-10 type).

Next, a stock liquid after the preliminary dispersion was treated three times using a dispersing machine (trade name: Microfluidizer M-610, manufactured by Microfluidex International Corporation, using Z type Interaction Chamber) with the pressure controlled to be 1150 kg/cm² to provide a dispersion of silver behenate. For the cooling operation, coiled heat exchangers were equipped in front of and behind the interaction chamber respectively, and accordingly, the temperature for the dispersion was set to be 18° C. by regulating the temperature of the cooling medium.

<<Preparation of Fine Particle Dispersion M1 to M5 of Silver Salt of Fatty Acid>>

<Preparation of Silver Salt of Fatty Acid M1>

In 4720 mL of distilled water were dissolved 130.8 g of behenic acid, 67.7 g of arachidic acid, 43.6 g of stearic acid, and 2.3 g of palmitic acid at 80° C. Thereafter, 540.2 mL of 1.5 mol/L sodium hydroxide aqueous solution and 6.9 mL of concentrated nitric acid were added thereto, and the resulting mixture was cooled to 55° C. to provide a solution of sodium salt of a fatty acid. The solution of sodium salt of a fatty acid was stirred for 20 minutes while keeping the temperature of the solution at 55° C. Thereafter, 500 mL of distilled water was added thereto, and the mixture stirred for 5 minutes.

Next, 702.6 mL of 1 mol/L silver nitrate solution was added thereto over 2 minutes. After stirring for 10 minutes, a dispersion of silver salt of an aliphatic carboxylic acid was obtained. Thereafter, the obtained dispersion of silver salt of an aliphatic carboxylic acid was added in a water washing vessel, and deionized water was added thereto. After stirring, the mixture was kept still to float-separate the dispersion of silver salt of an aliphatic carboxylic acid, and water-soluble salts in the bottom phase were removed. Thereafter, water washing with deionized water and drainage were repeated until the electrical conductivity of the wastewater became 2 μS/cm. After performing centrifugal dehydration, the obtained silver salt of an aliphatic carboxylic acid in the form of a wet cake was dried using a gas stream dryer Flash Jet Dryer (trade name, manufactured by Seishin Enterprise Co., Ltd.) where nitrogen gas atmosphere and the operation condition of the temperature of hot air at the entrance of the dryer were controlled, to reach to a moisture content of 0.1%. Thereby, powder silver salt of an aliphatic carboxylic acid M1 was obtained. Measurement of moisture content of the silver salt of an aliphatic carboxylic acid composition was determined using an infrared aquameter.

Preparation of M2 to M5 was conducted in a similar manner to the process in the preparation of the silver salt of a fatty acid M1 except that a part of sodium hydroxide was changed to potassium hydroxide as shown in the following Table.

<Preparation of Dispersion M1 to M5 of Silver Salt of Fatty Acid>

Dispersion M1 to M5 of silver salt of a fatty acid was prepared in a similar manner to the process in the preparation of the dispersion A of silver salt of a fatty acid except that the silver salt of a fatty acid M1 to M5 obtained as described above was used.

TABLE 4

| | | | Mean Particle |
|---|---|---|---|
| | | | Diameter |
| | NaOH | KOH | (μm) |
| M1 | 100 | 0 | 0.65 |
| M2 | 75 | 25 | 0.54 |
| M3 | 50 | 50 | 0.45 |
| M4 | 25 | 75 | 0.39 |
| M5 | 0 | 100 | 0.35 |

(Preparation of Nanoparticle Dispersion N1 of Silver Salt of Fatty Acid of the Invention)

Into a reaction vessel were poured 1900 mL of deionized water, 36 mL of a 10% solution of dodecylthio polyacrylamide surfactant, and 46.6 g of the above-described recrystallized behenic acid. The mixture in the reaction vessel was stirred at a stirring rate of 150 rpm and heated to 70° C., while adding 70.6 g of a 10% by weight solution of potassium hydroxide into the reaction vessel. Next, the resulting mixture in the reaction vessel was heated to 80° C. and allowed to stand for 30 minutes until the solution turned to be turbid. Thereafter, the reaction mixture was cooled to 70° C., and then 21.3 g of a 100% solution of silver nitrate constituted by silver nitrate was added into the reaction vessel over a period of 30 minutes while controlling the addition speed. Next, the temperature of the mixture was kept to the reaction temperature for 30 minutes, and then cooled to room temperature, and the resultant was then decanted. Thereby, a nanoparticle dispersion of silver behenate having a median particle size of 150 nm was obtained (solid content of 3% by weight).

2 kg of the obtained nanoparticle dispersion of silver behenate having a solid content of 3% by weight was introduced into a filtration dialysis/ultrafiltration device equipped with a permeable membrane cartridge Osmonics Model 21-HZ20-S8J (effective surface area of 0.34 m², and nominal molecular weight cutoff of 50,000). A 0.18% by weight aqueous solution of dodecylthio polyacrylamide surfactant was used as displacement liquid. This device was operated so that the pressure to the permeable membrane was set to be 3.5 kg/cm² (50 lb/in²). The permeation liquid was replaced by deionized water until 24 kg of permeation liquid was removed from the dispersion. At the stage, the displacement liquid was stopped, and the device was operated until the dispersion reached to the concentration of 28% by weight based on the solid content. Thereby, a nanoparticle dispersion of silver behenate was obtained.

3) Preparation of Reducing Agent Dispersion

(Preparation of Reducing Agent-1 Dispersion)

To 10 kg of reducing agent-1 (2,2′-methylenebis-(4-ethyl-6-tert-butylphenol)) and 16 kg of a 10% by weight aqueous solution of modified poly(vinyl alcohol) (manufactured by Kuraray Co., Ltd., Poval MP-203) was added 10 kg of water, and thoroughly mixed to give slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours. Thereafter, 0.2 g of benzisothiazolinone sodium salt and water were added thereto, thereby adjusting the concentration of the reducing agent to be 25% by weight. This dispersion was subjected to heat treatment at 60° C. for 5 hours to obtain reducing agent-1 dispersion.

Particles of the reducing agent included in the resulting reducing agent dispersion had a median diameter of 0.40 μm, and a maximum particle diameter of 1.4 μm or less. The resulting reducing agent dispersion was subjected to filtration with a polypropylene filter having a pore size of 3.0 μm to remove foreign substances such as dust, and stored.

(Preparation of Reducing Agent-2 Dispersion)

To 10 kg of reducing agent-2 (6,6′-di-t-butyl-4,4′-dimethyl-2,2′-butylidenediphenol)) and 16 kg of a 10% by weight aqueous solution of modified poly(vinyl alcohol) (manufactured by Kuraray Co., Ltd., Poval MP-203) was added 10 kg of water, and thoroughly mixed to give slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minutes. Thereafter, 0.2 g of benzisothiazolinone sodium salt and water were added thereto, thereby adjusting the concentration of the reducing agent to be 25% by weight. This dispersion was heated at 40° C. for one hour, followed by a subsequent heat treatment at 80° C. for one hour to obtain reducing agent-2 dispersion. Particles of the reducing agent included in the resulting reducing agent dispersion had a median diameter of 0.50 μm, and a maximum particle diameter of 1.6 μm or less.

The resulting reducing agent dispersion was subjected to filtration with a polypropylene filter having a pore size of 3.0 μm to remove foreign substances such as dust, and stored.

4) Preparation of Hydrogen Bonding Compound-1 Dispersion

To 10 kg of hydrogen bonding compound-1 (tri(4-t-butylphenyl)phosphineoxide) and 16 kg of a 10% by weight aqueous solution of modified poly(vinyl alcohol) (manufactured by Kuraray Co., Ltd., Poval MP-203) was added 10 kg of water, and thoroughly mixed to give slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 4 hours. Thereafter, 0.2 g of benzisothiazolinone sodium salt and water were added thereto, thereby adjusting the concentration of the hydrogen bonding compound to be 25% by weight. This dispersion was heated at 40° C. for one hour, followed by a subsequent heat treatment at 80° C. for one hour to obtain hydrogen bonding compound-1 dispersion. Particles of the hydrogen bonding compound included in the resulting hydrogen bonding compound dispersion had a median diameter of 0.45 μm, and a maximum particle diameter of 1.3 μm or less. The resulting hydrogen bonding compound dispersion was subjected to filtration with a polypropylene filter having a pore size of 3.0 μm to remove foreign substances such as dust, and stored.

5) Preparation of Development Accelerator-1 Dispersion

To 10 kg of development accelerator-1 and 20 kg of a 10% by weight aqueous solution of modified poly(vinyl alcohol) (manufactured by Kuraray Co., Ltd., Poval MP-203) was added 10 kg of water, and thoroughly mixed to give slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 3 hours and 30 minutes. Thereafter, 0.2 g of benzisothiazolinone sodium salt and water were added thereto, thereby adjusting the concentration of the development accelerator to be 20% by weight. Accordingly, development accelerator-1 dispersion was obtained. Particles of the development accelerator included in the resulting development accelerator dispersion had a median diameter of 0.48 μm, and a maximum particle diameter of 1.4 μm or less. The resulting development accelerator dispersion was subjected to filtration with a polypropylene filter having a pore size of 3.0 μm to remove foreign substances such as dust, and stored.

6) Preparation of Development Accelerator-2 Dispersion and Color-Tone-Adjusting Agent-1 Dispersion

Also concerning solid dispersions of development accelerator-2 and color-tone-adjusting agent-1, dispersion was executed similar to that in the development accelerator-1, and thereby dispersions of 20% by weight and 15% by weight were respectively obtained.

7) Preparation of Organic Polyhalogen Compound Dispersion

(Preparation of Organic Polyhalogen Compound-1 Dispersion)

10 kg of organic polyhalogen compound-1 (tribromomethane sulfonylbenzene), 10 kg of a 20% by weight aqueous solution of modified poly(vinyl alcohol) (manufactured by Kuraray Co., Ltd., Poval MP-203), 0.4 kg of a 20% by weight aqueous solution of sodium triisopropylnaphthalenesulfonate and 14 kg of water were thoroughly admixed to give slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of benzisothiazolinone sodium salt and water were added thereto, thereby adjusting the concentration of the organic polyhalogen compound to be 26% by weight. Accordingly, organic polyhalogen compound-1 dispersion was obtained. Particles of the organic polyhalogen compound included in the resulting organic polyhalogen compound dispersion had a median diameter of 0.41 μm, and a maximum particle diameter of 2.0 μm or less. The resulting organic polyhalogen compound dispersion was subjected to filtration with a polypropylene filter having a pore size of 10.0 μm to remove foreign substances such as dust, and stored.

(Preparation of Organic Polyhalogen Compound 2 Dispersion)

10 kg of organic polyhalogen compound 2 (N-butyl-3-tribromomethane sulfonylbenzamide), 20 kg of a 10% by weight aqueous solution of modified poly(vinyl alcohol) (manufactured by Kuraray Co., Ltd., Poval MP-203) and 0.4 kg of a 20% by weight aqueous solution of sodium triisopropylnaphthalenesulfonate were thoroughly admixed to give slurry. This slurry was fed with a diaphragm pump, and was subjected to dispersion with a horizontal sand mill (UVM-2: manufactured by AIMEX Co., Ltd.) packed with zirconia beads having a mean particle diameter of 0.5 mm for 5 hours. Thereafter, 0.2 g of benzisothiazolinone sodium salt and water were added thereto, thereby adjusting the concentration of the organic polyhalogen compound to be 30% by weight. This dispersion was warmed at 40° C. for 5 hours to obtain organic polyhalogen compound-2 dispersion. Particles of the organic polyhalogen compound included in the resulting organic polyhalogen compound dispersion had a median diameter of 0.40 μm, and a maximum particle diameter of 1.3 μm or less. The resulting organic polyhalogen compound dispersion was subjected to filtration with a polypropylene filter having a pore size of 3.0 μm to remove foreign substances such as dust, and stored.

8) Preparation of Phthalazine Compound-1 Solution

Modified poly(vinyl alcohol) MP-203 in an amount of 8 kg was dissolved in 174.57 kg of water, and then, thereto were added 3.15 kg of a 20% by weight aqueous solution of sodium triisopropylnaphthalenesulfonate and 14.28 kg of a 70% by weight aqueous solution of phthalazine compound-1 (6-isopropyl phthalazine) to prepare a 5% by weight solution of phthalazine compound-1.

9) Preparation of Aqueous Solution of Mercapto Compound

(Preparation of Aqueous Solution of Mercapto Compound-1)

Mercapto compound-1 (1-(3-sulfophenyl)-5-mercaptotetrazole sodium salt) in an amount of 7 g was dissolved in 993 g of water to provide a 0.7% by weight aqueous solution.

(Preparation of Aqueous Solution of Mercapto Compound-2)

Mercapto compound-2 (1-(3-methylureidophenyl)-5-mercaptotetrazole) in an amount of 20 g was dissolved in 980 g of water to provide a 2.0% by weight aqueous solution.

10) Preparation of Pigment-1 Dispersion

C.I. Pigment Blue 60 in an amount of 64 g and 6.4 g of DEMOL N manufactured by Kao Corporation were added to 250 g of water and thoroughly mixed to give slurry. Zirconia beads having a mean particle diameter of 0.5 mm were provided in an amount of 800 g, and charged in a vessel with the slurry. Dispersion was performed with a dispersing machine (¼G sand grinder mill: manufactured by AIMEX Co., Ltd.) for 25 hours. Thereafter, water was added thereto, thereby adjusting the concentration of the pigment to be 5% by weight. Accordingly, pigment-1 dispersion was obtained. Particles of the pigment included in the resulting pigment dispersion had a mean particle diameter of 0.21 μm.

11) Preparation of SBR Latex Liquid

SBR Latex (TP-1) was prepared as follows.

Into a polymerization vessel of a gas monomer reaction apparatus (manufactured by Taiatsu Techno Corporation, TAS-2J type) were poured 287 g of distilled water, 7.73 g of surfactant (PIONIN A-43-S (manufactured by TAKEMOTO OIL & FAT CO., LTD.): solid matter content of 48.5% by weight), 14.06 mL of 1 mol/L sodium hydroxide, 0.15 g of ethylenediamine tetraacetate tetrasodium salt, 255 g of styrene, 11.25 g of acrylic acid, and 3.0 g of tert-dodecyl mercaptan, followed by sealing of the reaction vessel and stirring at a stirring rate of 200 rpm. Degassing was conducted with a vacuum pump, followed by repeating nitrogen gas replacement several times. Thereto was injected 108.75 g of 1,3-butadiene, and the inner temperature of the vessel was elevated to 60° C. Thereto was added a solution obtained by dissolving 1.875 g of ammonium persulfate in 50 mL of water, and the mixture was stirred for 5 hours as it stands. Further, the mixture was heated to 90° C., followed by stirring for 3 hours. After completing the reaction, the inner temperature of the vessel was lowered to reach to the room temperature, and thereafter the mixture was treated by adding 1 mol/L sodium hydroxide and ammonium hydroxide to give the molar ratio of Na⁺ ion:NH₄⁺ ion=1:5.3, and thus, the pH of the mixture was adjusted to 8.4. Thereafter, filtration with a polypropylene filter having a pore size of 1.0 μm was conducted to remove foreign substances such as dust, and stored. Thereby, SBR latex TP-1 was obtained in an amount of 774.7 g. Upon the measurement of halogen ion by ion chromatography, concentration of chloride ion was revealed to be 3 ppm. As a result of the measurement of the concentration of the chelating agent by high performance liquid chromatography, it was revealed to be 145 ppm.

The aforementioned latex had a mean particle diameter of 90 nm, Tg of 17° C., a solid content of 44% by weight, an equilibrium moisture content at 25° C. and 60% RH of 0.6% by weight, and an ionic conductivity of 4.80 mS/cm (measurement of the ionic conductivity was performed using a conductometer CM-30S manufactured by To a Electronics Ltd. at 25° C.).

12) Preparation of Isoprene Latex Liquid (TP-2)

Isoprene latex (TP-2) was prepared as follows.

1500 g of distilled water was poured into a polymerization vessel of a gas monomer reaction apparatus (manufactured by Taiatsu Techno Corporation, TAS-2J type), and the vessel was heated for 3 hours at 90° C. to make passive film over the stainless-steel surface of the polymerization vessel and stainless-steel stirring device. Thereafter, 582.28 g of distilled water deaerated by nitrogen gas for one hour, 9.49 g of surfactant (PIONIN A-43-S, manufactured by Takemoto Oil & Fat Co., Ltd.), 19.56 g of 1 mol/L sodium hydroxide, 0.20 g of ethylenediamine tetraacetic acid tetrasodium salt, 314.99 g of styrene, 190.87 g of isoprene, 10.43 g of acrylic acid, and 2.09 g of tert-dodecyl mercaptan were added into the pretreated polymerization vessel. And then, the reaction vessel was sealed and the mixture was stirred at a stirring rate of 225 rpm, followed by elevating the inner temperature to 65° C. A solution obtained by dissolving 2.61 g of ammonium persulfate in 40 mL of water was added thereto, and the mixture was kept for 6 hours with stirring. At this point, the polymerization ratio was 90% according to the solid content measurement. Thereto, a solution obtained by dissolving 5.22 g of acrylic acid in 46.98 g of water was added, and then 10 g of water was added, and further a solution obtained by dissolving 1.30 g of ammonium persulfate in 50.7 mL of water was added. After the addition, the mixture was heated to 90° C. and stirred for 3 hours. After completing the reaction, the inner temperature of the vessel was lowered to reach to the room temperature, and thereafter the mixture was treated by adding 1 mol/L sodium hydroxide and ammonium hydroxide to give the molar ratio of Na⁺ ion:NH₄⁺ ion=1:5.3, and thus, the pH of the mixture was adjusted to 8.4. Thereafter, the resulting mixture was filtered with a polypropylene filter having a pore size of 1.0 μm to remove foreign substances such as dust, and stored. Thereby, 1248 g of isoprene latex TP-2 was obtained.

Upon the measurement of halogen ion by ion chromatography, concentration of chloride ion was revealed to be 3 ppm. As a result of the measurement of the concentration of the chelating agent by high performance liquid chromatography, it was revealed to be 142 ppm.

The latex described above had a mean particle diameter of 113 nm, Tg of 15° C., a solid content of 41.3% by weight, an equilibrium moisture content at 25° C. and 60RH % of 0.4% by weight, and an ionic conductivity of 5.23 mS/cm (measurement of the ionic conductivity was performed using a conductometer CM-30S manufactured by To a Electronics Ltd. at 25° C.).

### 2. Preparation of Coating Solutions

1) Preparation of Coating Solution for Image Forming Layer

To the dispersion of silver salt of a fatty acid obtained as described above (shown in Table 5) in an amount of 1000 g were serially added water, the pigment-1 dispersion, the organic polyhalogen compound-1 dispersion, the organic polyhalogen compound-2 dispersion, the phthalazine compound-1 solution, the SBR latex liquid (TP-1), the isoprene latex liquid (TP-2), the reducing agent-1 dispersion, the reducing agent-2 dispersion, the hydrogen bonding compound-1 dispersion, the development accelerator-1 dispersion, the development accelerator-2 dispersion, the color-tone-adjusting agent-1 dispersion, the mercapto compound-1 aqueous solution, and the mercapto compound-2 aqueous solution. By adding, just prior to coating, 140 g of the silver halide emulsion for coating (shown in Table 5) thereto and mixing sufficiently, a coating solution for the image forming layer was prepared, and allowed to be transported to a coating die.

Viscosity of the above-described coating solution for the image forming layer was 35 [mPa·s] which was measured with a B type viscometer at 40° C. (No. 1 rotor, 60 rpm).

Viscosity of the coating solution at 38° C. when it was measured using Rheo Stress RS150 manufactured by Haake Co. Ltd. was 38, 49, 48, 34, and 25 [mPa·s], respectively, at the shearing rate of 0.1, 1, 10, 100, 1000 [l/second].

The amount of zirconium in the coating solution was 0.30 mg per 1 g of silver.

2) Preparation of Coating Solution for Intermediate Layer

To 1000 g of poly(vinyl alcohol) PVA-205 (manufactured by Kuraray Co., Ltd.), 163 g of the pigment-1 dispersion, 33 g of a 18.5% by weight aqueous solution of blue dye-1 (manufactured by Nippon Kayaku Co., Ltd.: Kayafect turquoise RN liquid 150), 27 mL of a 5% by weight aqueous solution of di(2-ethylhexyl) sodium sulfosuccinate, 4200 mL of a 19% by weight liquid of methyl methacrylate/styrene/butyl acrylate/hydroxyethyl methacrylate/acrylic acid copolymer (weight ratio of the copolymerization of 57/8/28/5/2) latex, 27 mL of a 5% by weight aqueous solution of aerosol OT (manufactured by American Cyanamid Co.), and 135 mL of a 20% by weight aqueous solution of diammonium phthalate was added water to give the total amount of 10000 g. The mixture was adjusted to the pH of 7.5 with sodium hydroxide. Thereby, the coating solution for the intermediate layer was prepared.

Viscosity of the coating solution was 58 [mPa·s] which was measured with a B type viscometer at 40° C. (No. 1 rotor, 60 rpm).

3) Preparation of Coating Solution for First Layer of Surface Protective Layers

In 840 mL of water were dissolved 100 g of inert gelatin and 10 mg of benzisothiazolinone, and thereto were added 180 g of a 19% by weight liquid of methyl methacrylate/styrene/butyl acrylate/hydroxyethyl methacrylate/acrylic acid copolymer (weight ratio of the copolymerization of 57/8/28/5/2) latex, 46 mL of a 15% by weight methanol solution of phthalic acid, and 5.4 mL of a 5% by weight aqueous solution of di(2-ethylhexyl) sodium sulfosuccinate, and were mixed. Just prior to coating, 40 mL of a 4% by weight chrome alum was mixed therein.

Viscosity of the coating solution was 20 [mPa·s] which was measured with a B type viscometer at 40° C. (No. 1 rotor, 60 rpm).

4) Preparation of Coating Solution for Second Layer of Surface Protective Layers

(Preparation of Coating Solution-1 for Second Layer of Surface Protective Layers)

In 800 mL of water were dissolved 100 g of inert gelatin and 10 mg of benzisothiazolinone, and thereto were admixed 10 g of a 10% by weight emulsified dispersion of liquid paraffin, 30 g of a 10% by weight emulsified dispersion of dipentaerythritol hexaisostearate, 180 g of a 19% by weight liquid of methyl methacrylate/styrene/butyl acrylate/hydroxyethyl methacrylate/acrylic acid copolymer (weight ratio of the copolymerization of 57/8/28/5/2) latex, 40 mL of a 15% by weight methanol solution of phthalic acid, 5.5 mL of a 1% by weight solution of fluorocarbon surfactant (F-1), 5.5 mL of a 1% by weight aqueous solution of fluorocarbon surfactant (F-2), 28 mL of a 5% by weight aqueous solution of di(2-ethylhexyl) sodium sulfosuccinate, 4 g of poly(methyl methacrylate) fine particles (mean particle diameter of 0.7 μm, distribution of volume-weighted average of 30%), and 21 g of poly(methyl methacrylate) fine particles (mean particle diameter of 3.6 μm, distribution of volume-weighted average of 60%).

Viscosity of the coating solution was 19 [mPa·s] which was measured with a B type viscometer at 40° C. (No. 1 rotor, 60 rpm).

(Preparation of Coating Solution-2 to -4 for Second Layer of Surface Protective Layers)

Preparation of coating solution-2 to -4 for the second layer of the surface protective layers was conducted in a similar manner to the process in the preparation of the coating solution-1 for the second layer of the surface protective layers except that the fluorocarbon surfactants were respectively changed to the compounds shown in Table 5.

### 3. Preparation of Photothermographic Material

Reverse surface of the back surface was subjected to simultaneous multilayer coating by a slide bead coating method in order of the image forming layer, intermediate layer, first layer of the surface protective layers, and second layer of the surface protective layers, starting from the undercoated face, and thereby samples of photothermographic material were produced.

The coating amount of the coating solution for the intermediate layer was 8.9 mL/m², the coating amount of the coating solution for the first layer of the surface protective layers was 26.1 mL/m², and the coating amount of the coating solution for the second layer of the surface protective layers was 8.3 mL/m².

The coating amount of each compound (g/m²) for the image forming layer is as follows.

| | |
|---|---|
| Silver salt of a fatty acid (see Table 5) | 5.42 |
| Pigment (C.I. Pigment Blue 60) | 0.036 |
| Organic polyhalogen compound-1 | 0.14 |
| Organic polyhalogen compound-2 | 0.28 |
| Phthalazine compound-1 | 0.18 |
| SBR latex (TP-1) | 2.83 |
| Isoprene latex (TP-2) | 6.60 |
| Reducing agent-1 | 0.40 |
| Reducing agent-2 | 0.40 |
| Hydrogen bonding compound-1 | 0.116 |
| Development accelerator-1 | 0.01 |
| Development accelerator-2 | 0.02 |
| Mercapto compound-1 | 0.002 |
| Mercapto compound-2 | 0.012 |

Silver halide (the number and coating amount are shown in Table 5)

Conditions for coating and drying were as follows.

Coating was performed at a speed of 180 m/min. The clearance between the leading end of the coating die and the support was from 0.10 mm to 0.30 mm. The pressure in the vacuum chamber was set to be lower than atmospheric pressure by 196 Pa to 882 Pa. The support was decharged by ionic air before coating. In the subsequent chilling zone, the coating solution was cooled by air having the dry-bulb temperature of from 10° C. to 20° C. Transportation with no contact was carried out, and the coated support was dried with an air of the dry-bulb of from 23° C. to 45° C. and the wet-bulb of from 15° C. to 21° C. in a helical type contactless drying apparatus.

After drying, moisture conditioning was performed at 25° C. in the humidity of from 40% RH to 60% RH. Then, the film surface was heated to be from 70° C. to 90° C., and after heating, the film surface was cooled to 25° C.

(Coating Density of Silver Halide)

A slice having a thickness of 0.1 μm was prepared from the coated photothermographic material described above using a microtome. The slice was observed by TEM, and grain density per volume is determined by dividing a number of the observed grains by a volume of the region (area×0.1 μm). The value obtained by multiplying this grain density per volume by the thickness of the layer containing the silver halide is regarded as coating density of silver halide grains.

TABLE 5

| | | | | | Non-photosensitive | | Coating Solution | | | |
|---|---|---|---|---|---|---|---|---|---|---|
| | Silver Halide Emulsion | | | | Silver Salt | | for Second Layer of | | | |
| | | Mean | | | | Mean | Surface Protective Layers | | | |
| | | Grain | Coating | Coating | | Particle | | Fluorocarbon | Fluorocarbon | |
| Sample | | Size | Amount | Density | | Size | | Surfactant 1 | Surfactant 2 | |
| No. | No. | (nm) | (g Ag/m²) | (grains/μm²) | No. | (μm) | No. | (mg/m²) | (mg/m²) | Note |
| 1 | 1 | 42 | 0.12 | 850 | A | 0.52 | 1 | F-1 (0.4) | F-2 (0.4) | Comparative |
| 2 | 2 | 80 | 0.12 | 125 | A | 0.52 | 1 | F-1 (0.4) | F-2 (0.4) | Comparative |
| 3 | 3 | 34 | 0.12 | 1600 | A | 0.52 | 1 | F-1 (0.4) | F-2 (0.4) | Comparative |
| 4 | 5 | 23 | 0.12 | 5200 | A | 0.52 | 1 | F-1 (0.4) | F-2 (0.4) | Comparative |
| 5 | 1 | 42 | 0.12 | 850 | A | 0.52 | 1 | F-34 (20) | F-28 (3) | Comparative |
| 6 | 3 | 34 | 0.12 | 1600 | A | 0.52 | 2 | F-34 (20) | F-28 (3) | Invention |
| 7 | 7 | 30 | 0.12 | 2300 | A | 0.52 | 2 | F-34 (20) | F-28 (3) | Invention |
| 8 | 5 | 23 | 0.12 | 5200 | A | 0.52 | 2 | F-34 (20) | F-28 (3) | Invention |
| 9 | 5 | 23 | 0.12 | 5200 | A | 0.52 | 2 | F-34 (20) | — | Invention |
| 10 | 5 | 23 | 0.12 | 5200 | A | 0.52 | 2 | F-28 (20) | — | Invention |
| 11 | 5 | 23 | 0.12 | 5200 | A | 0.52 | 2 | F-1 (20) | — | Invention |
| 12 | 5 | 23 | 0.12 | 5200 | A | 0.52 | 2 | F-5 (20) | — | Invention |
| 13 | 5 | 23 | 0.12 | 5200 | A | 0.52 | 2 | F-36 (20) | — | Invention |
| 14 | 5 | 23 | 0.12 | 5200 | A | 0.52 | 2 | F-38 (20) | — | Invention |
| 15 | 5 | 23 | 0.12 | 5200 | A | 0.52 | 2 | F-41 (20) | — | Invention |
| 16 | 8 | 18 | 0.12 | 10800 | A | 0.52 | 2 | F-34 (20) | F-28 (3) | Invention |
| 17 | 5 | 23 | 0.12 | 5200 | Fine particle M4 | 0.39 | 2 | F-34 (20) | F-28 (3) | Invention |
| 18 | 5 | 23 | 0.12 | 5200 | Fine particle M4 | 0.39 | 3 | F-34 (90) | — | Invention |
| 19 | 5 | 23 | 0.12 | 5200 | Fine particle M4 | 0.39 | 4 | F-31 (50) | — | Invention |
| 20 | 5 | 23 | 0.12 | 5200 | Nanoparticle N1 | 0.16 | 2 | F-34 (20) | F-28 (3) | Invention |
| 21 | 5 | 23 | 0.12 | 5200 | Nanoparticle N1 | 0.16 | 3 | F-34 (90) | — | Invention |
| 22 | 5 | 23 | 0.12 | 5200 | Nanoparticle N1 | 0.16 | 4 | F-31 (50) | — | Invention |

Chemical structures of the compounds used in Examples of the invention are shown below.

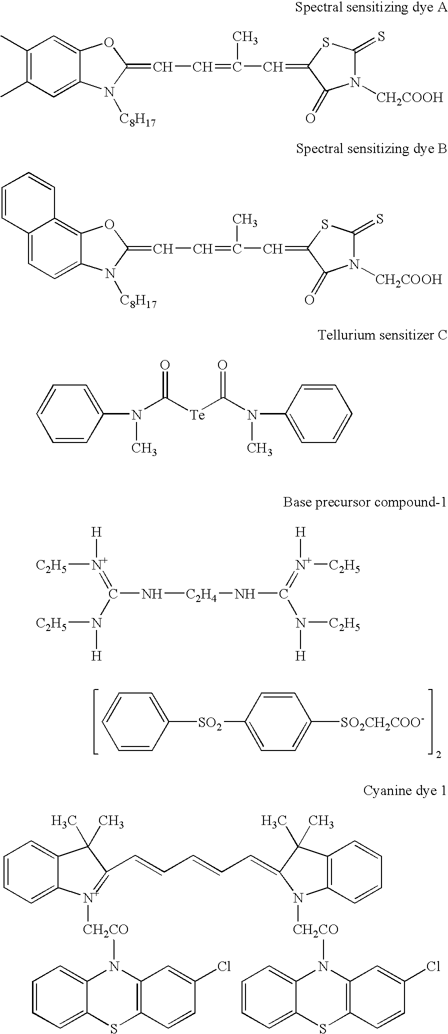

### Compound 1 that is one-electron-oxidized to provide a one-electron oxidation product which releases one or more electrons

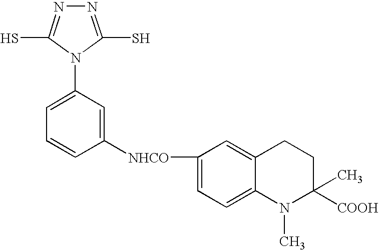

### Compound 2 that is one-electron-oxidized to provide a one-electron oxidation product which releases one or more electrons

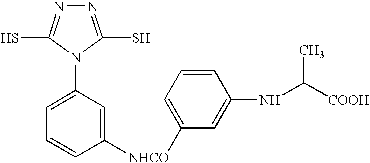

### Compound 3 that is one-electron-oxidized to provide a one-electron oxidation product which releases one or more electrons

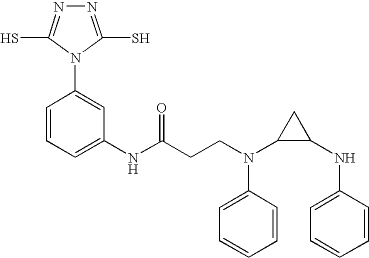

### Compound 1 having adsorptive group and reducing group

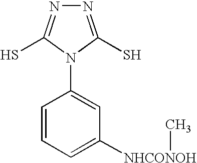

### Compound 2 having adsorptive group and reducing group

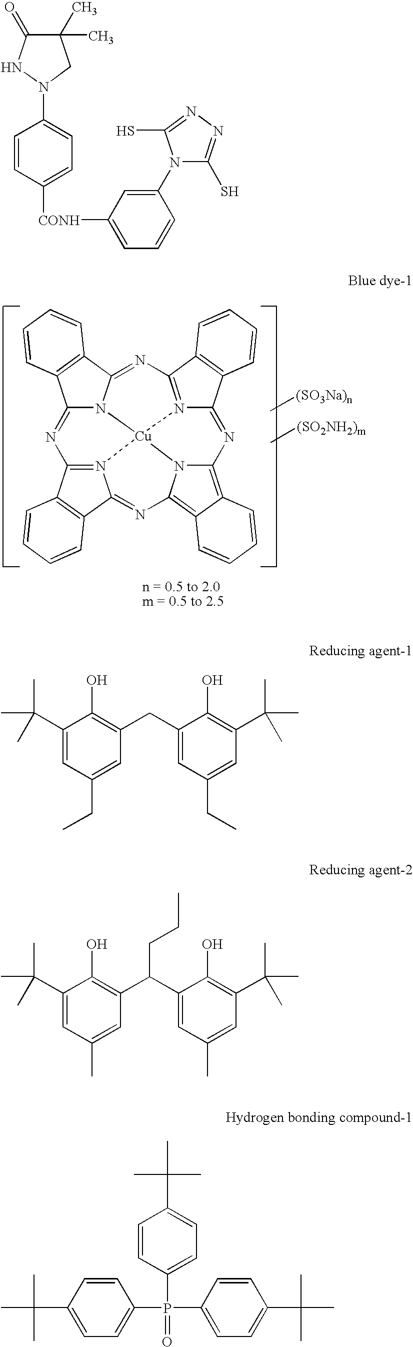

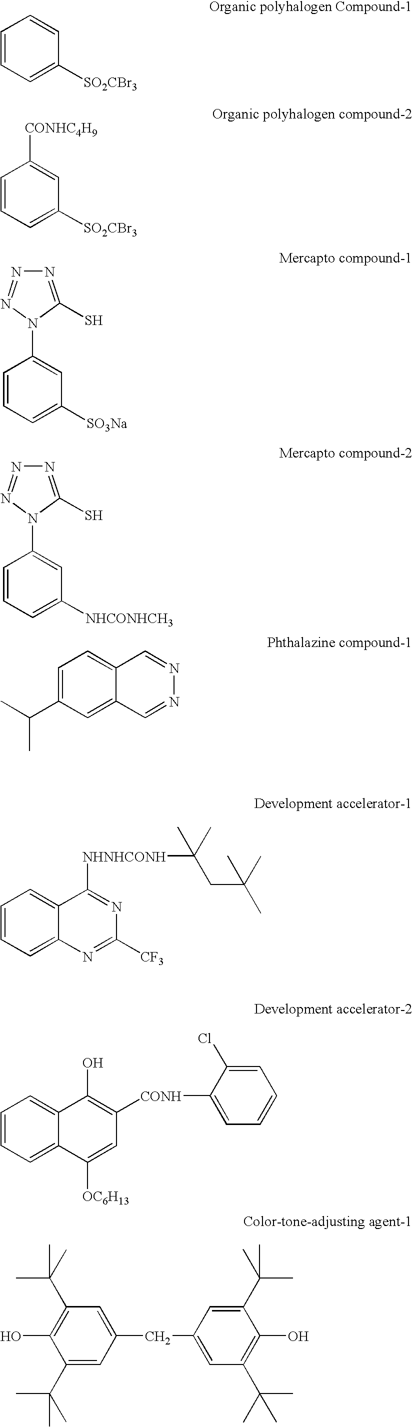

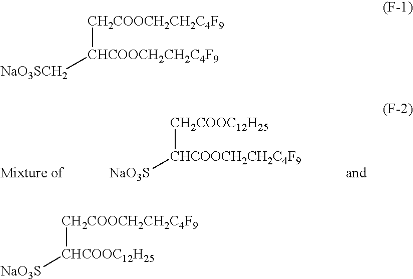

### 4. Evaluation of Performance

1) Preparation

The obtained sample was cut into a half-cut size (43 cm in length×35 cm in width) and was wrapped with the following packaging material under an environment of 25° C. and 50% RH, and stored for 2 weeks at an ambient temperature. Thereafter, the sample was subjected to the evaluation described below.

<Packaging Material>

A laminate film of 10 μm of PET/12 μm of PE/9 μm of aluminum foil/15 μm of Ny/50 μm of polyethylene containing carbon in an amount of 3% by weight:

oxygen permeability at 25° C.: 0.02 mL·atm⁻¹m⁻²day⁻¹;

moisture permeability at 25° C.: 0.10 g·atm⁻¹m⁻²day⁻¹.

2) Imagewise Exposure and Development of Photothermographic Material

Using each sample, imagewise exposure and thermal development (14 seconds in total with 3 panel heaters respectively set to 107° C., 121° C., and 121° C.) with a Fuji Medical Dry Laser Imager DRYPIX 7000 (equipped with a 660 nm laser diode having a maximum output of 50 mW (IIIB)) were performed. Evaluation of the obtained image was performed with a densitometer.

3) Evaluation Terms

<Photographic Properties>

Fog: Fog is expressed in terms of a density of an unexposed portion.

Sensitivity: Sensitivity is the inverse of the exposure value giving a density of fog +1.0. The sensitivities of samples are shown as relative values, with the sensitivity of sample No. 1 designated as 100.

Dmax: Dmax is expressed in terms of a saturated maximum density with an increasing exposure value.

Granularity: Each sample was subjected to imagewise exposure and thermal development similar to those described above. Density measurement was conducted with respect to the uniform image having a density of 1.0 obtained by uniform exposure by a microdensitometer with an aperture size of 0.1 mm×0.1 mm. Granularity was evaluated from the RMS value.

<Coated Surface State>

For each coated sample, evaluation of coated surface state was performed by visual observation.

∘: Density unevenness is not seen.

Δ: Density unevenness is slightly seen.

X: Density unevenness is seen.

XX: Remarkable density unevenness is seen.

<<Image Storability in Dark and Hot Place>>

As a compulsory condition for investigating the image storability in a dark and hot place of the image for a short period, each sample after thermal development was stored in a dark place under conditions of 60° C. and 80% RH for 72 hours. When the photothermographic material has inferior image storability in a dark and hot place, density of the image portion decreases. Evaluation with respect to the decrease in density of the portion having an initial density of 2.6 was performed for showing the image storability in a dark and hot place. It is shown as a relative value, with the decrease in density of sample No. 1 designated as 100. The smaller the value is, the more excellent in image storability in a dark and hot place the photothermographic material is.

4) Evaluation Results

The obtained results are shown in Table 6.

According to the samples of the present invention, photothermographic materials which exhibit excellent granularity and high Dmax, while exhibiting excellent performance in coated surface state, fog, and image storability in a dark and hot place are obtained. Moreover, as is clear from Table 6, particularly excellent effects are obtained in the system where fine particle organic silver salt is used in combination.

TABLE 6

| | | | | | | Image | |
|---|---|---|---|---|---|---|---|
| | | | | | Coated | Storability in | |
| Sample | | | | | Surface | Dark and Hot | |
| No. | Fog | Sensitivity | Dmax | Granularity | State | Place | Note |
| 1 | 0.171 | 100 | 3.81 | 0.0043 | ◯ | 100 | Comparative |
| 2 | 0.170 | 76 | 3.76 | 0.0150 | Δ | 95 | Comparative |
| 3 | 0.176 | 79 | 3.92 | 0.0026 | X | 110 | Comparative |
| 4 | 0.182 | 76 | 3.98 | 0.0018 | X | 120 | Comparative |
| 5 | 0.174 | 95 | 3.84 | 0.0045 | X X | 101 | Comparative |
| 6 | 0.170 | 82 | 4.02 | 0.0026 | ◯ | 100 | Invention |
| 7 | 0.171 | 96 | 4.12 | 0.0022 | ◯ | 96 | Invention |
| 8 | 0.172 | 84 | 4.25 | 0.0018 | ◯ | 95 | Invention |
| 9 | 0.175 | 85 | 4.24 | 0.0021 | ◯ | 100 | Invention |
| 10 | 0.173 | 83 | 4.23 | 0.0020 | ◯ | 96 | Invention |
| 11 | 0.173 | 80 | 4.08 | 0.0022 | ◯ | 98 | Invention |
| 12 | 0.173 | 80 | 4.05 | 0.0024 | ◯ | 98 | Invention |
| 13 | 0.175 | 83 | 4.20 | 0.0020 | ◯ | 102 | Invention |
| 14 | 0.175 | 83 | 4.18 | 0.0020 | ◯ | 104 | Invention |
| 15 | 0.175 | 83 | 4.18 | 0.0020 | ◯ | 104 | Invention |
| 16 | 0.174 | 47 | 4.10 | 0.0010 | Δ | 107 | Invention |
| 17 | 0.171 | 101 | 4.48 | 0.0018 | ◯ | 90 | Invention |
| 18 | 0.172 | 99 | 4.38 | 0.0018 | ◯ | 96 | Invention |
| 19 | 0.171 | 98 | 4.42 | 0.0018 | ◯ | 98 | Invention |
| 20 | 0.176 | 109 | 4.45 | 0.0018 | ◯ | 95 | Invention |
| 21 | 0.174 | 106 | 4.32 | 0.0018 | ◯ | 98 | Invention |
| 22 | 0.175 | 101 | 4.40 | 0.0018 | ◯ | 101 | Invention |

### Example 2

### 1. Preparation of Sample Nos. 23 to 26

Preparation of sample Nos. 23 to 26 was conducted in a similar manner to the process in the preparation of sample No. 10 of Example 1 except that the reducing agent-1 and reducing agent-2 are removed and the compound of formula (R1) shown in Table 7 was used instead.

### 2. Evaluation of Performance

Evaluation was performed similar to Example 1.

As a result, further improvements on Dmax and on image storability in a dark and hot place are obtained by using the compound represented by formula (R1).

TABLE 7

| | Compound | | | | | | | Image | |
|---|---|---|---|---|---|---|---|---|---|
| | of Formula | | | | | | Coated | Storability in | |
| Sample | (R1) | | | | | | Surface | Dark and Hot | |
| No. | No. | (g/m²) | Fog | Sensitivity | Dmax | Granularity | State | Place | Note |
| 23 | R1-1 | 0.72 | 0.171 | 105 | 4.51 | 0.0016 | ◯ | 82 | Invention |
| 24 | R1-11 | 0.78 | 0.172 | 103 | 4.49 | 0.0016 | ◯ | 85 | Invention |
| 25 | R1-31 | 0.90 | 0.171 | 104 | 4.50 | 0.0017 | ◯ | 86 | Invention |
| 26 | R1-36 | 0.96 | 0.172 | 102 | 4.49 | 0.0017 | ◯ | 88 | Invention |

### Example 3

### 1. Back Layer

To 830 g of methyl ethyl ketone, 84.2 g of cellulose acetate butyrate (trade name: CAB381-20, manufactured by Eastman Chemical Co.) and 4.5 g of polyester resin (trade name: Vitel PE2200B, manufactured by Bostic Co.) were added while stirring and allowed to be dissolved.

Next, to the solution were added 0.30 g of infrared dye-1 and a solution obtained by dissolving 4.5 g of fluorocarbon surfactant (trade name: Surflon KH40, manufactured by Asahi Glass Co., Ltd.) and 2.3 g of fluorocarbon surfactant (trade name: Megaface F120K, manufactured by Dainippon Ink and Chemicals, Inc.) in 43.2 g of methanol, and the mixture was stirred sufficiently to obtain a solution.

Then, 75 g of silica particles (trade name: Sylysia 450, manufactured by Fuji Silysia Chemical Co., Ltd.) dispersed in methyl ethyl ketone at a concentration of 1% by using a dissolver type homogenizer was added thereto, and the resulting mixture was stirred. Thereby, a coating solution for the backside was prepared.

Next, the prepared coating solution for the backside was coated on one side of a PET support, which is colored with a blue dye and has a thickness of 175 μm, to give a dry film thickness of 3.5 μm using an extrusion coater, and dried. Drying was carried out over 5 minutes with an air of the drying temperature of 100° C. and the dew point temperature of 10° C.

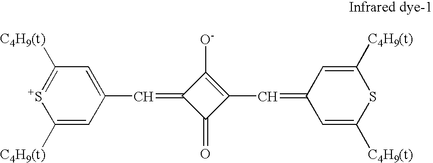

### 2. Image Forming Layer and Surface Protective Layer

### 2-1. Preparation of Materials for Coating

(Preparation of Binder for Dispersion)

<Preparation of Binder A for Dispersion>

100 g of poly(vinyl alcohol) having a polymerization degree of 500 and saponification degree of 99.8% (PVA: manufactured by Kuraray Co., Ltd.) was dissolved by warming in 900 g of distilled water. Thereafter, the solution was maintained at 20° C., and thereto were added 40 g of 35% hydrochloric acid and 17.5 g of butyraldehyde. Next, the mixture was cooled to 12° C., and thereto was added 60.5 g of butyraldehyde. After resin was separated out, the mixture was kept for 30 minutes, and thereafter 110 g of 35% hydrochloric acid was added, the resulting mixture was warmed to 30° C., and kept for 10 hours.

After completing the reaction, washing was carried out using distilled water, and to the poly(vinyl butyral) resin dispersed solution after water washing was added sodium hydroxide to adjust the pH of the solution to 7. After the solution was kept at 50° C. for 12 hours, the solution was cooled. At this point, the pH of the solution was 5.4. Then, the solution was subjected to water washing with distilled water in an amount of 100 times of the solid content of the poly(vinyl butyral), and after removing the water, distilled water was further added in an amount of 10 times of the solid content of the poly(vinyl butyral). The resulting solution was kept for 8 hours while stirring at 50° C. Thereafter, the solution was subjected to a dehydration step, and dried at 40° C. until the change in weight per 1 hour attained 0.1% or less.

<Preparation of Powder Organic Silver Salt A>

In 3980 mL of distilled water were dissolved 111.4 g of behenic acid, 83.8 g of arachidic acid, and 54.9 g of stearic acid at 80° C. Thereafter, 540.2 mL of 1.5 mol/L potassium hydroxide aqueous solution and 6.9 mL of concentrated nitric acid were added thereto, and the resulting mixture was cooled to 55° C. to provide a solution of potassium salt of organic acid. While keeping the temperature of the solution of potassium salt of organic acid at 55° C., the photosensitive silver halide emulsion 5 described above (including silver in an amount of 0.038 mol) and 420 mL of distilled water were added thereto, and the mixture stirred for 5 minutes. Next, 760.6 mL of 1 mol/L silver nitrate solution was added thereto over 2 minutes. After stirring for 20 minutes, water-soluble salts were removed by filtration. Thereafter, water washing with deionized water and filtration were repeated until the electrical conductivity of the wastewater became 2 μS/cm. After performing centrifugal dehydration and drying, powder organic silver salt A was obtained.

<Preparation of Organic Silver Salt Dispersion A>

26 g of PVB (Butvar-B79) was dissolved in 1300 g of methyl ethyl ketone, and while stirring using a dissolver DISPERMAT CA-40M type manufactured by VMA-GETZMANN Co., 500 g of the powder organic silver salt A was added little by little, and was sufficiently mixed to prepare a preliminary dispersion. After the powder organic silver salt A was added in its entirety, the mixture was stirred at 2000 rpm for 30 minutes. This preliminary dispersion was fed with a pump to a media type dispersing machine DISPERMAT SL-C12EX type (manufactured by VMA-GETZMANN Co.) packed with zirconia beads (Trade name: Torayceram, manufactured by Toray Industries, Inc.) having a diameter of 0.5 mm in an amount of 80% based on the internal volume to give a residence time of 1.5 minutes, and was subjected to dispersion at a mill lap speed of 8 m/s. Thereby, an organic silver salt dispersion was prepared. The concentration of the binder for dispersion in the organic silver salt dispersion was 1.4% by weight.

Preparation of Organic Silver Salt Dispersion B was Conducted in a similar manner to the process in the preparation of the organic silver salt dispersion A except that the PVB (Butvar-B79) was changed to the above-described binder A for dispersion.

### 2-2. Coating of Image Forming Layer and Surface Protective Layer

(Preparation of Coating Solutions)

1) Preparation of Coating Solution for Image Forming Layer

The coating amount of each constituent element (g/m², on the basis of the solid content) is as follows.

| | |
|---|---|
| Organic silver salt dispersion (see Table 8) | 11.08 |
| Aggregate of 2 molecules of N,N- | 0.039 |
| dimethylacetamide/1 molecule of bromic | |
| acid/1 molecule of bromine | |
| Calcium bromide | 0.045 |
| Sensitizer A1 | 1 × 10⁻⁶ mol/mol Ag |
| Sensitizer A2 | 1 × 10⁻⁶ mol/mol Ag |
| Dibenzo-18-crown-6 | 0.027 |
| Potassium acetate | 0.008 |
| 2-Chlorobenzoic acid | 0.054 |
| Salicylic acid-p-toluenesulfonate | 0.101 |
| 5-Methyl-2-mercaptobenzimidazole | 0.013 |
| p-Toluenethiosulfonic acid potassium salt | 0.041 |
| Binder (Butvar B-79) | 10.92 |
| Reducing agent (R1-1) | 2.03 |
| Compound of formula (1) | (See Table 8) |
| Desmodur N3300 | 0.131 |
| Tribromomethyl-2-azaphenylsulfone | 0.034 |
| Phthalazine | 0.256 |

Sensitizer A1

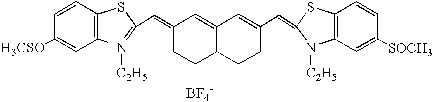

Sensitizer A2

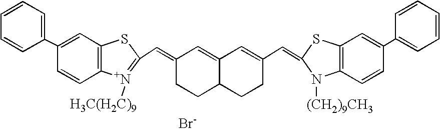

2) Preparation of Coating Solution for Surface Protective Layer

To 865 g of MEK, 96 g of cellulose acetate butyrate (trade name: CAB171-15, manufactured by Eastman Chemical Co.), 4.5 g of poly(methyl methacrylate) (trade name: PARALOID A-21, manufactured by Rohm and Haas Co.), 1.5 g of 1,3-di(vinyl sulfonyl)-2-propanol, 1.0 g of benzotriazole, and 1.0 g of fluorocarbon compound (shown in Table 8) were added while stirring, and allowed to be dissolved. Then, 30 g of a dispersion obtained by dispersing 13.6% by weight of cellulose acetate butyrate (trade name: CAB171-15, manufactured by Eastman Chemical Co.) and 9% by weight of calcium carbonate (trade name: Super-Pflex200, manufactured by Speciality Minerals Co.) to MEK using dissolver type homogenizer at 8000 rpm for 30 minutes was added thereto, and the mixture was stirred to prepare a coating solution for the surface protective layer.

(Coating of Image Forming Layer and Surface Protective Layer)

The coating solution for the image forming layer and the coating solution for the surface protective layer was subjected to simultaneous double coating on the reverse surface of the support form the back layer with an extrusion coater, and thereby photothermographic material-31 to -38 were obtained. Coating was carried out so that the coating solution for the image forming layer gave the amount of coated silver of 2.3 g/m², and so that the coating solution for the surface protective layer gave the dry film thickness of 2.5 μm. Thereafter, drying was carried out for 10 minutes with an air of the drying temperature of 75° C. and the dew point temperature of 10° C.

TABLE 8

| | | Silver Halide | | Compound | | | | | | |
|---|---|---|---|---|---|---|---|---|---|---|
| | | Emulsion | | of | | Fluorocarbon | | Fluorocarbon | | |
| | Organic | Amount of | | Formula (1) | | Surfactant 1 | | Surfactant 2 | | |
| | Silver | Coated | Coating | | Addition | | Addition | | Addition | |
| Sample | Salt | Silver | Density | | Amount | | Amount | | Amount | |
| No. | No. | (g/m²) | (g/m²) | No. | (mg/m²) | No. | (mg/m²) | No. | (mg/m²) | Note |
| 31 | A | 0.18 | 7800 | — | — | C₈F₁₇SO₃Li | 30 | — | — | Comparative |
| 32 | A | 0.18 | 7800 | — | — | FC-54 | 20 | FC-48 | 3 | Invention |
| 33 | A | 0.18 | 7800 | 1-1 | 240 | FC-54 | 20 | FC-48 | 3 | Invention |
| 34 | A | 0.18 | 7800 | 1-4 | 370 | FC-54 | 20 | FC-48 | 3 | Invention |
| 35 | B | 0.18 | 7800 | 1-1 | 240 | FC-54 | 20 | FC-48 | 3 | Invention |
| 36 | B | 0.18 | 7800 | 1-1 | 240 | FC-29 | 30 | — | — | Invention |
| 37 | B | 0.18 | 7800 | 1-1 | 240 | FC-27 | 30 | — | — | Invention |
| 38 | B | 0.18 | 7800 | 1-1 | 240 | FC-7 | 30 | — | — | Invention |

### 3. Evaluation of Performance

Imagewise exposure and thermal development were performed similar to Example 1 except that the 660 nm laser diode in the image forming apparatus was changed to infrared laser.

The obtained results are shown in Table 9. The values of sensitivity and image storability shown in Table 9 are relative values, with the sensitivity and image storability of comparative sample No. 31 designated as 100.

It is clear from Table 9 that the samples of the invention exhibit excellent coated surface state, excellent image storability, and high sensitivity.

TABLE 9

| | | | | | Image | |
|---|---|---|---|---|---|---|
| Sam- | | | | Coated | Storability in | |
| ple | | | Granu- | Surface | Dark and | |
| No. | Fog | Sensitivity | larity | State | Hot Place | Note |
| 31 | 0.186 | 100 | 0.0025 | X | 100 | Comparative |
| 32 | 0.183 | 115 | 0.0025 | ◯ | 95 | Invention |
| 33 | 0.185 | 152 | 0.0022 | ◯ | 89 | Invention |
| 34 | 0.186 | 135 | 0.0023 | ◯ | 98 | Invention |
| 35 | 0.181 | 157 | 0.0018 | ◯ | 85 | Invention |
| 36 | 0.182 | 148 | 0.0020 | ◯ | 91 | Invention |
| 37 | 0.182 | 151 | 0.0019 | ◯ | 88 | Invention |
| 38 | 0.181 | 150 | 0.0021 | ◯ | 87 | Invention |

What is claimed is:

1. A photothermographic material comprising, on at least one side of a support, an image forming layer comprising at least a photosensitive silver halide, a non-photosensitive organic silver salt, a reducing agent for silver ions, and a binder, and at least one non-photosensitive layer, wherein:
1) a mean grain size of the photosensitive silver halide is from 10 nm to 40 nm in terms of equivalent circular diameter, and a number of coated grains thereof is from 550 grains/μm² to 10000 grains/μm²; and
2) the photothermographic material comprises a fluorocarbon compound represented by the following formula (FC-1), (FC-2), or (FC-3):
(Rf)ₚ—Y-(L-Z)_{q} Formula (FC-1):
Rf-L-Z′-L-Rf Formula (FC-2):
Z-L-Rf′-L-Z Formula (FC-3):
wherein Rf represents a fluoroalkyl group or fluoroalkenyl group having 3 to 17 fluorine atoms; Rf′ represents a fluoroalkylene group or fluoroalkenylene group having 3 to 17 fluorine atoms; L represents a bond or a divalent linking group; Y represents a bond or a saturated linking group having a valency of (p+q); Z represents an anionic group, a cationic group, a betaine group, or a nonionic polar group; Z′ represents a divalent nonionic polar group; p and q each independently represent an integer of from 1 to 3; and when (p+q) is 2, both of L and Y are not simultaneously a bond.

2. The photothermographic material according to claim 1, wherein the mean grain size of the photosensitive silver halide is from 20 nm to 30 nm in terms of equivalent circular diameter.

3. The photothermographic material according to claim 1, wherein the number of coated grains of the photosensitive silver halide is from 2000 grains/μm² to 8000 grains/μm².

4. The photothermographic material according to claim 1, wherein, in formula (FC-1), (p+q) is 3.

5. The photothermographic material according to claim 1, wherein Rf is represented by the following formula (FC-1-C):
-Rc-Re—W Formula (FC-1-C):
wherein Rc represents a bond or a straight-chain alkylene group having 4 or fewer carbon atoms; Re represents a perfluoroalkylene group having 2 to 6 carbon atoms; and W represents a hydrogen atom or a fluorine atom.

6. The photothermographic material according to claim 1, wherein Rf is a C₄F₉ group.

7. The photothermographic material according to claim 1, wherein Rf is a C₉F₁₇ group.

8. The photothermographic material according to claim 1, wherein the reducing agent for silver ions is a compound represented by the following formula (R1): 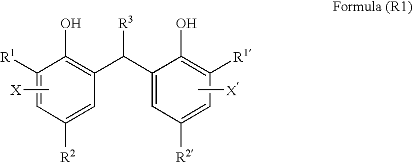
wherein R¹ and R^{1′} each independently represent an alkyl group having 1 to 20 carbon atoms; R² and R^{2′} each independently represent a hydrogen atom or a substituent which substitutes for a hydrogen atom on a benzene ring; R³ represents a substituent which forms a 3- to 7-membered ring formed from atoms selected from among carbon, oxygen, nitrogen, sulfur, and phosphorus; and X and X′ each independently represent a hydrogen atom or a group substituting for a hydrogen atom on a benzene ring.

9. The photothermographic material according to claim 1, wherein 50% by weight or more of the binder in the image forming layer is poly(vinyl butyral).

10. The photothermographic material according to claim 9, wherein the poly(vinyl butyral) is a mixture of poly(vinyl acetal) of a low polymerization degree and poly(vinyl acetal) of a high polymerization degree.

11. The photothermographic material according to claim 10, wherein the poly(vinyl acetal) of a low polymerization degree is poly(vinyl butyral) having a weight-average polymerization degree of from 200 to 600.

12. The photothermographic material according to claim 10, wherein the poly(vinyl acetal) of a high polymerization degree is poly(vinyl butyral) having a weight-average polymerization degree of from 900 to 3000.

13. The photothermographic material according to claim 10, wherein a weight ratio of the poly(vinyl acetal) of a low polymerization degree to the poly(vinyl acetal) of a high polymerization degree is from 5/95 to 95/5.

14. The photothermographic material according to claim 1, wherein 50% by weight or more of the binder in the image forming layer is a polymer latex.

15. The photothermographic material according to claim 1, wherein a mean particle size of the non-photosensitive organic silver salt is 0.4 μm or less in terms of equivalent spherical diameter.

16. The photothermographic material according to claim 15, wherein the non-photosensitive organic silver salt is a silver salt formed by a reaction between a potassium salt of an organic acid and silver nitrate.

17. The photothermographic material according to claim 15, wherein the non-photosensitive organic silver salt comprises nanoparticles.

18. The photothermographic material according to claim 17, wherein the nanoparticles are particles prepared in the presence of at least one dispersing agent comprising polyacrylamide or a derivative thereof.

19. The photothermographic material according to claim 1, wherein the photothermographic material comprises a compound represented by the following formula (1) on the side having the image forming layer: 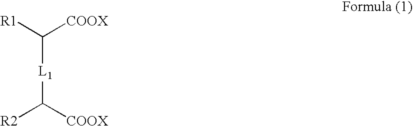
wherein L₁ represents a bond or a divalent linking group; R¹ and R² each independently represent a hydrogen atom, or a hydrocarbon group which may bond to each other to form a ring; X represents a hydrogen atom or a cation; and when X is a cation having a valency of 2 or more, the two carboxy groups may chelate with a single X.

20. The photothermographic material according to claim 19, wherein the photothermographic material comprises the compound represented by formula (1) on the side having the image forming layer in an amount of from 0.2 g/m² to 1.0 g/m².

21. The photothermographic material according to claim 19, wherein the photothermographic material comprises the compound represented by formula (1) in an amount of from 10 mol % to 30 mol % per 1 mol of silver on the side having the image forming layer.

22. The photothermographic material according to claim 19, wherein the compound represented by formula (1) is a compound represented by the following formula (2): 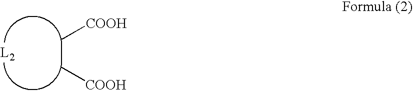
wherein L₂ represents a 6- to 8-membered, substituted or unsubstituted, saturated or unsaturated hydrocarbon ring.

23. The photothermographic material according to claim 19, wherein the photothermographic material comprises at least two compounds represented by formula (1).

24. An image forming method for forming an image by imagewise exposing and thermally developing the photothermographic material according to claim 1, wherein the imagewise exposure is executed by scanning exposure using a laser beam forming a beam spot diameter of 25 μm or less on the exposed surface of the photothermographic material, and the thermal development is executed by heating at 100° C. to 200° C. for a period of from 1 sec to 60 sec.

25. The image forming method according to claim 24, wherein an obtained maximum image density is 4 or higher.
